(19) United States
(12) Patent Application Publication
(10) Pub. No.: US 2016/0071162 A1
(43) Pub. Date: Mar. 10, 2016

(54) Systems and Methods for Continuous Analysis and Procurement of Advertisement Campaigns

(71) Applicant: Sysomos L.P., Toronto (CA)

(72) Inventors: Stuart OGAWA, Los Gatos, CA (US); Edward Dong-Jin KIM, Toronto (CA); Kanchana PADMANABHAN, Toronto (CA)

(73) Assignee: SYSOMOS L.P., Toronto (CA)

(21) Appl. No.: 14/849,353

(22) Filed: Sep. 9, 2015

Related U.S. Application Data
(60) Provisional application No. 62/048,612, filed on Sep. 10, 2014.
(60) Provisional application No. 62/068,118, filed on Oct. 24, 2014.

(51) Int. Cl. G06Q 30/02; G06Q 50/00

(52) U.S. Cl. CPC G06Q 30/0269; G06Q 50/01

(57) ABSTRACT

A system and a method are provided for continuously analysing and procuring advertisements. Social data is obtained and is used to identify one or more relationships. The operations further include: modifying or determining a target set based on the one or more relationships, the target set comprising a combination of inputs and a target audience, the inputs comprising a search algorithm for identifying the target audience; presenting the target set when a proposed advertising campaign is detected; procuring the proposed advertising campaign using the target audience to generate a procured advertisement; obtaining feedback about the procured advertisement; and further modifying the target set based on the feedback.

### CROSS-REFERENCE TO RELATED APPLICATIONS

This application claims priority to United States Provisional Patent Application No. 62/048,612 filed on Sep. 10, 2014 and titled “Systems and Methods for Identifying A Target Audience In a Social Data Network”, and to U.S. Provisional Patent Application No. 62/068,118 filed on Oct. 24, 2014 and titled “Systems and Methods for Continuous Analysis and Procurement of Advertisement Campaigns”, and the entire contents of these applications are herein incorporated by reference.

### TECHNICAL FIELD

The following generally relates to analysing social data to procure advertisement campaigns.

### BACKGROUND

In recent years social media has become a popular way for individuals and consumers to interact online (e.g. on the Internet). Social media also affects the way businesses aim to interact with their customers, fans, and potential customers online.

There are many different types of social media (e.g. articles, online posts, blogs, comments, pictures, videos, audio data, etc.). The sources of the data also vary as there are many persons, groups and organizations generating the social data.

Businesses wish to utilize social media to advertise to users.

### BRIEF DESCRIPTION OF THE DRAWINGS

Embodiments will now be described by way of example only with reference to the appended drawings wherein:

FIG. 1 is a block diagram of an advertisement procurement and analysis system interacting with the Internet or a cloud computing environment, or both.

FIG. 2 is a block diagram of an example embodiment of a computing system for advertisement procurement and analysis, including example components of the computing system.

FIG. 3 is a block diagram of an example embodiment of multiple computing devices interacting with each other over a network to form the advertisement procurement and analysis system.

FIG. 4 is a schematic diagram showing the interaction and flow of data between an active receiver module, a target audience analysis and library module and an advertisement procurement module.

FIG. 5 is a schematic diagram showing the interaction and flow of data between the target audience analysis and library module and the advertisement procurement module.

FIG. 6 is a schematic diagram showing the interaction and flow of data between the target audience analysis and library module and the active receiver module.

FIG. 7 is a block diagram of an active receiver module showing example components thereof.

FIG. 8 is a flow diagram of an example embodiment of computer executable or processor implemented instructions for receiving social data.

FIG. 9 is a schematic diagram of users following each other in a social data network.

FIG. 10 is a flow diagram of an example embodiment of computer executable or processor implemented instructions for identifying influencers and their communities.

FIG. 11 is a flow diagram of another example embodiment of computer executable or processor implemented instructions for identifying influencers and their communities.

FIG. 12 is a schematic diagram of a topic network of users related to a specific topic.

FIG. 13 is a schematic diagram of the topic network of FIG. 12, but showing different groups within the topic network.

FIG. 14 is a flow diagram of another example embodiment of computer executable or processor implemented instructions for identifying and filtering outliers in a topic network.

FIG. 15 is a flow diagram of another example embodiment of computer executable or processor implemented instructions for ranking influencers.

FIG. 16 is a flow diagram of another example embodiment of computer executable or processor implemented instructions for identifying segments of users based on a topic.

FIG. 17 is a flow diagram of another example embodiment of computer executable or processor implemented instructions for identifying segments of users based on a topic.

FIG. 18 is a flow diagram of an example embodiment of computer executable or processor implemented instructions for identifying segments of users based on a topic, using n-gram processing of text.

FIG. 19 is a flow diagram of an example embodiment of computer executable or processor implemented instructions for selectively obtaining data specific to a certain parameter.

FIG. 20 is a flow diagram of an example embodiment of computer executable or processor implemented instructions for filtering and amplifying features in the obtained social data.

FIG. 21 is a flow diagram of an example embodiment of computer executable or processor implemented instructions for filtering out noise in the obtained social data.

FIG. 22 is a flow diagram of an example embodiment of computer executable or processor implemented instructions for correlating location and topic data.

FIG. 23 is a flow diagram of an example embodiment of computer executable or processor implemented instructions for obtaining and combining data from different data sources.

FIG. 24 is a flow diagram of another example embodiment of computer executable or processor implemented instructions for obtaining and combining data from different data sources.

FIG. 25 is a flow diagram of an example embodiment of computer executable or processor implemented instructions for obtaining data from different data sources and comparing the same for verification.

FIG. 26 is a flow diagram of an example embodiment of computer executable or processor implemented instructions for predicting or synthesizing data, or both.

FIG. 27 is a flow diagram of an example embodiment for identifying a target group of users and communicating to the same.

FIG. 28 is a diagram illustrating users in connection with each other in a social data network.

FIG. 29 is a schematic diagram of example components in a target audience search algorithm module.

FIG. 30 is a flow diagram of an example embodiment of computer executable instructions for identifying a target audience.

FIG. 31 is a diagram illustrating high-authority users and low-authority users in connection with each other in a social data network.

FIG. 32 is a flow diagram of another example embodiment of computer executable instructions for determining a target audience including users related to high-authority users and users related to low-authority users.

FIG. 33A is a flow diagram of an example embodiment of computer executable or processor implemented instructions for composing a new digital advertisement.

FIG. 33B is a flow diagram of an example embodiment of computer executable or processor implemented instructions for combining social data or advertising data according to an operation described in FIG. 33A.

FIG. 33C is a flow diagram of an example embodiment of computer executable or processor implemented instructions for extracting social data or advertising according to an operation described in FIG. 33A.

FIG. 33D is a flow diagram of an example embodiment of computer executable or processor implemented instructions for creating a digital advertisement according to an operation described in FIG. 33A.

FIG. 34 is a flow diagram of an example embodiment of computer executable or processor implemented instructions for composing a new digital advertising file based on a previously composed digital advertising file.

FIG. 35 is a flow diagram of an example embodiment of computer executable or processor implemented instructions for composing audio and video content.

FIG. 36 is a schematic diagram of an example embodiment of video images and overlaid audio content at different instances in time.

### DETAILED DESCRIPTION OF THE DRAWINGS

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

The proposed computing systems and methods described herein relate to determining a target audience for an advertising campaign. The target audience is determined based on topics or content of the advertising, as well as attributes related to the people or users in the audience. For example, a library of search algorithms for searching for a target audience according to certain conditions is provided. A library of digital advertisement templates may also be provided, which are associated with features of various target audiences. The search algorithms and the advertisement templates may automatically update or modify themselves based on machine learning, data received from social data networks and data received responsive to previous advertising campaigns. The libraries of search algorithms and advertisement templates can be searched by a user who is developing an advertisement campaign. The computing system may also automatically recommend search algorithms and advertisement templates to the user based on features of the advertising campaign (e.g. industry, product, service, language, geography, age group, culture, etc.). The search algorithm may also recommend one or more social data networks to carry out the advertisement campaign. Tools are also provided to identify the target audience, to carry out audience reach simulations, and to suggest features of the advertising campaign. Other tools are also provided to procure the advertising campaign, such as sending the advertisements over the advertising networks and social data networks. There may also be a tool to obtain feedback about the advertisement campaign and to conduct analysis of the feedback. The feedback about the advertisement campaign is used to automatically update or modify the search algorithms for the searching for a target audience, as well as to automatically update or modify the advertisement templates. The feedback may also be used to automatically update or modify any of the tools provided, so as to continuously improve the effectiveness and reach of the advertisement campaigns amongst people and networks.

A “social data network” or “social network”, as used herein includes one or more social data networks based on different social networking platforms. For example, a social network based on a first social networking platform and a social network based on a second social networking platform may be combined to generate a combined social data network. A target audience of users may be identified using the combined social data network, or also simply herein referred to as a “social data network” or “social network”. Non-limiting examples of social data networks include Facebook, Tumblr, Twitter, LinkedIn, Pinterest, Google plus and Instagram.

Social data herein refers to content able to be viewed or heard, or both, by people over a data communication network, such as the Internet. Social data includes, for example, text, video, graphics, and audio data, or combinations thereof. Examples of text include blogs, emails, messages, posts, articles, comments, etc. For example, text can appear on websites such as Facebook, Tumblr, Twitter, LinkedIn, Pinterest, Instagram, other social networking websites, magazine websites, newspaper websites, company websites, blogs, etc. Text may also be in the form of comments on websites, text provided in an RSS feed, etc. Examples of video can appear on Facebook, YouTube, news websites, personal websites, blogs (also called vlogs), company websites, etc. Graphical data, such as pictures, can also be provided through the above mentioned outlets. Audio data can be provided through various websites, such as those mentioned above, audio-casts, “Pod casts”, online radio stations, etc. It is appreciated that social data can vary in form.

A social data object herein refers to a unit of social data, such as a text article, a video, a picture, a comment, a message, an audio track, a graphic, or a mixed-media social piece that includes different types of data. A stream of social data includes multiple social data objects. For example, in a string of comments from people, each comment is a social data object. In another example, in a group of text articles, each article is a social data object. In another example, in a group of videos, each video file is a social data object. Social data includes at least one social data object.

A digital advertisement herein refers to a social data object that is a form of digital marketing communication and is used to encourage, persuade, or manipulate an audience. A digital advertisement in many cases is specific to commerce and promotes, for example, a brand, a company, a product, a service, a person, or combinations thereof. A digital advertisement may also promote thoughts or actions, such as political and ideological advertising. A digital advertisement may also be called a digital advertising file or an advertisement.

An advertisement campaign herein refers to a coordinated series of linked digital advertisements with a single idea or theme. An advertising campaign is typically transmitted through several media channels or social data network channels or platforms. It may focus on a common theme and one or few brands or products, or be directed at a particular segment of the population.

A target audience herein refers to one or more persons, or a group of people, or people having a certain characteristic, to which it is desirable to send an advertisement. In a non-limiting embodiment, each person or entity in the target audience is identifiable by a computing system using a user account associated with one or more email services, social data networks, media platforms, or websites.

It will be appreciated that a user account is a known term in the art of computing. In some cases, although not necessarily, a user account is associated with an email address. A user has a user account and is identified to the computing system by a username (or user name). Other terms for username include login name, screen name (or screenname), nickname (or nick) and handle.

A target audience search algorithm herein refers to a computer process that identifies a target audience.

It is recognized that effective social communication, from a business perspective, is a significant challenge. The expansive reach of digital social sites, such as Twitter, Facebook, YouTube, etc., the real time nature of communication, the different languages used, and the different communication modes (e.g. text, audio, video, etc.) make it challenging for typical computing systems to effectively understand feedback from a business' customers and to communicate with the business' customers. The increasing number of websites, channels, and communication modes can overwhelm typical computing processes with too much real time data and little appropriate and relevant information. It is also recognized that people in decision making roles in business are often left wondering who is saying what, what communication data channels are being used, which people are important to listen to, and to whom an advertisement should be targeted. Current computing systems and processes generally are unable to automatically and accurately identify this pertinent information.

It is recognized that typically a person or persons generate an advertisement, which may be sent through social data networks. For example, a person generates an advertisement by writing a message, an article, a comment, etc., or by generating other social data (e.g. pictures, video, and audio data). An advertisement may contain mixed media. This generation process, although sometimes partially aided by a computer, is time consuming and uses effort by the person or persons. For example, a person typically types in a text message, and inputs a number of computing commands to attach a graphic or a video, or both. After a person creates the advertisement, the person will need to distribute the advertisement to a website, a social network, or another communication channel. For example, the person selects the social data network on which to distribute the advertisement, formats the advertisement (e.g. data format, data size, image size, maximum number of characters, etc.) to meet the requirements provided by the social data network, and uploads the advertisement onto the social network. Although this process is performed by person with the aid of a computer, it is a time consuming process that requires input from a person.

It is also recognized that when a person generates an advertisement, before the advertisement is distributed, the person does not have a way to estimate how well the social data will be received by other people. After the advertisement has been distributed, a person may also not have a way to evaluate how well the content has been received by other people. Furthermore, many software and computing technologies require a person to view a website or view a report in order for the person to interpret feedback from other people. It is recognized herein that it is desirable for a computer process to estimate how well the social data will be received by people (e.g. positive or negative feedback or reactions from people) before the advertisement is distributed over a data network.

It is also recognized that generating advertising content that is interesting to people, and identifying which people would find the advertising interesting is a difficult process for a person, and much more so for a computing device. Computing technologies typically require input from a person to identify topics of interest, as well as identify people who may be interested in a topic. It also recognized that generating large amounts of advertising covering many different topics is a difficult and time-consuming process. Furthermore, it is difficult for computing systems to achieve such a task on a large data scale within a short time frame.

It is also recognized that social data may be used to understand the context of proposed advertising campaigns, as well as the context of past advertising campaigns. However, obtaining social data and understanding the relationships between social data is difficult for computing systems, given the volume of data and different meanings of the social data. For example, given a large volume of data, it is recognized that quickly receiving and processing the received data is difficult. It is also recognized that identifying relationships between users and data (e.g. topics, keywords, etc.) is difficult for computing systems, since, for example, the interactions between users and the data may not be predefined. Other relationships, such as location and topic, may also be skipped over. It also recognized that receiving relevant data particular to a goal or a set of criteria is difficult.

It is also recognized that there are many ways for a computing device or system to identify a target audience. Selecting an appropriate computing technique to identify a target audience may depend on various factors, and is typically selected by a person. However, a person may not consider all the various factors in detail, or may take time to do so before selecting a computing technique for identifying a target audience. Furthermore, when there are multiple advertising campaigns that are being generated quickly, a person may not be able to keep up and select the appropriate computing techniques to identify a target audience for each advertising campaign. Thus, an advertising campaign may be sent to a target audience that is not appropriate or up-to-date with current feedback data.

It is also recognized that launching an advertisement campaign may be costly and that the impression of people reacting to the advertising campaign may have a lasting effect. Typically, advertising computing systems do not have a way to understand the effect or reach of the advertisements, until after the advertisements have been sent. However, an understanding provided in hindsight will incur the costs of the campaign and, if the reactions from the audience are negative, the reactions may be difficult to reverse. Therefore, it is recognized that it is desirable for computing systems to predict or understand the effect or reach of the advertisements before sending the advertisements. In this way, the advertising campaign, including the target audience and the content, may be adjusted or modified before actually sending the advertisements. It is also desirable to for an advertising computing system to make changes to an advertising campaign while the campaign is running based on real time social feedback. Preferably, the changes to the advertising campaign are made automatically by the computing system, without human intervention, and the changes are made in real time. These “live changes” (e.g. changes made while the advertising campaign is active) would improve the effectiveness of the campaign and reduce any negative reactions to the campaign.

Aspects of the proposed computing systems and methods described herein address one or more of these above computer issues. Aspects of the proposed computing systems and methods use one or more computing devices to receive social data, identify relationships between the social data, modify one or more search algorithms (e.g. computer processes) to search for target audiences (e.g. user accounts) based on the identified relationships and the received social data, and make available the modified one or more search algorithms in a library stored in memory. Aspects of the proposed computing systems and methods further include recommending one or more search algorithms from the library to be used to identify a target audience for a proposed advertising campaign. Based on the target audience and the proposed advertising campaign, digital content or digital format or both may be suggested for the advertisement. Computer simulations of the advertising campaign may be performed to refine the advertising campaign and to generate recommendations. In a preferred example embodiment, these computing systems and methods are automated and require no input from a person for continuous operation. In another example embodiment, some input from a person is used to customize operation of these computing systems and methods.

Aspects of the proposed computing systems and methods are able to obtain feedback during this process to improve computations related to any of the operations described above. For example, feedback is obtained about the advertising campaign, and this feedback can be used to adjust parameters related to the search algorithms for the target audience, the recommendation process for identifying search algorithms to be used, the simulation process, the recommendation process, and the advertisement procurement process. This feedback is also used to adjust parameters used in identifying relationships. Further details and example embodiments regarding the proposed systems and methods are described below.

Aspects of the proposed computing systems and methods may be used for real time listening, analysis, advertisement content composition, and targeted broadcasting. The systems, for example, capture global data streams of data in real time. The stream data is analyzed and used to intelligently determine content composition and intelligently determine who, what, when, and how the composed advertisements are to be sent.

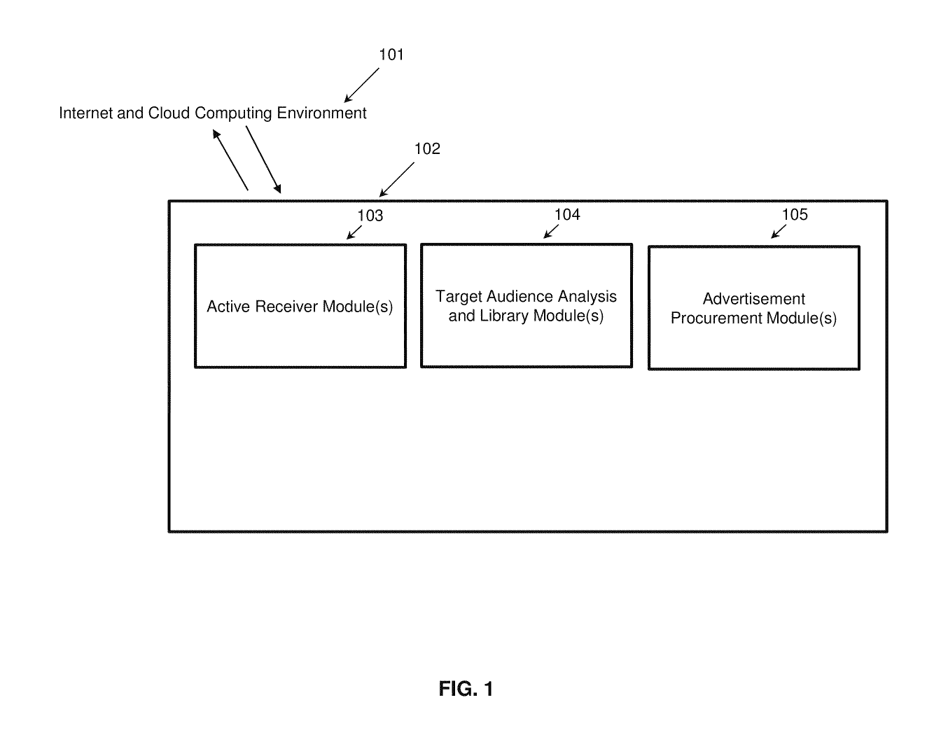

Turning to FIG. 1, the proposed continuous advertisement analysis and procurement system 102 includes an active receiver module 103, a target audience analysis and library module 104, and an advertisement procurement module 105. The system 102 is in communication with the Internet or a cloud computing environment, or both 101. The cloud computing environment may be public or may be private. In an example embodiment, these modules function together to: receive social data; identify relationships between the social data; determine or modify (or both) one or more processes used to search for a target audience, the determining or modifying (or both) based on the identified relationships and the received social data; store the determined or modified processes in a library; recommend a process for searching for a target audience from the library based on parameters of a given advertising campaign; perform the recommended process to identify a target audience; launch the advertising campaign using the identified target audience; and obtain feedback about the launched advertising campaign. The social data may include feedback about previous advertisements. The obtained feedback about the launched advertising campaign is used to determine or modify (or both) one more processes in the library. The above computing operations are iterative, or in other words, repeated.

The active receiver module 103 receives social data from the Internet or the cloud computing environment, or both. The active receiver module 103 is able to simultaneously receive social data from many data streams. The active receiver module 103 also analyses the received social data to identify relationships amongst the social data. Units of ideas, products, services, companies, brands, trademarks, thoughts, people, location, groups, companies, words, numbers, images, or values are herein referred to as concepts. The active receiver module 103 identifies at least two concepts and identifies a relationship between the at least two concepts. For example, the active receiver module identifies relationships amongst originators of the social data, the consumers of the social data, and the content of the social data. The receiver module 103 outputs the identified relationships.

The target audience analysis and library module 104 uses the relationships and social data to determine or modify processes or algorithms used to search for a target audience. The module 104 also includes one or more libraries of processes or algorithms used to search for a target audience. For example, the target audience analysis and library module uses machine learning to determine or modify processes or algorithms for searching for a target audience.

The advertisement procurement module 105 obtains information about a proposed advertising campaign and is used to determine one or more algorithms to be used to search for a target audience for the proposed advertising campaign. The module 105 communicates with the module 104 to determine the one or more target audience search algorithms. Determining the target audience search algorithms to be used may be based on user selection, or preferably is automatically performed by the computing system. At least one of module 104 and 105, or both modules, perform the algorithms to determine the target audience. The advertisement procurement module 105 is also configured to perform computer simulations to predict the reach of the advertisement amongst the target audience and beyond, as well as to predict the reactions of the advertisement from the target audience. Module 105 is also configured to recommend changes to the advertisement content or format (or both). Module 105 is also configured to automatically compose a digital advertisement file. Module 105 is also configured to modify or recommend a different target audience search algorithm, or to modify or recommend a different target audience. Module 105 determines appropriate communication channels and social networks over which to send the advertisements. Module 105 also is configured to procure the advertisements (e.g. data files) and transmit the same to advertisement networks and social data networks. Module 105 is also configured receive feedback about the advertisements using trackers associated with the newly composed social data.

In an example embodiment, there are multiple instances of each module device. For example, multiple active receiver modules 103 are physically located in different geographic locations. One active receiver module is physically located in North America, another active receiver module is located in South America, another active receiver module is physically located in Europe, and another active receiver module is physically located in Asia. Similarly, there may be multiple target audience analysis and library modules and multiple advertisement procurement modules. These modules will be able to communicate with each other and send information between each other. The multiple modules allows for distributed and parallel processing of data. Furthermore, the multiple modules physically positioned in each geographic region may be able to obtain social data that is specific to the geographic region and transmit social data to computing devices (e.g. computers, laptops, mobile devices, tablets, smart phones, wearable computers, etc.) belonging to users in the specific geographic region. In an example embodiment, social data in South America is obtained within that region and is used to compose adveritsement data that is transmitted to computing devices within South America. In another example embodiment, social data is obtained in Europe and is obtained in South America, and the social data from the two regions are combined and used to compose advertisement data that is transmitted to computing devices in North America.

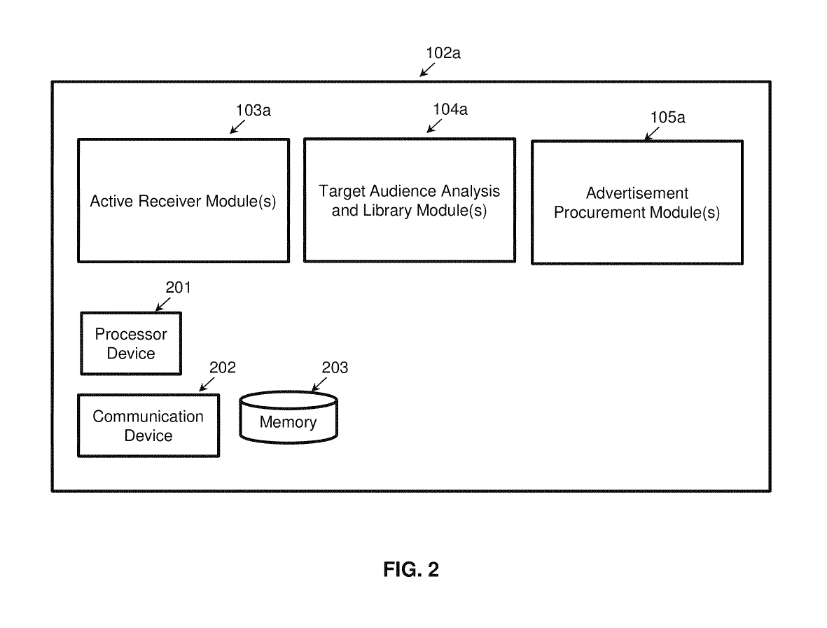

Turning to FIG. 2, an example embodiment of a system 102a is shown. For ease of understanding, the suffix “a” or “b”, etc. is used to denote a different embodiment of a previously described element. The system 102a is a computing device or a server system and it includes a processor device 201, a communication device 202 and memory 203. The communication device is configured to communicate over wired or wireless networks, or both. The active receiver module 103a, the target audience analysis and library module 104a, and the advertisement procurement module 105a are implemented by software and reside within the same computing device or server system 102a. In other words, the modules may share computing resources, such as for processing, communication and memory.

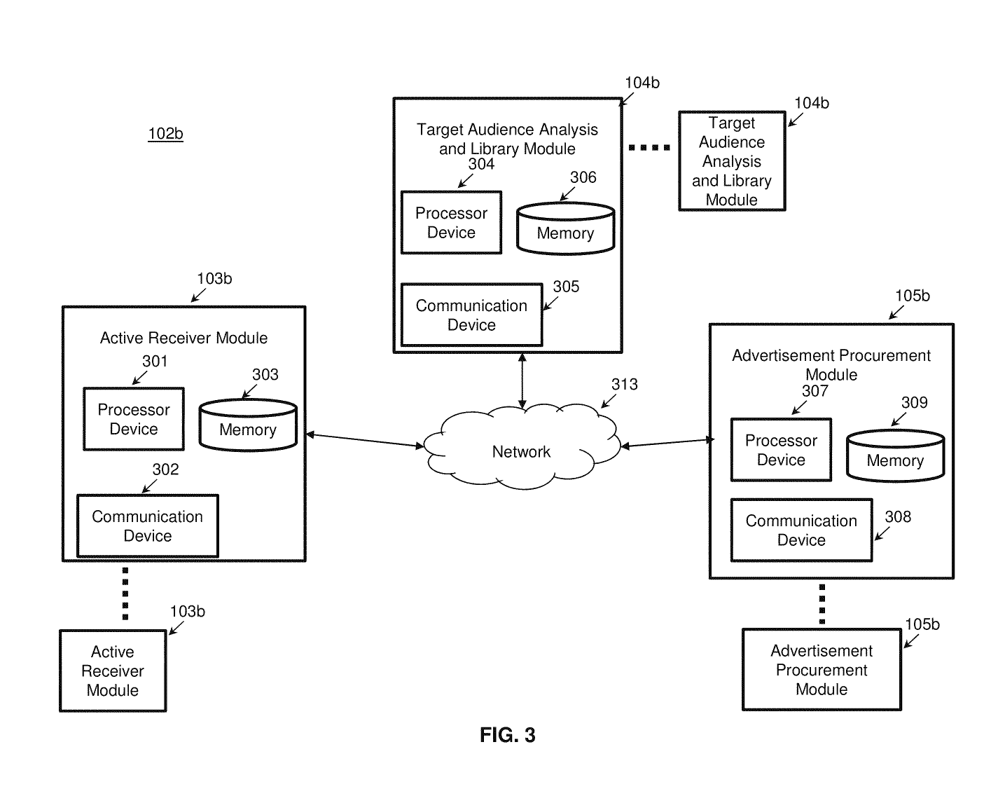

Turning to FIG. 3, another example embodiment of a system 102b is shown. The system 102b includes different modules 103b, 104b, 105b that are separate computing devices or server systems configured to communicate with each other over a data network 313. In particular, the active receiver module 103b includes a processor device 301, a communication device 302, and memory 303. The target audience analysis and library module 104b includes a processor device 304, a communication device 305, and memory 306. The advertisement procurement module 105b includes a processor device 307, a communication device 308, and memory 309.

It can be appreciated that there may be single or multiple instances of each module that are able to communicate with each other using the network 313. As described above with respect to FIG. 1, there may be multiple instances of each module and these modules may be located in different geographic locations.

It can be appreciated that there may be other example embodiments for implementing the computing structure of the system 102.

It is appreciated that currently known and future known technologies for the processor device, the communication device and the memory can be used with the principles described herein. Currently known technologies for processors include multi-core processors. Currently known technologies for communication devices include both wired and wireless communication devices. Currently known technologies for memory include disk drives and solid state drives. Examples of the computing device or server systems include dedicated rack mounted servers, desktop computers, laptop computers, set top boxes, and integrated devices combining various features. A computing device or a server uses, for example, an operating system such as Windows Server, Mac OS, Unix, Linux, FreeBSD, Ubuntu, etc.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the system 102, or any or each of the modules 103, 104, 105 or accessible or connectable thereto. Any application or module herein described may be implemented using computer readable/executable instructions that may be stored or otherwise held by such computer readable media.

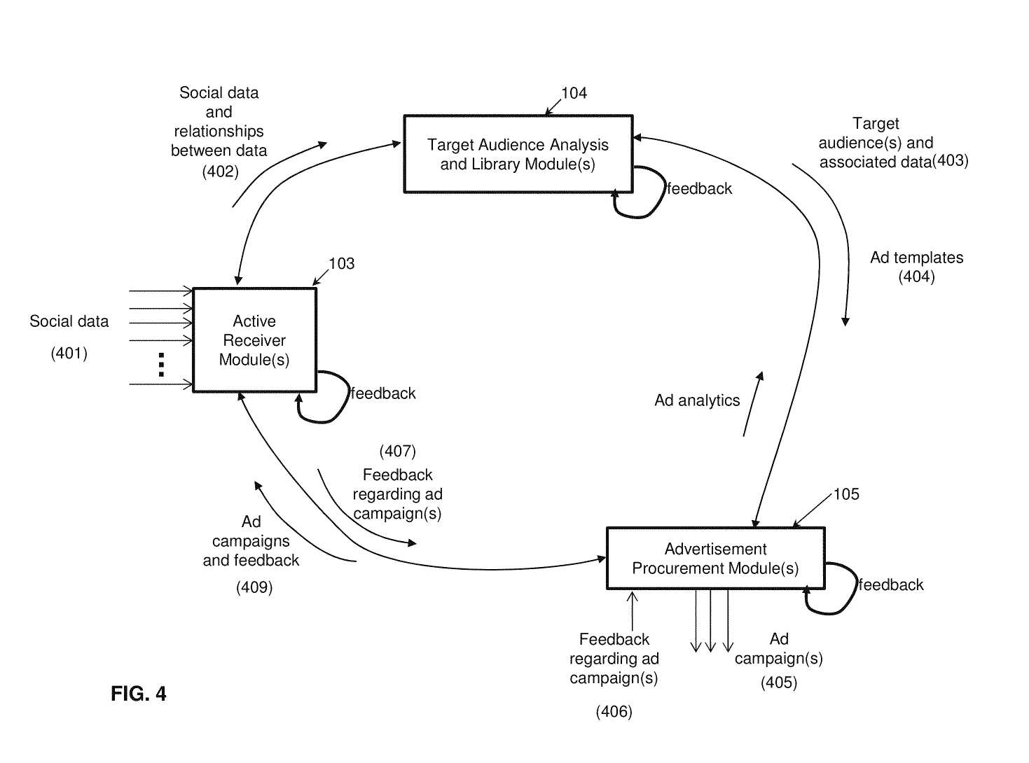

Turning to FIG. 4, the interactions between the modules are shown. The system 102 is configured to listen to data streams, determine or modify (or both) processes to search for target audiences, procure advertisement campaigns, listen to what people are saying about the launched content.

In particular, the active receiver module 103 receives social data 401 from one or more data streams. The data streams can be received simultaneously and in real-time. The data streams may originate from various sources, such as Twitter, Facebook, YouTube, LinkedIn, Pinterest, blog websites, news websites, company websites, forums, RSS feeds, emails, social networking sites, advertisement networks, marketing networks, etc. The active receiver module 103 analyzes the social data, determines or identifies relationships between the social data, and outputs these relationships 402.

In a particular example, the active receiver module 103 obtains social data about a particular car brand and social data about a particular sports team from different social media sources. The active receiver 103 uses analytics to determine there is a relationship between the car brand and the sports team. For example, the relationship may be that buyers or owners of the car brand are fans of the sports team. In another example, the relationship may be that there is a high correlation between people who view advertisements of the car brand and people who attend events of the sports team. The one or more relationships are outputted.

The target audience analysis and library module 104 obtains these relationships 402 and obtains social data corresponding to these relationships. The target audience analysis and library module 104 uses these relationships and corresponding data to determine or modify (or both) processes or algorithms for searching for a target audience. The search processes or algorithms, the target audiences and the associated data (403) are made available to the advertisement procurement module 105. The relationships and corresponding data may also be used to determine or modify (or both) templates (404) used for an advertisement. The target audience analysis and library module 104 can apply analytics and machine learning to recommend an appropriate, or optimal, target audience search process or algorithm that is machine-created using various social data geared towards a given advertising campaign. The target audience analysis and library module 104 can also apply analytics and machine learning to recommend an appropriate, or optimal, template for an advertisement that is machine-created using various social data geared towards a given advertising campaign and target audience.

Continuing with the particular example, the target audience analysis and library module 104 modifies a target audience search algorithm that is geared towards finding a target audience for advertising the car brand. In particular, the search algorithm is modified to find people who have an affinity to the sports team (e.g. people who attended a game of the sports team, people who follow or subscribe to content related to the sports team, people who purchased merchandise of the sports team, people who follow other people that are closely associated with the sports team, etc.). The search algorithm may be modified using machine learning. It will be appreciated that the people who have an affinity to the sports teams are also good candidates for positively responding to an advertisement about the car brand, since there is a high correlation between the car brand and fans of the sports team. Data associated with the search algorithm is collected, including the parameters used to find the target audience and features or statistics about the identified target audience. This associated data is also sent to the advertisement procurement module 105.

In another aspect, continuing with the particular example, the target audience analysis and library module 104 is also configured to provide digital advertisement templates. For example, based on the relationships between the sports teams and the car brand, digital advertisement templates for the car brand may be automatically composed to include a sports theme similar to messages and announcements made by the sports team. For example the layout and font of the car brand advertisement template may be similar to the layout and font of messages and announcements made by the sports team.

In an example embodiment, the advertisement template is a data file with predefined tags identifying attributes about the font, the placement of images, the placement of text, the colors, the sizing, and other visual aspects. For example, the module 104 determines the relative pixel location of text and the relative pixel location of an image in a sports team message, and in particular the pixel locations are determined relative to the boundaries or edges of the sports team message. The relative pixel locations and associated type of data (e.g. image or text) is stored as tags in the advertisement template. In particular, the same relative pixel locations are used to create the advertisement template, such that advertisement text is placed at a similar or same relative pixel location as the text in the sports team message, and such that an advertisement image is placed at a similar or same relative pixel location as the image in the sports team message. Image recognition or, meta data or data tags associated with the sports team message, is used to identify the font (e.g. including color, size, etc.) of the text in the sports team message, which the module 104 incorporates as font tags in the advertisement template. Similarly, image recognition is used to identify predominant colors in an image of the sports team message (e.g. top two or three highest percentages of pixels having the same colors). The module 104 then incorporates tags identifying the colors of the image for the advertisement template, so that images inserted into the advertisement template include the same or similar predominant colors. For example, if the sports team image predominantly includes blue and white pixels, then the advertisement image is selected or digitally modified to predominantly include blue and white pixels, or a shade of blue pixels and a shade of white pixels. It will be appreciated that the advertisement image may be different than the sports team image, such as a picture of a car compared to a picture of a sports team logo.

The advertisement procurement module 105 obtains the target audience search algorithm(s), the target audience(s) and any associated data (403) from the module 104. The advertising templates (404) may also be obtained. In an example embodiment, a graphical user interface is provided by module 105 to select a desired or recommended target audience search algorithm and initiate computation of the selected target audience search algorithm. In another example embodiment, the module 105 obtains information about the desired advertising campaign and automatically determines and selects one or more recommended target audience search algorithms. The module 105 may also automatically determine and select one or more recommended advertising templates based on the obtained information about the desired advertising campaign.

The module 105 is also configured to determine on which social data networks the advertising campaign is to be launched, or in other words, transmitted. The module 105 also performs simulations to predict the potential reach of the advertisements. The reach may include identifying how many people may receive the advertisement, including re-transmissions of the advertisement by individuals or secondary networks, and sharing of the advertisement amongst friends. The reach may also include identify who the potential people are that may receive the advertisement, and may further include the location and demographic information of the potential people. The simulation may also predict potential response and reaction to the advertisement (e.g. positive or negative responses). Based on the simulation outcomes, any one or more of the target audience, the content or format of the advertising, and the transmission details (e.g. social data network, time and date, countries, etc.) may be modified.

After the details of the advertising campaign are complete, the module 105 procures and sends the advertisement campaign (405) to the social data networks and advertising networks. The module 105 receives feedback about the advertising campaign (406) from the advertising networks and social data networks. The module 105 may also receive feedback about the advertising campaign (407) from the active receiver module 103. The module 105 performs analysis of the feedback and sends the results of the analysis (e.g. analytics) (408) to the target audience analysis and library module 104. The module 104 uses the analytics as feedback to modify one or more target audience search algorithms.

The details about the advertising campaign and the analytics (409) may also be sent from module 105 to the active receiver module 104. The active receiver module 104 uses this information to more accurately obtain additional feedback information about the advertising campaign. The active receiver module 104 may also use this information to identify new relationships between data concepts.

Continuing with the particular example regarding the car brand and the sports team, the advertisement and procurement module 105 obtains the target audience search algorithm about people who may be interested in the car brand, particularly fans or followers of the sports team. The target audience search algorithm is executed or computed by either one, or both of, modules 105 and 104, and the identified target audience is outputted. An advertisement template, provided by module 104, is used by module 105 to compose an advertisement. In particular, content about the car brand is used to populate the advertisement template. The module 105 runs a simulation to predict the reach and the response if the composed advertisement were to be sent to the identified target audience. Based on the predictions, changes may be made to the target audience or the advertisement, or both.

In another aspect of the particular example, special events, such as a competition event, like a game or a match, for the sports team are identified to determine the scheduling or timing for when the composed advertisement should be transmitted. In particular, the composed advertisement is scheduled to be transmitted on a date/time that coincides with the date/time of the special event. Location of targeted readers will also be used to determine the language of the composed advertisement and the local time at which the composed advertisement should be transmitted. Markers, such as number of clicks, number of forwards, time trackers to determine length of time the composed advertisement is viewed, etc., are used to gather information about people's reaction to the composed advertisement.

The composed advertisement is sent to the social data networks and advertising networks. Feedback about the advertisement is obtained by module 105 or 103, or both. For example, the feedback indicates that people are positively responding to the advertisement and are using slang or jargon to positively describe the advertisement. The feedback may also make reference to the sports team. The feedback may be used to modify the advertisement to include the slang or jargon, or reference the sports team in a similar manner. The feedback may also reveal that people who are fans of a different sports team are also reacting positively to the car brand advertisement. The feedback is used by module 104 to modify the target search algorithm to find fans of the different sports team. In this way, a subsequent advertising campaign for the car brand may have a larger reach, or in other words, will be viewed by a larger targeted audience.

Continuing with FIG. 4, the active receiver module 103 receives the advertising about the car brand and the associated feedback. The active receiver module 103 analyses this data to determine if there are any relationships or correlations. For example, the feedback can be used to determine or affirm that the relationship used to generate the advertising and the target audience is correct, or is incorrect.

Continuing with the particular example regarding the car brand and the sports team, the active receiver module 103 receives the composed social data and the associated feedback. If the feedback shows that people are providing positive comments and positive feedback about the composed social data, then the active receiver module determines that the relationship between the car brand and the sports team is correct. The active receiver module may increase a rating value associated with that particular relationship between the car brand and the sports team. The active receiver module may mine or extract even more social data related to the car brand and the sports team because of the positive feedback. If the feedback is negative, the active receiver module corrects or discards the relationship between the car brand and the sports team. A rating regarding the relationship may decrease. In an example embodiment, the active receiver may reduce or limit searching for social data particular to the car brand and the sports team.

Continuing with FIG. 4, each module is also configured to learn from its own gathered data and to improve its own processes and decision making algorithms. Currently known and future known machine learning and machine intelligence computations can be used. For example, the modules 103, 104 and 105 have feedback loops. In this way, the process in each module can continuously improve individually, and also improve using the feedback provided amongst the modules. This self-learning on a module-basis and system-wide basis allows the system 102 to be completely automated without human intervention.

It can be appreciated that as more data is provided and as more iterations are performed by the system 102 for sending advertisements, then the system 102 becomes more effective and efficient.

Other example aspects of the system 102 are described below.

The system 102 is configured to capture social data in real time.

The system 102 is configured to analyze social data relevant to a business, a product, a service, or a person or party, in real time.

The system 102 is configured to store, generate and modify search algorithms used to identify target audiences for advertising.

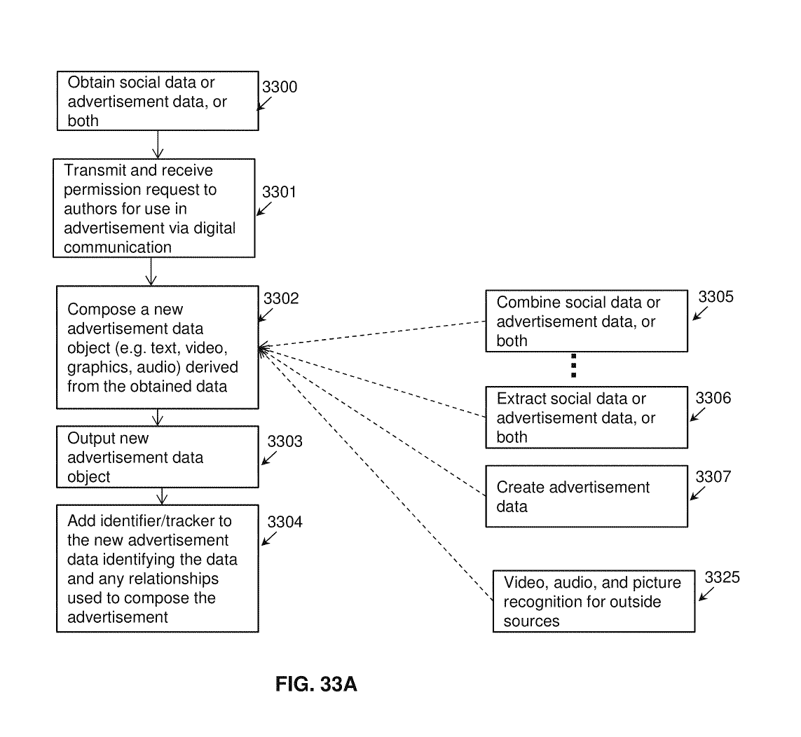

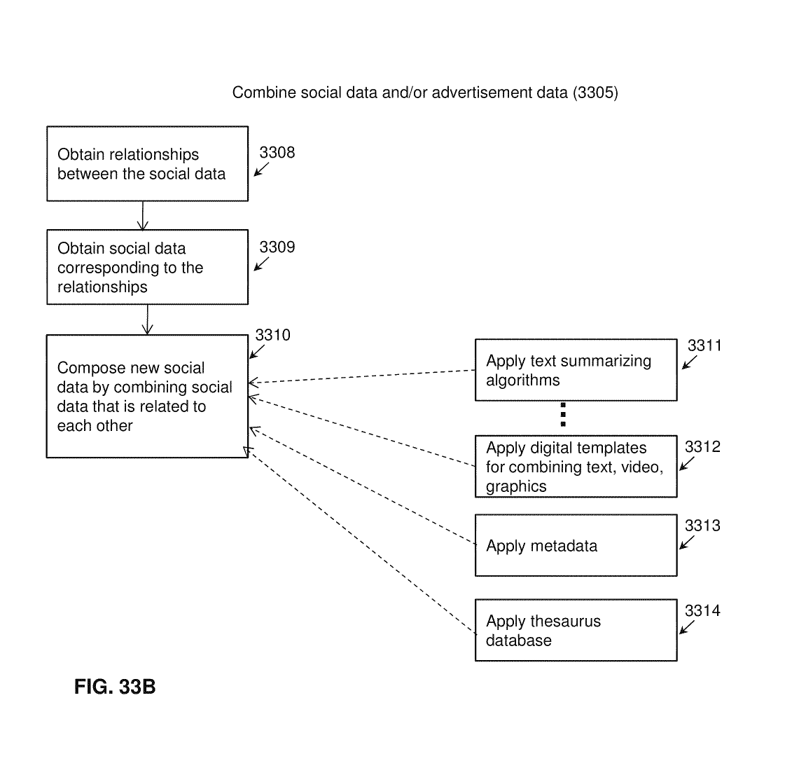

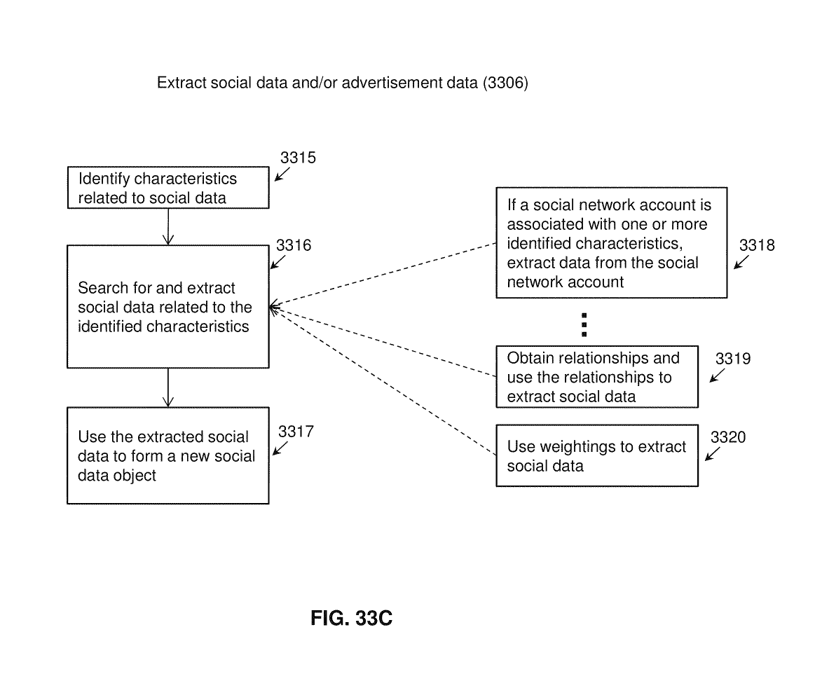

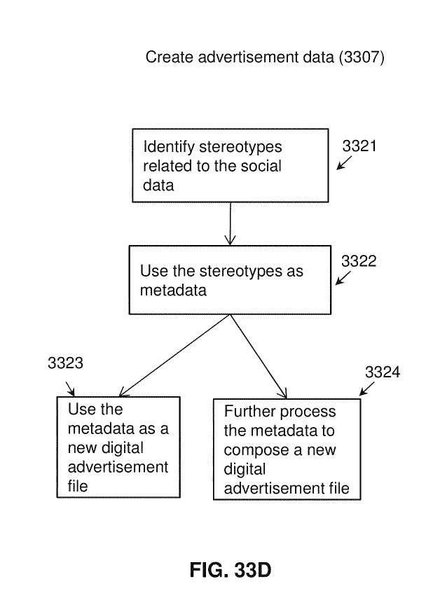

The system 102 is configured to create and compose advertisements that are targeted to certain people or a target audience, in real time. Further details regarding the composition of advertisements is described below, for example, with reference to FIGS. 33 to 36.

The system 102 is configured to determine the best or appropriate times to transmit the advertisements.

The system 102 is configured to determine the best or appropriate social data channels to reach the selected or targeted people or groups.

The system 102 is configured to determine what people are saying about the new advertisement sent by the system 102.

The system 102 is configured to apply metric analytics to determine the effectiveness of the advertisement process.

The system 102 is configured to determine and recommend analysis techniques and parameters, advertising content, advertising formatting, transmission channels, target audience people, and data scraping and mining processes to facilitate continuous loop, end-to-end communication relating to advertisements.

The system 102 is configured to add N number of systems or modules, for example, using a master-slave arrangement.

It will be appreciated that the system 102 may perform other operations.

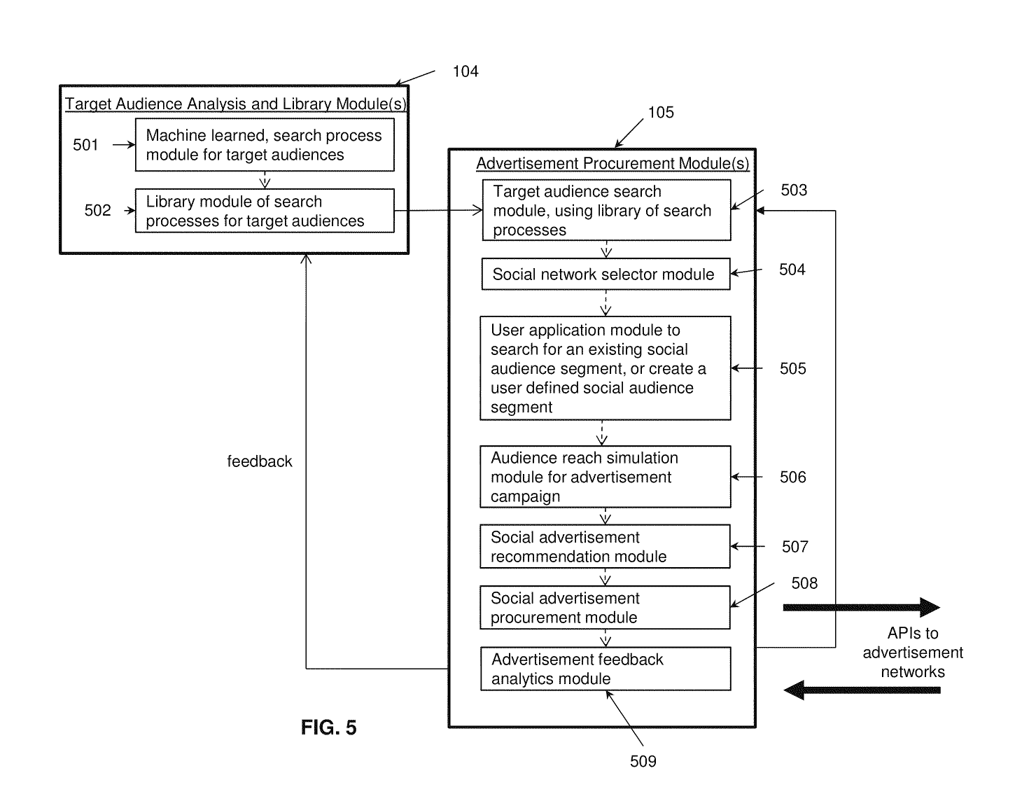

Turning to FIG. 5, an example embodiment of modules 104 and 105 are shown interacting with each other. Module 104 includes modules 501 and 502. Other modules may be included in the target audience analysis and library modules, such as an advertising templates module to generate and store digital advertising templates, but for the purposes of FIG. 5, these other modules are not shown. Module 501 is configured to at least one of generate, obtain and modify search processes or search algorithms for searching for a target audience. The generation, obtaining, or modifying operations are driven by machine learning algorithms. In particular, the machine learning algorithms use data from the active receiver module 103 or data from the advertisement procurement module 105 (or both) to automatically determine parameters and calculations associated with the target audience search algorithms. The generated, obtained or modified target audience search algorithms are stored in the library module 502. Information or metadata associated with each target audience search algorithm is also stored in the library module 502. The associated information or metadata may be used to identify the situation in which a given target audience search algorithm is applicable. For example, one target audience search algorithm has the following associated information or metadata: suitable for advertising for company A, company B, company C; suitable for advertising for product type X, product type Y, product type Z; and target audiences are adult males and adult females. For example, a second target audience search algorithm has the following associated information or metadata: suitable for advertising for advertising for service Q, service R, service S; target audiences are in geographical location A; and target audience is female. It will be appreciated that different target audience search algorithms may have different associated information including any one or more of: a particular applicable company, a particular applicable service or product (or both), a particular demographic, a particular location of the target audience, a particular time period in which the target audience has shown interest in a relevant concept (e.g. the advertised product/service, or an event, a product, a person, a company, a location, a service related to the advertised product/service). For example, the target audience search algorithm may look for people who have shown an interest in the past six months (or some other time period) about an event, a product, a person, a company, a location, or a service which is related to the advertised product/service. It is appreciated that the associated information or metadata may be used by the advertisement procurement module to determine the most appropriate target audience search algorithm(s) to use.

Continuing with FIG. 5, the library module 502 may be accessed by the advertisement procurement module 105. In particular, the module 105 includes a target audience search module 503, which accesses the library module 502 to search for the most appropriate target search audience algorithm(s). In a preferred example embodiment, information about the advertisement campaign is obtained by the module 105 and the module 503 automatically identifies the most appropriate target search audience algorithm(s). For example, information about the advertising campaign is compared with information or metadata associated with each given target audience search algorithm. The information or metadata that best matches the advertising campaign information is used to identify the target audience search algorithm(s). The identified target audience search algorithm(s) are then computed or executed to output one or more target audiences.

In an example embodiment, the proposed advertising campaign includes one or more of following associated metadata: brand name, demographic of the target audience and geographical location of the target audience (e.g. region or country). This metadata of the proposed advertising campaign is compared with metadata of a target set (e.g. a combination of inputs and a target audience search algorithm) in order to select the target set.

In another example embodiment, module 503 provides a graphical user interface (GUI) that allows a user to input information about the advertising campaign. One or more recommended target audience search algorithms are then provided or displayed via the GUI for user selection. Based on the user selection, one or more selected target audience search algorithms are then computed or executed to output one or more target audiences.

Module 105 also includes a social network selector module 504 which automatically, or semi-automatically, selects one or more social data networks or distribution channels to send the advertisements to the target audience. In an example embodiment, the social data networks or distribution channels that may be used to communicate to the target audience is obtained. It may be that several social data networks may be used in order to reach the entire target audience. It may also be that one or more persons in the target audience are part of multiple social data networks or distribution channels, so that using multiple social data networks to send the advertisement may overlap certain persons. It may also be that particular social networks have a more positive advertising effect for a given product or service. It may also be that using particular social networks may incur an advertising cost. It may also be that the party or company launching the advertising campaign previously used certain social networks, and has preference for those previously used social data networks. These factors are considered by module 504 when automatically selecting social data networks and distribution channels for the advertisement. Machine learning may be used to consider the above factors when deciding upon the social data networks.

In another example, module 504 automatically uses the above factors to provide recommended social data networks and distribution channels for the advertisement. A GUI is displayed showing the recommendations and a user is able to select from the shown recommendations. The GUI may also enable a user to override the recommended social data networks and distribution channels, and a user may select other social data networks and distribution channels that were not recommended.

Continuing with FIG. 5, user application module 505 is configured to enable a user customize advertising campaign parameters, content, and settings. Module 505 is not used when the system 102 is entirely automatic and does not include human input. Module 505 is used when the user wishes to customize the system 102 and, in particular, to search for an existing social audience segment or create a user defined social audience segment.

For example, module 505 is configured to display a graphical user interface to receive from a user one or more of the following types of information: an advertising budget (e.g. money amount for advertising), calendar dates to run the advertising campaign(s) and or program(s), calendar dates to run A/B test campaign(s), language of the advertising campaign, geographic location of the advertising campaign, and any demographic information. The user may provide other information via the GUI of module 505. Other non-limiting examples of information include performance and exposure parameters. Based on the information provided by the user, module 505 is configured to recommend an advertising campaign.

For example, the module 505 receives from the user a given date, a given amount of money budgeted for the advertising campaign, and other information. The module 505 then provides a portfolio of social data network channels with the appropriate content and target audience sets. For example, the identified target audience based on the provided information are women ages 13 to 19 years old and who like Beyonce. Accordingly, the recommended social data network channels include: the people associated with X fan page for Twitter, the people associated with Y fan page for Facebook and the people associated with Z fan page for Tumblr.

Continuing with FIG. 5, module 105 also includes a simulation module 506 which simulates the audience reach for an advertisement campaign. The simulation may also include responses from people. Module 506 is configured to obtain information and performance about other advertising campaigns, including the target audience, the advertising content, and the feedback related to the advertising. The data from the past advertising campaigns are analysed to determine patterns, trends and effectiveness, and those recognized patterns, trends and effectiveness are used to predict the reach of the proposed advertising campaign. Similarly, the recognized patterns, trends and effectiveness are also used to predict the response from the target audience about the proposed advertising campaign.

The simulation, for example, predicts how an advertisement is re-posted and shared amongst users in a social data network. In another example, the simulation predicts how an advertisement is re-posted and shared across users in different social data networks. This is also herein referred to as the dissemination of the advertisement. In Twitter, for example, people may re-Tweet or re-post a message, extending the reach of the message. In Twitter, people may also reply to a message, which also extends the reach of the message. In Twitter, people may also mention another user, without meaning to explicitly reply. If the other user being mentioned has posted the message, the mention from people may extend the reach of the message. It will be appreciated that the message includes or is linked to the advertisement. It will also be appreciated that other forms of re-sending, re-posting, replying, etc. in other social data networks may be used to extend the reach of the advertisement campaign.

Based on the interaction of users in one or more social data networks, influential users and their communities are established. The relationships amongst influential users, or influencers and their communities may be used to predict the spread or reach of an advertisement. It will be appreciated that example embodiments of processes used to identify influencers and their communities are described in U.S. patent application No. 62/020,833, filed Jul. 3, 2014, and titled “Systems and Methods for Dynamically Determining Influencers in a Social Data Network Using Weighted Analysis”, the contents of which are incorporated herein by reference.

It will be appreciated that there may be different ways to perform the computer simulations. Non-limiting example approaches may include: the Group method of data handling, the Naive Bayes classification, the k-nearest neighbor algorithm, the majority classifier which takes non-anomalous data and incorporates it within its calculations, support vector machines, random forests, boosted trees (e.g. gradient boosting, classification and regression trees (e.g. decision tree learning), multivariate adaptive regression splines, and artificial neural networks. Other simulation approaches include Monte Carlo simulations and using Markov chains for prediction.

The simulations may also provide correlation analytics, re-amplification or re-posting predictions, and predictions about likes or dislikes of the advertising. This is also referred to as predicting sentiment feedback to a proposed advertisement.

In an example embodiment of the computer simulations, a prediction is made based on the way similar data was disseminated and received in the past. The similar data may be been an advertisement, but may not necessarily be an advertisement. In other words, the proposed advertisement data used for the simulation may be similar to a message, video or other social data object which is not necessarily an advertisement.

More generally, several predictions or computer simulations are obtained. One prediction is computed by simulating a highest dissemination pattern possible for a given topic or brand, or both, and for a given group of people. A second prediction includes computing a simulation for a lowest dissemination pattern possible for a given topic or brand, or both, and for a given group of people. An average estimate is then computed by calculating the average between the high estimate and the low estimate. The computing system displays the highest predicted dissemination (e.g. a best case scenario), the lowest estimated dissemination (e.g. a worst case scenario), and an average dissemination (e.g. an expected case).

In another example embodiment, instead of or in addition to predicting dissemination of the proposed advertisement, the computing system predicts the sentiment feedback to the proposed advertisement, including computing a highest possible sentiment feedback value and a lowest possible sentiment feedback value. An average value of the two sentiment feedback values is computed by the computing system, and these values may be displayed to a user.

Based on the output of the simulation, the adjustments or modifications are made to any one of the target audience, the content or format (or both) of the advertisement, and the transmission details of the advertisement. For example, if the simulation outputs that the number of users reached by the advertisement is below a certain threshold, a modified advertisement is created for a subsequent simulation or a new target audience is computed for a subsequent simulation, or both. Similarly, if the simulation outputs that the text feedback response from users will be negative (e.g. simulated feedback includes words like “dislike”, “disagree”, “hate”, “boring”, “waste”, “wrong”, “bad”, “terrible”, “rip-off”, “overpriced”, “ugly”, etc.), then a modified advertisement is created for a subsequent simulation or a new target audience is computed for a subsequent simulation, or both.

In a preferred example embodiment, the adjustments or modifications are automatically made, without human intervention. In another example embodiment, the results of the simulation are presented to a user, along with recommended adjustments or modifications. Responsive to user input, the user-selected adjustments or modifications are implemented by module 105.

Module 105 also includes a social advertisement recommendation module 507, which recommends words, phrases and other content (e.g. images, graphics, sounds, video, etc.) for the advertisement. The content is adjusted, for example, based on the results of the simulation module 506. The content may also be adjusted to be geared towards the target audience. Additional parameters about the advertising campaign are recommended, including the number of time the advertisement should be sent, the time and date of the transmission, the language of the advertisement, and the geographical distribution of the advertisement. Other recommended parameters include whether different advertisements should be bundled or combined to reduce cost or improve reach, or both. The recommendations from module 507 may be automatically implemented without human intervention, according to an example embodiment. In another example embodiment, the recommendations are presented to a user, and the user provides input indicating which of the recommendations are to be implemented. Other modifications may be made by the user, which may not be part of the recommendations produced by module 507.

The module 105 also includes a social advertisement procurement module 508. After the parameters of the advertising campaign are finalized and the content of the advertisement is finalized, the module 508 automatically procures the advertisements on the one or more selected advertising networks or social data networks. The procuring process includes purchasing the advertisement from the relevant social data networks or advertising networks, or both. The procuring process further includes the module 105 inserting data markers or data beacons into the advertising content so that feedback about the advertising may be more easily tracked. It will be appreciated that data markers or data beacons are code or software incorporated into the advertising file, and which are recognizable by the computing system 102, including the active receiver module 103. In an example embodiment, the data markers or beacons obtain information about the user viewing the advertisement, such as IP address, date and time the advertisement is viewed, when the advertisement is sent to another computing device, etc. The data markers or beacons may trigger a computing device in the social data network to transmit this obtained information back to the advertisement computing system 102, for which a URL address may be included in the marker or beacon. The procuring process further includes uploading the advertising content to the relevant social data networks or advertising networks, or both. The procuring process further includes sending information identifying the target audience and the transmission parameters. The interaction between the procurement module 508 and the social data networks or the advertising networks, or both, are facilitated using application programming interfaces (APIs).

Continuing with FIG. 5, module 105 also includes an advertisement feedback analytics module 509. After procuring the advertisement(s), module 509 receives feedback about the performance of the advertisements. The feedback metrics include, for example, click-through numbers, re-post numbers, reply numbers and reply sentiment (e.g. positive, liked, negative, disliked, etc.), and amount of time spent viewing the advertisement. The feedback metrics may also include the speed at which the advertisement is spread, the locations to where the advertisement is spread, and the identity of the people, organizations and parties viewing or spreading the advertisement. The feedback information may be obtained directly from the advertisement networks or social data networks (or both). The feedback information may also be obtained from third-party sources, a non-limiting example of which is the company comScore Inc. The feedback information may also be obtained using the trackers, markers or beacons placed into the advertising content. The feedback information may also be obtained from the active receiver module 103.

The advertisement feedback analytics module 509 is also configured to perform machine learning and natural language processing of the comments that relate to the advertising campaign. For example, social comments are obtained in the timeframe of the advertising campaign. The module 509 processes the text or the audio data in social comments to determine sentiment, mentions, purchase behavior, etc. It is appreciated that correlation techniques may be used to determine if there is a correlation between the comments, the advertisement, and the metrics of sentiment, mentions, purchase behavior, etc.

The feedback results and the metrics are presented or sent to the user that is responsible for the advertising campaign. The module 509 also generates recommendations based on the analytics.

For example, a recommendation may be switch advertising campaign A for advertising campaign B on a certain social data network, and use content M for the advertising campaign B. In another example recommendation, a recommended modification is to increase advertising spending by 50% or some dollar amount on a certain social data network when using campaign C and content N. In another example recommendation, a recommended modification is to increase advertising spending by 200% on a certain social data network and to switch the advertising content to content O. It will be appreciated that other recommendations may be made, including modifying the time or schedule of when the advertisement is to be sent, modifying the language of the advertisement, modifying the advertisement to include language used in feedback comments, and modifying the target audience.

The feedback is also sent to the target audience analysis and library module 104 and to other modules within the advertisement procurement module 105. Although not shown in FIG. 5, the feedback may be sent to the active receiver module 103.

The module 104 uses the feedback to adjust the target audience search algorithms. For example, based on the spread or reach of the advertising campaign, new users and new influential users may be identified as part of the target audience. The algorithms may be modified to search for people including the new users and the new influential users, as well as people that are similar to the new users and the new influential users.

Module 503 may use the feedback to adjust which target audience search algorithms are to be recommended for the current advertising campaign, and may be used to adjust parameters of the recommendation algorithm to affect how future target audience search algorithms are recommended for future advertising campaigns.

Module 504 may use the feedback to adjust which social data networks or advertising networks are to be recommended for the current advertising campaign. The feedback may also be used to adjust parameters of the network selection algorithm to affect how one or more social data networks or advertising networks are recommended for future advertising campaigns.

Module 506 may use the feedback to adjust simulation parameters, for example by providing data about patterns, trends and effectiveness of the current advertising campaign.

Module 507 may use the feedback to adjust other parameters related to the advertising campaign.

It is appreciated that the adjustments made using the feedback may be performed automatically, without human intervention. In other words, the process shown in FIG. 5 may be completely automatic and may automatically repeat. With each iteration, the advertising campaign may be adjusted and improve over time.

In another example embodiment, the adjustments are recommended to a user via a GUI, and the user provides approval to implement the adjustments.

It will be appreciated that the operations of modules 503, 504, 505, 506 and 507 are shown being performed according to specific order in FIG. 5, according to an example embodiment. However, the order of the operations associated with modules 503, 504, 505, 506 and 507 may be in a different order than the order shown in FIG. 5. In another example, one or more of the operations associated with modules 503, 504, 505, 506 and 507 may be performed in parallel.

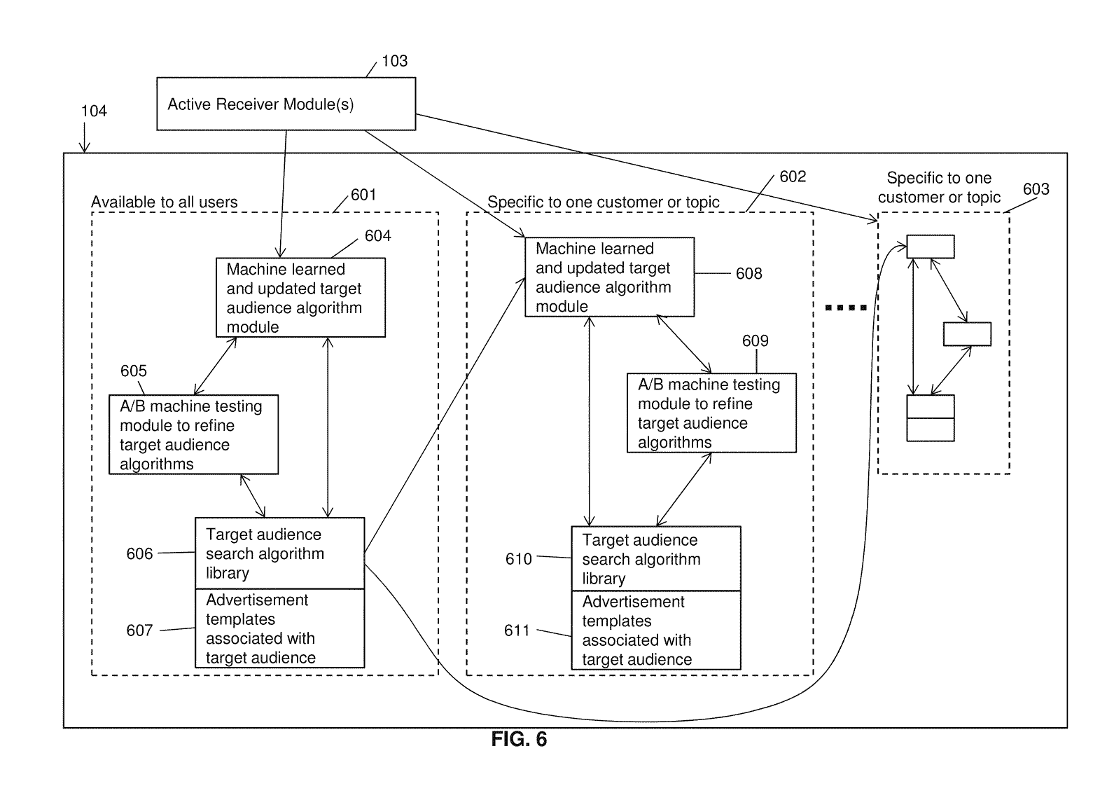

Turning to FIG. 6, example components and interaction between the active receiver module 103 and the target audience analysis and library module 104 are provided. The active receiver module 103 is shown interacting with different sets of processes and data libraries 601, 602, 603, which are part of module 104. In particular, module 104 includes one set of processes and data 601 includes modification processes and a library of target audience search algorithms that are available to all users of the system 102. Another set 602 is specific to a given customer or topic. In other words, only one customer or company has access to set 602, which is customized for the one customer. Control to the different customer sets may include verifying a customer by a password, by an email account, or by an IP address, or a combination thereof. Alternatively, the set 602 is specific to a topic, and any user of the system 102 who subscribes to the topic has access to the set 602. It will be appreciated that there may be multiple custom sets, each set customized and selective accessible based on a customer or topic. For example, there another set 603 is for yet another customer or user of the system 102, or is for yet another topic.

It will be appreciated that the library 606 in the set 601 is accessible to all users and is accessed by certain processes in the custom sets 602 and 603.

Continuing with FIG. 6, the active receiver module 103 sends social data and relationships between the social data to module 604 in set 601. The social data and relationships may also be sent to module 608 in set 602 and the like module in set 603.

In particular, module 604 is configured to apply machine learning to update or generate a target audience search algorithm. The updating or generating of a target audience search algorithm is based on the obtained social data and relationships. Module 604 identifies social patterns which are used to identify a target audience that would be of interest to an advertiser (i.e. a user of the system 102).

Various types of inputs are considered in the machine learning process. One set of inputs includes algorithms that search for recurring social patterns, or algorithms that identify anchor social patterns. Example of social patterns may be specific to: events, people, places, products, sales, brands, services, behaviors, and subjects. Social patterns may also be specific to social channels, such as Twitter, FaceBook, Instagram, Tumblr, etc. “Anchor social patterns” herein refer to patterns that are recurring and are, thus, predictable. Examples of anchor social patterns include: drinking after a sports game, celebrating after the presidential election and buying baby equipment when a woman is pregnant. Hence, events or activities that repeat or occur like clock-work are considered to be anchored patterns.

There may be other types of social patterns that are being identified. The social patterns may also relate different concepts, such as certain people in certain locations behave a certain way, or certain events on certain social channels are more widely discussed. For example, the pattern or relationship may be between Taylor Swift (a pop singer) and a certain brand of headphones, which is identified based on photos and social media messages describing Taylor Swift wearing the certain brand of headphones during a concert in San Francisco, Calif.

Another set of inputs include algorithms that searches for key words and or phrases.

Other algorithms for searching for a target audience may be inputted to module 604, such as search algorithms stored in the target audience search library 606. An example of a target audience search algorithm includes finding an expert or an influencer amongst a group of users for a particular topic, and then identifying the community of users associated with the expert or the influencer. Another example of a target search audience algorithm includes representing users as nodes in a graph, modelling their interactions as edges, and providing a weighting associated with each edge based on the type of interaction and frequency of interaction. The edges may be vectored, that is include a direction indicating which user is following or affecting which user. Based on the weighting and vector of the edges, an influencer and their community may be identified, forming a target audience. Another example of a target audience search algorithm is to identify users that have common interests in a topic. Another example of a target audience search algorithm is to identify users that are friends or followers of a given user, which share similar characteristics as the given user. The given user may be a popular user, an influential user, or considered to be an ideal person for consuming the advertisement.

It will be appreciated that there may be different target audience search algorithms each having various parameters that affect the computation behaviour of the search algorithms. The parameters associated with each search algorithm are also sent as inputs.

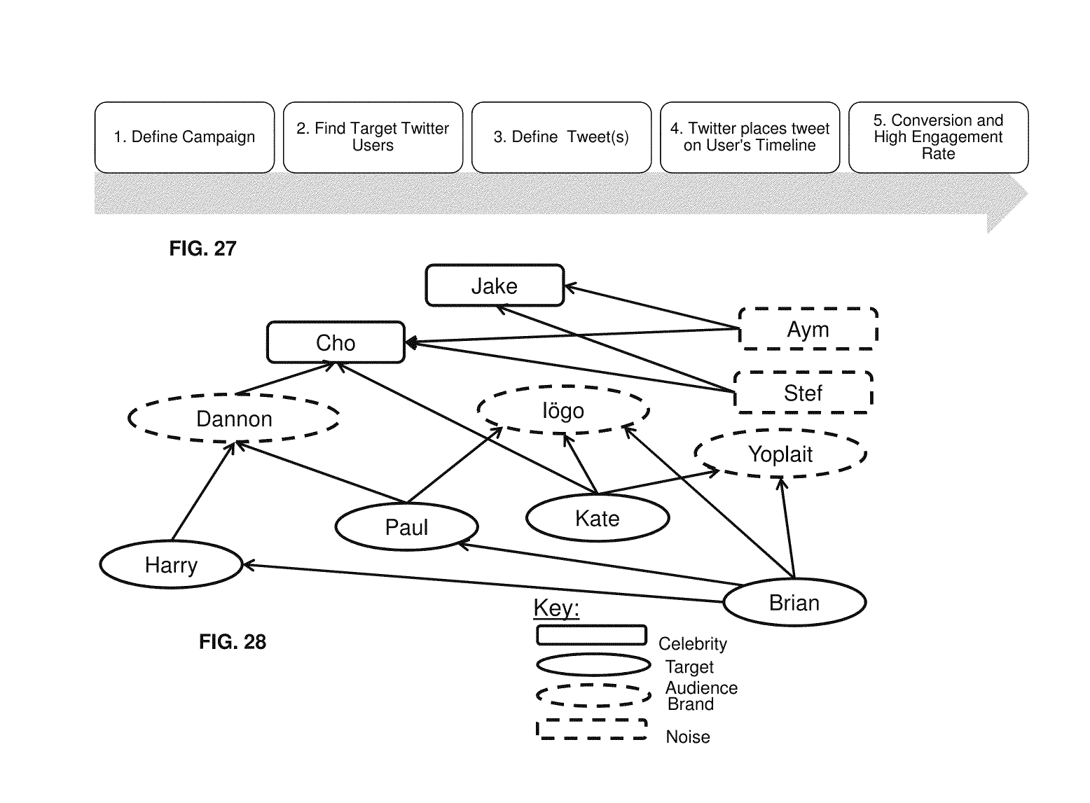

A further detailed description of a preferred example of a target audience search process or algorithm is described with respect to FIGS. 27-32 below.

Another set of inputs includes sentiment and natural language processing results.

Another input may be target audience(s) generated from other processes, or supplied to the system 102 by the user.

As noted above, inputs may come from the library 606 and the active receiver module 103. Inputs may also come from another internal system(s). Inputs may also come from other third-party systems (e.g. Google analytics, Twitter Analytics, ComScore, etc.)

Module 604 uses machine learning to combine the various inputs that always have a direct and or high correlation to one another.

In another aspect, module 604 uses machine learning to determine combinations of inputs that do not correlate with each other, or have a high probability of never correlating with one another. This relationship may be used, for example, to filter out topics, words or images that do not correlate to a given topic.

For example, a threaded conversation of messages amongst users in a social data network is directed to the topic of anti-terrorism activities. In the threaded conversation, a posted message states “I love kitty cats”, which is considered a stray or orthogonal topic. Module 604 would apply natural language processing and machine learning to identify that there is a high probability that the phrase “I love kitty cats” has no correlation with anti-terrorism. The module 604 would then modify a target search algorithm to filter out or exclude such a stray message, and the related data (e.g. the user who posted the stray message). In this way, for example, advertising related to kitty cats is not directed to the users participating in the threaded conversation about anti-terrorism. In another example, advertising related to anti-terrorism is not sent to the user who posted the stray message.

In an example embodiment, the module 604 predicts and recommends combinations comprising inputs and target audiences. Each unique combination of recommended input(s) and target audience(s) is called a “target set”. There may be N number of target sets. As will be understood, the input includes one or more target audience search algorithms and values defining associated parameters.

These target sets are A/B machine tested (in module 605) over and over with applied machine learning to optimize these sets over time to determine the most effective advertiser target sets to reach and engage an audience.

After N number of A/B machine tested recursions, each target set is then placed into the target audience search algorithm library 606.

In another example, after N number of days, weeks, months, etc. each target set is then placed into the library 606. For example, a target set must be used, tested and modified over a set time period before is considered sufficiently developed and able to be stored in the library 606.

There may be a number of various determinants or thresholds that dictate when a target set is ready to be put into the library 606. Other types of determinants or thresholds include feedback from those people receiving the advertisements (e.g. the audience), as well as speed or rate at which an advertisement spreads amongst users in one or more social data networks. In another example, a user may simply vote or select a target set to be made available in the library 606.

It will be appreciated that there may be another database (not shown) storing target sets that have not yet matured or sufficiently developed, but are still being tested and modified based on new data and testing. It will also be appreciated that target sets in both the library 606 and the other database may be updated with each iteration. However, the target sets in the other database are not available for use by the advertisement procurement module 105, while the target sets in the library 606 are available for use by the advertisement procurement module 105.

It will be appreciated that module 604 may generate variants of a target set, and each variant is considered a new target set.

Different approaches to machine learning may be used. Non-limiting examples of machine learning approaches include neural networks, fuzzy logic, clustering, and association rule learning.

The target sets being modified, developed, or generated are machine tested, regardless of whether or not they are already stored in the library 606. The machine testing is performed by module 605, which conducts A/B machine testing.

By way of background, A/B machine testing describes a randomized experiment with two variants, A and B, which are the control and treatment in the controlled experiment. It is a form of statistical hypothesis testing with two variants leading to the technical term, Two-sample hypothesis testing, used in the field of statistics. Other terms used for this method include bucket tests and split testing but these terms have a wider applicability to more than two variants. However, these other types of testing may be performed by module 605. The A/B testing (or more generally machine testing) identifies changes to target set that increase or maximize an outcome of interest (e.g., click-through rate for an advertisement, a higher number of re-posts, forwards, replies, purchases, and more positive feedback sentiment). Formally the current target set is associated with the null hypothesis.

Two versions (version A and version B) are compared, which are identical except for one variation that might affect the reach and response of the advertisement. Version A might be the currently used version (control), while Version B is modified in some respect (treatment). Improvements can sometimes be seen through testing elements like the type of target audience search algorithm, the content of advertisement, the parameters of a given target audience search algorithm. The vastly larger group of statistics broadly referred to as Multivariate testing or multinomial testing is similar to A/B testing, but may test more than two different versions at the same time and/or has more controls, etc. The module 606 is also configured to use multivariate testing.

The machine testing module 605 is able to rank target sets based on their success as well as group target sets based on similar features (e.g. similar ones of inputs and/or similar target audiences).

The above processes associated with target sets, which are related to combinations of inputs and a target audience, may also apply to template sets. A “template set” is a combination of inputs and an advertisement template. The inputs into the template set include many of the same inputs mentioned above. The template sets are similarly A/B machine tested. Those template sets that are determined to be developed and have met a certain threshold are stored in the advert template library 607. In an example embodiment, each target set is associated with a template set, although not necessarily.

It will be understood that modules 608, 609, 610 and 611 and the corresponding operations in set 602 are respectively generally the same as the modules 604, 605, 606 and 607 and the associated operations, as per set 601. However, the modules 608, 609, 610 and 611 are specific to a one company or customer, or one topic. It is recognized that a company or advertiser may wish to develop their own custom target set library and custom advertisements, which may be considered a secret. These target sets and template sets are not to be shared with other companies or advertisers using the system 102. Accordingly, it will be understood that while machine learning module 608 is able to obtain inputs from the target set library 606 from all users, the machine learning module 604 is not able to obtain inputs from the target set library 610 which is specific and secret to a given company or advertiser.

The operations of set 603 are similar to the operations of set 602.

It will be understood that the performance and inputs of sets 602 and 603 may be at least as comprehensive as the performance and inputs of set 601, which is available to all users of the system 102.

Although one instance of the set 601 is shown, multiple instances of the set 601 may be performed in parallel to improve the speed at which the target sets are updated.

In an example embodiment, the operations in FIG. 6 are continuously repeated regardless of the type of inputted data and amount of inputted data. It is recognized that existing social data algorithms are configured for processing large amounts of inputs (e.g. “big data”) in order to generate an output, but are not suited to generate an effective output based on a small amount of inputs. Alternatively, other social data algorithms are configured for processing a small amount of inputs in order to generate an input, but may not be configured to handle or effectively process a larger amount of inputs. The proposed approach in FIG. 6 addresses such lack of inflexibility. The machine learning algorithms adapt to different types and amounts of data to effectively and continuously re-evaluate the target sets.

### Active Receiver Module

Details about the active receiver module 103 are provided below. The active receiver module 103 automatically and dynamically listens to N number of global data streams and is connected to Internet sites or private networks, or both. The active receiver module may include analytic filters to eliminate unwanted information, machine learning to detect valuable information, and recommendation engines to quickly expose important conversations and social trends. In particular, trends and patterns related to currently proposed advertising campaigns or past advertising campaigns are considered important. New meta data may also be created from the social ingested data, such as but not limited to relationships and correlations.

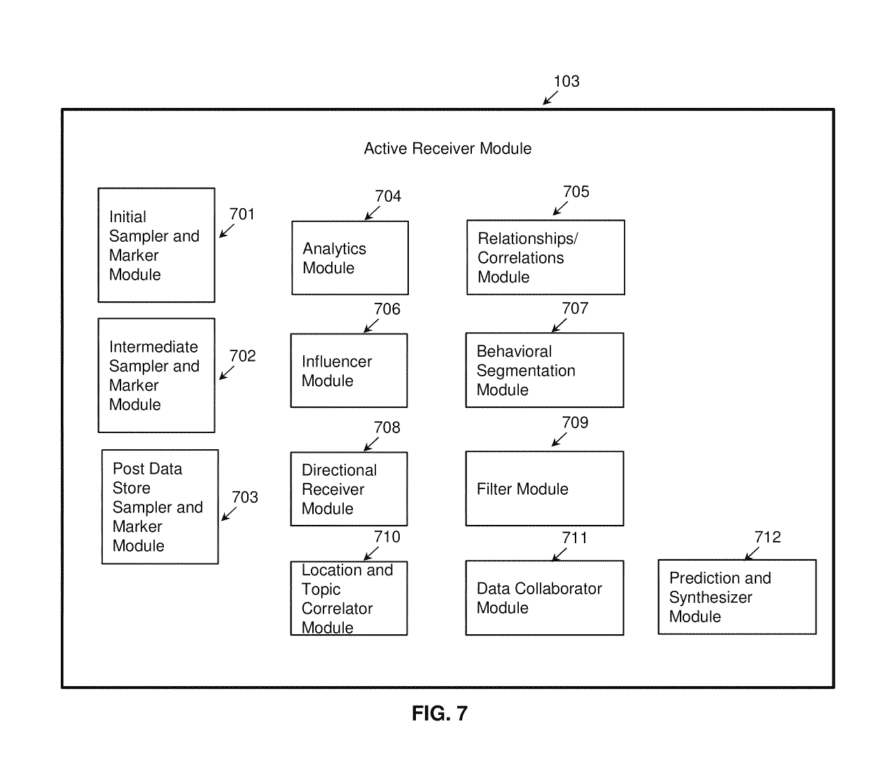

Turning to FIG. 7, example components of the active receiver module 103 are shown. The example components include an initial sampler and marker module 701, an intermediate sampler and marker module 702, a post-data-storage sampler and marker module 703, an analytics module 704, a relationships/correlations module 705, an influencer module 706, a behavioral segmentation module 707, a directional receiver module 708, a filter module 709, a location and topic correlator module 710, a data collaborator module 711 and a prediction and synthesizer module 712. It will be appreciated that the modules within the active receiver 103 may exchange data with each other.

In an example embodiment, module 701 provides real time analytics, module 702 provides near real time analytics, and module 703 provides batched analytics. This is referred to as, for example, social streaming analytics.

To facilitate real-time and efficient analysis of the obtained social data, different levels of speed and granularity are used to process the obtained social data. The module 701 is used first to initially sample and mark the obtained social data at a faster speed and lower sampling rate. This allows the active receiver module 103 to provide some results in real-time. The module 702 is used to sample and mark the obtained data at a slower speed and at a higher sampling rate relative to module 701. This allows the active receiver module 103 to provide more detailed results derived from module 702, although with some delay compared to the results derived from module 701. The module 703 samples all the social data stored by the active receiver module at a relatively slower speed compared to module 702, and with a much higher sampling rate compared to module 702. This allows the active receiver module 103 to provide even more detailed results which are derived from module 703, compared to the results derived from module 702. It can thus be appreciated, that the different levels of analysis can occur in parallel with each other and can provide initial results very quickly, provide intermediate results with some delay, and provide post-data-storage results with further delay.

The sampler and marker modules 701, 702, 703 also identify and extract other data associated with the social data including, for example: the time or date, or both, that the social data was published or posted; hashtags; a tracking pixel; a web bug, also called a web beacon, tracking bug, tag, or page tag; a cookie; a digital signature; a keyword; user and/or company identity associated with the social data; an IP address associated with the social data; geographical data associated with the social data (e.g. geo tags); entry paths of users to the social data; certificates; users (e.g. followers) reading or following the author of the social data; users that have already consumed the social data; etc. This information is used to identify relationships.

The analytics module 704 can use a variety of approaches to analyze the social data and the associated other data. The analysis is performed to determine relationships, correlations, affinities, and inverse relationships. Non-limiting examples of algorithms that can be used include artificial neural networks, nearest neighbor, Bayesian statistics, decision trees, regression analysis, fuzzy logic, K-means algorithm, clustering, fuzzy clustering, the Monte Carlo method, learning automata, temporal difference learning, apriori algorithms, the ANOVA method, Bayesian networks, and hidden Markov models. More generally, currently known and future known analytical methods can be used to identify relationships, correlations, affinities, and inverse relationships amongst the social data. The analytics module 704, for example, obtains the data from the modules 701, 702, and/or 703.

It will be appreciated that inverse relationships between two concepts, for example, is such that a liking or affinity to first concept is related to a dislike or repelling to a second concept.

The relationships/correlations module 705 uses the results from the analytics module to generate terms and values that characterize a relationship between at least two concepts. The concepts may include any combination of keywords, time, location, people, video data, audio data, graphics, etc.

The relationships module 705 can also identify keyword bursts. The popularity of a keyword, or multiple keywords, is plotted as a function of time. The analytics module identifies and marks interesting temporal regions as bursts in the keyword popularity curve. The analytics module identifies one or more correlated keywords associated with the keyword of interest (e.g. the keyword having a popularity burst). The correlated keyword is closely related to the keyword of interest at the same temporal region as the burst. Such a process is described in detail in U.S. patent application Ser. No. 12/501,324, filed on Jul. 10, 2009 and titled “Method and System for Information Discovery and Text Analysis”, the entire contents of which are incorporated herein by reference.

In an example embodiment, searching for and analysing data, such as one or more text sources and temporally-ordered data objects, includes: providing access to one or more text sources, each text source including one or more temporally-ordered data objects; obtaining or generating a search query based on one or more terms and one or more time intervals; obtaining or generating time data associated with the data objects; identifying one or more data objects based on the search query; and generating one or more popularity curves based on the frequency of data objects corresponding to one or more of the search terms in the one or more time intervals.

In another example aspect, the method further includes: analysing data objects within the one or more popularity curves; and defining one or more data objects as data objects of interest based on fluctuations in the popularity curve indicating a high frequency of data objects corresponding to one or more search terms. In another example aspect, the method further includes generating one or more additional terms associated with the data objects of interest. In another example aspect, the method further includes generating and submitting a search query automatically based upon one or more specific data objects, or one or more obtained terms, and one or more terms generated by a prior search query. In another example aspect, the generating of the search query based upon one or more specific data objects further includes extracting query terms from the one or more specified data objects by way of an algorithmic methodology. In another example aspect, the method includes ranking the data objects and additional terms associated with data objects of interest, characterized in that the ranking orders the data objects and additional terms associated with the data objects of interest in accordance with the authoritative nature of the data object as indicated by the data associated with the data object establishing that a data object is frequently referenced by users. In another example aspect, the method further includes including in the search query one or more of: one or more geographical search terms, or one or more demographic search terms. In another example aspect, the one or more popularity curves are based upon sentiment analysis derived through assigning user sentiment data to each data object, either positive or negative, by defining or obtaining positive or negative terms relating to the data objects, inferring the sentiment data from the presence or absence of such positive or negative terms, and based on such sentiment data defining additional information for a search query. In another example aspect, the popularity curve fluctuations are drill down and roll-up capable.

In another example aspect, the relationships module 705 can also identify relationships between topics (e.g. keywords) and users that are interested in the keyword. The relationships module, for example, can identify a user who is considered an expert in a topic. If a given user regularly comments on a topic, and there many other users who “follow” the given user, then the given user is considered an expert. The relationships module can also identify in which other topics that an expert user has an interest, although the expert user may not be considered an expert of those other topics. The relationships module can obtain a number of ancillary users that a given user follows; obtain the topics in which the ancillary users are considered experts; and associate those topics with the given user. It can be appreciated that there are various ways to correlate topics and users together.

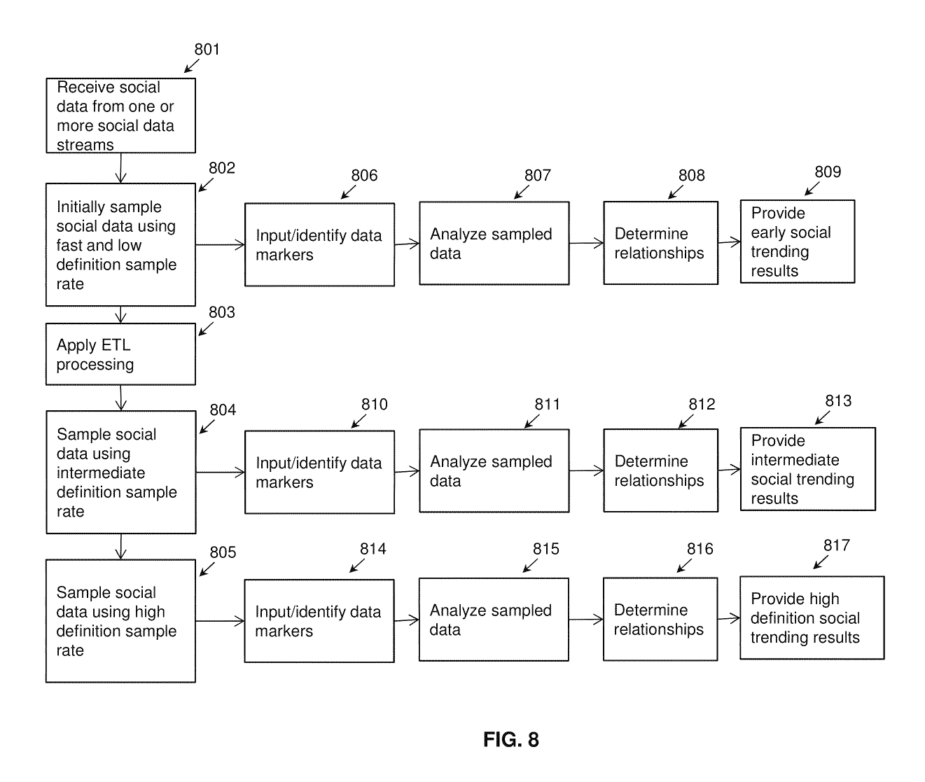

Turning to FIG. 8, example computer or processor implemented instructions are provided for receiving and analysing data according to the active receiver module 103. At block 801, the active receiver module receives social data from one or more social data streams. At block 802, the active receiver module initially samples the social data using a fast and low definition sample rate (e.g. using module 701). At block 803, the active receiver module applies ETL (Extract, Transform, Load) processing. The first part of an ETL process involves extracting the data from the source systems. The transform stage applies a series of rules or functions to the extracted data from the source to derive the data for loading into the end target. The load phase loads the data into the end target, such as the memory.

At block 804, the active receiver module samples the social data using an intermediate definition sample rate (e.g. using 601). At block 805, the active receiver module samples the social data using a high definition sample rate (e.g. using module 703). In an example embodiment, the initial sampling, the intermediate sampling and the high definition sampling are performed in parallel. In another example embodiment, the samplings occur in series.

Continuing with FIG. 8, after initially sampling the social data (block 802), the active receiver module inputs or identifies data markers (block 806). It proceeds to analyze the sampled data (block 807), determine relationships from the sampled data (block 808), and use the relationships to determine early or initial social trending results (block 809).

Similarly, after block 804, the active receiver module inputs or identifies data markers in the sampled social data (block 810). It proceeds to analyze the sampled data (block 811), determine relationships from the sampled data (block 812), and use the relationships to determine intermediate social trending results (block 813).

The active receiver module also inputs or identifies data markers in the sampled social data (block 814) obtained from block 805. It proceeds to analyze the sampled data (block 715), determine relationships from the sampled data (block 816), and use the relationships to determine high definition social trending results (block 817).

In an example embodiment, the operations at block 806 to 809, the operations at block 810 to 813, and the operations at block 814 to 817 occur in parallel. The relationships and results from blocks 808 and 809, however, would be determined before the relationships and results from blocks 812, 813, 816 and 817.

It will be appreciated that the data markers described in blocks 806, 810 and 814 assist with the preliminary analysis and the sampled data and also help to determine relationships. Example embodiments of data markers include keywords, certain images, and certain sources of the data (e.g. author, organization, location, network source, etc.). The data markers may also be tags extracted from the sampled data. In an example embodiment, the data markers were implanted in advertisements by module 508.

In an example embodiment, the data markers are identified by conducting a preliminary analysis of the sampled data, which is different from the more detailed analysis in blocks 807, 811 and 815. The data markers can be used to identify trends and sentiment.

In another example embodiment, data markers are inputted into the sampled data based on the detection of certain keywords, certain images, and certain sources of data. A certain organization can use this operation to input a data marker into certain sampled data. For example, a car branding organization inputs the data marker “SUV” when an image of an SUV is obtained from the sampling process, or when a text message has at least one of the words “SUV”, “Jeep”, “4×4”, “CR-V”, “Rav4”, and “RDX”. It can be appreciated that other rules for inputting data markers can be used. The inputted data markers can also be used during the analysis operations and the relationship determining operations to detect trends and sentiment.

With respect to the influencer module 706, relationships related to influence are obtained. As used herein, the term “influencer” refers to a user account that primarily produces and shares content related to a topic and is considered to be influential to other users in the social data network.

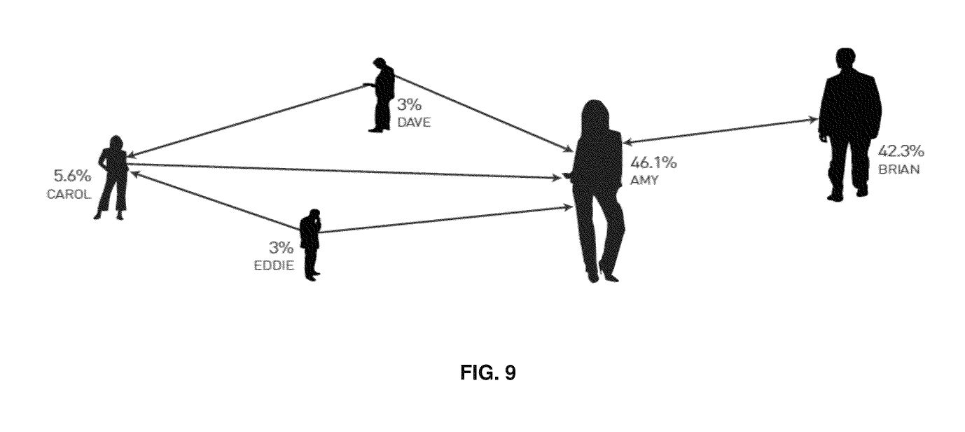

As an example, consider the simplified follower network for a particular topic in FIG. 9. Each user, actually a user account or a user name associated with a user account or user data address, is shown in relationship to the other users. The lines between the users, also called edges, represent relationships between the users. For example, an arrow pointing from the user account “Dave” to the user account “Carol” means Dave reads messages published by Carol. In other words, Dave follows Carol. A bi-directional arrow between Amy and Brian means, for example, Amy follows Dave and Dave follows Amy. Beside each user account in FIG. 9, a PageRank score is provided. The PageRank algorithm is a known algorithm used by Google to measure the importance of website pages in a network and can be also applied to measuring the importance of users in a social data network.

Continuing with FIG. 9, Amy has the greatest number of followers (i.e. Dave, Carol, and Eddie) and is the most influential user in this network (i.e. PageRank score of 46.1%). However, Brian, with only one follower (i.e. Amy), is more influential than Carol with two followers (i.e. Eddie and Dave), primarily because Brian has a significant portion of Amy's mindshare. In other words, using the proposed systems and methods herein, although Carol has more followers than Brian, she does not necessarily have a greater influence than Brian. Hence, using the proposed systems and methods described herein, the number of followers of a user is not the sole determination for influence. In an example embodiment, identifying who are the followers of a user may also be factored into the computation of influence.

The example network in FIG. 9 is represented in Table 1, and it illustrates how PageRank can significantly differ from the number of followers.

TABLE 1
Twitter follower counts and PageRank scores
for sample network represented in Figure 9.

| User Handle | Follower Count | PageRank |
|---|---|---|
| Amy | 4 | 46.1% |
| Brian | 1 | 42.3% |
| Carol | 2 | 5.6% |
| Dave | 0 | 3.0% |
| Eddie | 0 | 3.0% |

Amy is clearly the top influencer with the greatest number of followers and highest PageRank score. Although Carol has two followers, she has a lower PageRank metric than Brian who has one follower. However, Brian's one follower is the most-influential Amy (with four followers), while Carol's two followers are low influencers with (0 followers each). The intuition is that, if a few experts consider someone an expert, then s/he is also an expert. However, the PageRank algorithm gives a better measure of influence than only counting the number of followers. As will be described below, the PageRank algorithm and other similar ranking algorithms can be used with the proposed systems and methods described herein.

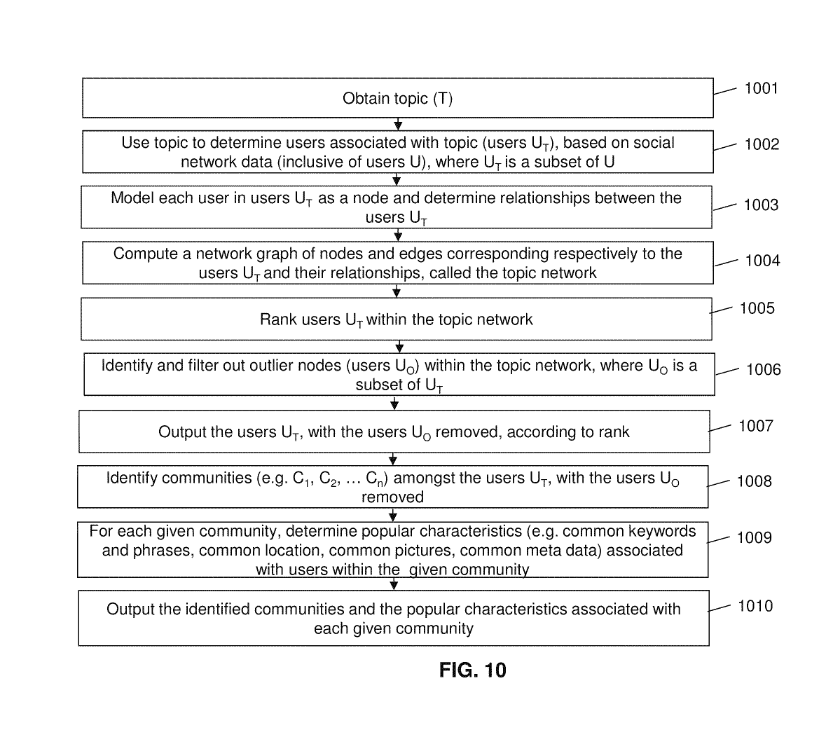

Turning to FIG. 10, an example embodiment of computer executable instructions are shown for determining one or more influencers of a given topic. The social network data, or social data, includes multiple users that are represented as a set U. At block 1001, the active receiver 103 obtains a topic represented as T. At block 1002, the active receiver uses the topic to determine users from the social network data which are associated with the topic. This determination can be implemented in various ways and will be discussed in further detail below. The set of users associated with the topic is represented as U_{T}, where U_{T} is a subset of U.

Continuing with FIG. 10, the active receiver module models each user in the set of users U_{T} as a node and determines the relationships between the users U_{T} (block 1003). The active receiver computes a network of nodes and edges corresponding respectively to the users U_{T} and the relationships between the users U_{T} (block 1004). In other words, the active receiver creates a network graph of nodes and edges corresponding respectively to the users U_{T} and their relationships. The network graph is called the “topic network”. It can be appreciated that the principles of graph theory are applied here. The relationships that define the edges or connectedness between two entities or users U_{T} can include for example: friend connection and/or follower-followee connection between the two entities within a particular social networking platform. In an additional aspect, the relationships could include other types of relationships defining social media connectedness between two entities such as: friend of a friend connection. In yet another aspect, the relationship could include connectedness of a friend or follower connection across different social network platforms (e.g. Instagram and Facebook). In yet a further aspect, the relationship between the users U_{T} as defined by the edges can include for example: users connected via re-posts of messages by one user as originally posted by another user (e.g. re-tweets on Twitter), and/or users connected through replies to messages posted by one user and commented by another user via the social networking platform. Referring again to FIG. 10, the presence of an edge between two entities indicates the presence of at least one type of relationship or connectedness (e.g. friend or follower connectivity between two users) in one or more social networking platforms.

The active receiver then ranks users within the topic network (block 1005). For example, the server uses PageRank to measure importance of a user within the topic network and to rank the user based on the measure. Other non-limiting examples of ranking algorithms that can be used include: Eigenvector Centrality, Weighted Degree, Betweenness, Hub and Authority metrics.

The active receiver identifies and filters out outlier nodes within the topic network (block 1006). The outlier nodes are outlier users that are considered to be separate from a larger population or clusters of users in the topic network. The set of outlier users or nodes within the topic network is represented by U_{O}, where U_{O} is a subset of U_{T}. Further details about identifying and filtering the outlier nodes are described below.

At block 1007, the active receiver outputs the users U_{T}, with the users U_{O} removed, according to rank.

In an alternate example embodiment, block 1006 is performed before block 1005.

At block 1008, the active receiver identifies communities (e.g. C₁, C₂, . . . , Cₙ) amongst the users U_{T} with the users U₀ removed. The identification of the communities can depend on the degree of connectedness between nodes within one community as compared to nodes within another community. That is, a community is defined by entities or nodes having a higher degree of connectedness internally (e.g. with respect to other nodes in the same community) than with respect to entities external to the defined community. In an example embodiment, the value or threshold for the degree of connectedness used to separate one community from another can be pre-defined. The resolution thus defines the density of the interconnectedness of the nodes within a community. Each identified community graph is thus a subset of the network graph of nodes and edges (the topic network) defined in block 1004 for each community. In one aspect, the community graph further provides both a visual representation of the users in the community (e.g. as nodes) with the community graph and a textual listing of the users in the community. In yet a further aspect, the listing of users in the community is ranked according to degree of influence within the community and/or within all communities for topic T In accordance with block 1008, users U_{T} are then split up into their community graph classifications such as U_{C1}, U_{C2}, . . . U_{Cn}.

At block 1009, for each given community (e.g. C₁), the active receiver determines popular characteristic values for pre-defined characteristics (e.g. one or more of: common words and phrases, topics of conversations, common locations, common pictures, common meta data) associated with users (e.g. U_{C1}) within the given community based on their social network data. The selected characteristic (e.g. topic or location) can be user-defined and/or automatically generated (e.g. based on characteristics for other communities within the same topic network, or based on previously used characteristics for the same topic T). At block 1010, the active receiver outputs the identified communities (e.g. C₁, C₂, . . . , Cₙ) and the popular characteristics associated with each given community.

It is appreciated that blocks 1008, 1009 and 1010 are optional and are related to further identifying communities and characteristics associated with the influencers outputted at block 1007.

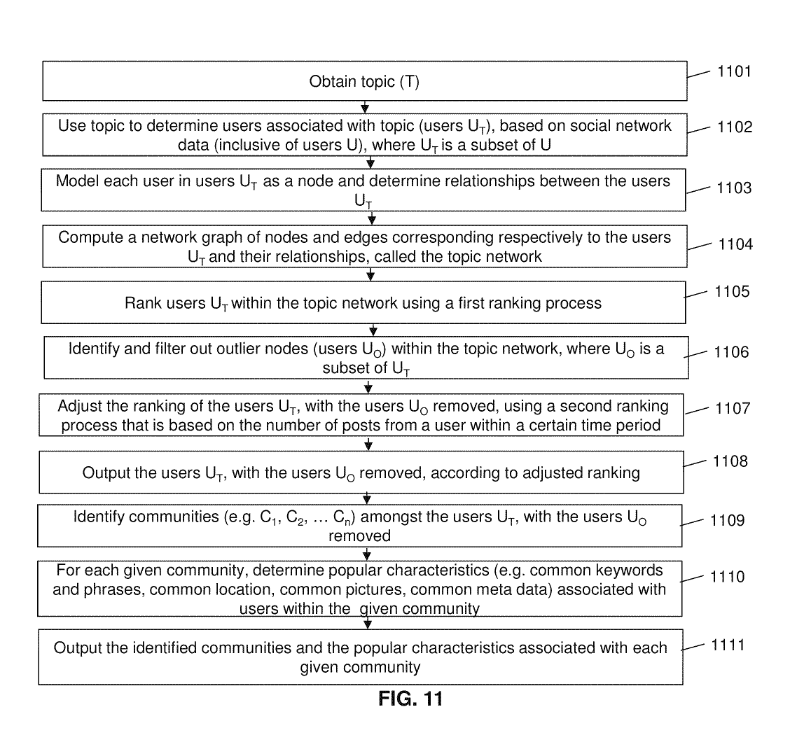

Turning to FIG. 11, another example embodiment of computer executable instructions are shown for determining one or more influencers of a given topic. Blocks 1101 to 1104 correspond to blocks 1001 to 1004. Following block 1104, the active receiver ranks users within the topic network using a first ranking process (block 1105). The first ranking process may or may not be the same ranking process used in block 1105. The ranking is done to identify which users are the most influential in the given topic network for the given topic.

At block 1106, the active receiver identifies and filters out outlier nodes (users U_{O}) within the topic network, where U_{O} is a subset of U_{T}. At block 1107, the active receiver adjusts the ranking of the users U_{T}, with the users U_{O} removed, using a second ranking process that is based on the number of posts from a user within a certain time period. For example, the active receiver determines that if a first user has a higher number of posts within the last two months compared to the number of posts of a second user within the same time period, then the first user's original ranking (from block 1105) may be increased, while the second user's ranking remains the same or is decreased. At block 1108, the active receiver outputs the users U_{T}, with the users U_{O} removed, according to rank.

It is recognized that a network graph based on all the users U may be very large. For example, there may be hundreds of millions of users in the set U. Analysing the entire data set related to U may be computationally expensive and time consuming. Therefore, using the above process to find a smaller set of users U_{T} that relate to the topic T reduces the amount of data to be analysed. This decreases the processing time as well. In an example embodiment, near real time results of influencers have been produced when analysing the entire social network platform of Twitter. Using the smaller set of users U_{T} and the data associated with the user U_{T}, a new topic network is computed. The topic network is smaller (i.e. less nodes and less edges) than the social network graph that is inclusive of all users U. Ranking users based on the topic network is much faster than ranking users based on the social network graph inclusive of all users U.

Furthermore, identifying and filtering outlier nodes in the topic network helps to further improve the quality of the results.

At block 1109, the active receiver is configured to identify communities (e.g. C₁, C₂, . . . , Cₙ) amongst the users U_{T} with the users U₀ removed in a similar manner as previously described in relation to block 1008. At block 1110, the active receiver is configured to determine, for each given community (e.g. C₁), popular characteristic values for pre-defined characteristics (e.g. common keywords and phrases, topics of conversations, common locations, common pictures, common meta data) associated with users (e.g. U_{C1}) within the given community (e.g. C₁), based on their social network data in a similar manner as previously described in relation to block 1609. At block 1111, the server is configured to output the identified communities and the characteristic values for the popular characteristics associated with each given community (e.g. C₁-Cₙ) in a similar manner as block 1010.

It is recognized that the data from the topic network can be improved by removing problematic outliers. For instance, a query using the topic “McCafe” referring to the McDonalds coffee brand also happened to bring back some users from the Philippines who are fans of a karaoke bar/cafe of the same name. Because they happen to be a tight-knit community, their influencer score is often high enough to rank in the critical top-ten list.

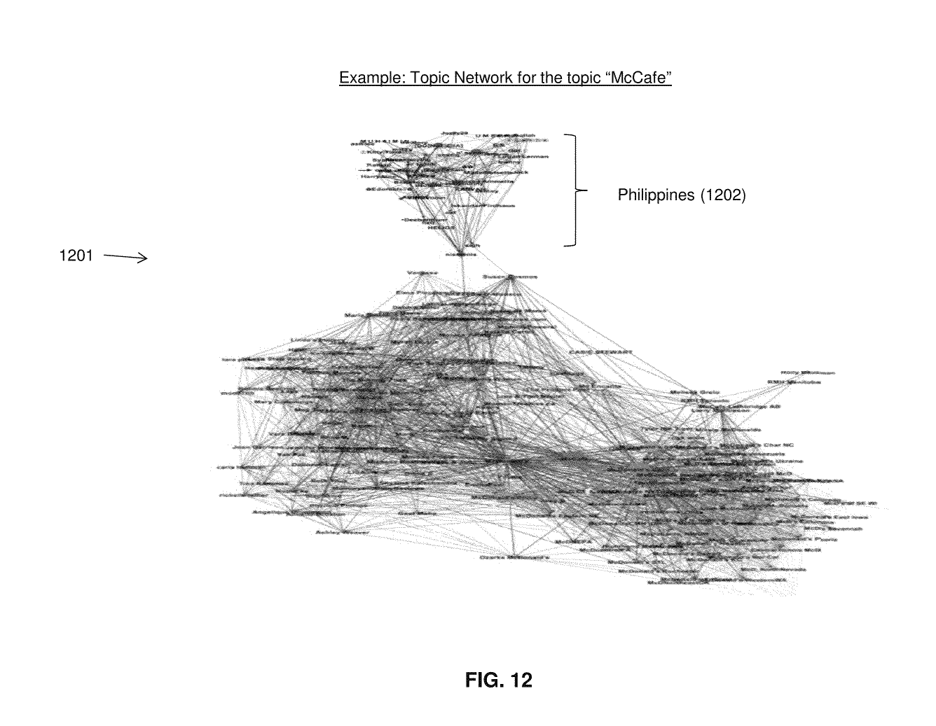

Turning to FIG. 12, an illustration of an example embodiment of a topic network 1201 showing unfiltered results is shown. The nodes represent the set of users U_{T} related to the topic McCafe. Some of the nodes 1202 or users are from the Philippines who are fans of a karaoke bar/cafe of the same name McCafe.

This phenomenon sometimes occurs in test cases, not limited to the test case of the topic McCafe. It is herein recognized that a user who looks for McCafe is not looking for both the McDonalds coffee and the Filipino karaoke bar, and thus this sub-network 1202 is considered noise.

To accomplish noise reduction, in an example embodiment, the server uses a network community detection algorithm called Modularity to identify and filter these types of outlier clusters in the topic queries. The Modularity algorithm is described in the article cited as Newman, M. E. J. (2006) “Modularity and community structure in networks,” PROCEEDINGS-NATIONAL ACADEMY OF SCIENCES USA 103 (23): 8577-8696, the entire contents of which are herein incorporated by reference.

It will be appreciated that other types of clustering and community detection algorithms can be used to determine outliers in the topic network. The filtering helps to remove results that are unintended or sought after by a user looking for influencers associated with a topic.

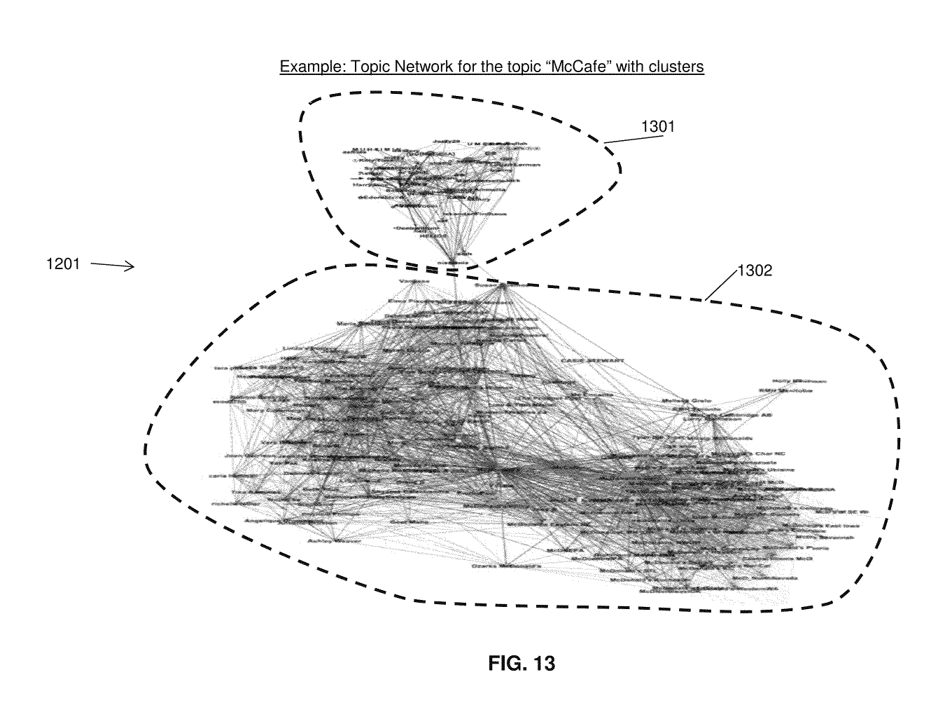

As shown in FIG. 13, an outlier cluster 1301 is identified relative to a main cluster 1302 in the topic network 1201. The outlier cluster of users U_{O} 1301 is removed from the topic network, and the remaining users in the main cluster 1302 are used to form the ranked list of outputted influencers.

In an example embodiment, the active receiver 103 computes the following instructions to filter out the outliers:

1. Execute the Modularity algorithm on the topic network.

2. The Modularity function decomposes the topic network into modular communities or sub-networks, and labels each node into one of X clusters/communities. In an example embodiment, X<N/2, as a community has more than one member, and N is the number of users in the set U_{T}.

3. Sort the communities by the number of users within a community, and accept the communities with the largest populations.

4. When the cumulative sum of the node population exceeds 80% of the total, remove the remaining smallest communities from the topic network.

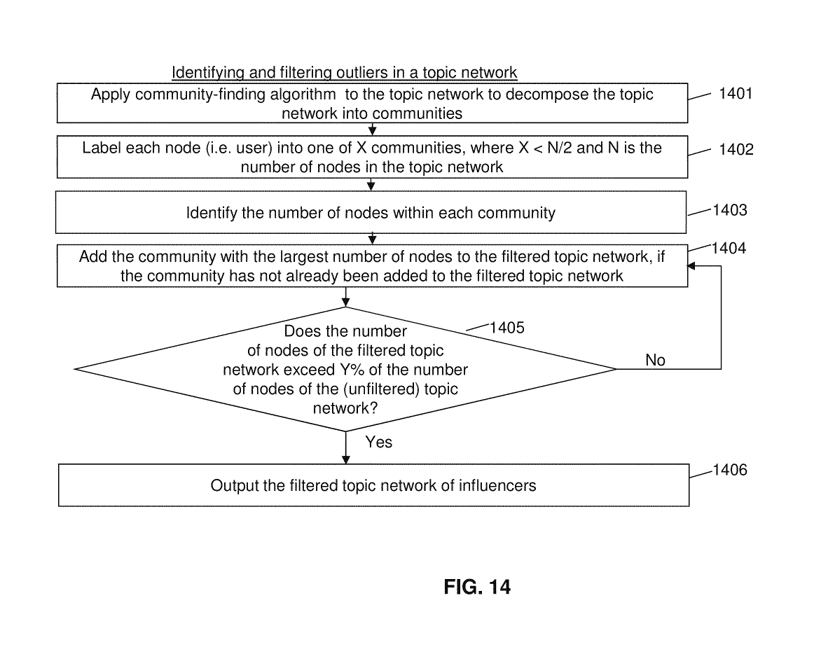

A general example embodiment of the computer executable instructions for identifying and filtering the topic network is described with respect to FIG. 14. It can be appreciated that these instructions can be used to execute blocks 1006 and 1106.

At block 1401, the active receiver applies a community-finding algorithm to the topic network to decompose the network into communities. Non-limiting examples of algorithms for finding communities include the Minimum-cut method, Hierarchical clustering, the Girvan-Newman algorithm, the Modularity algorithm referenced above, and Clique-based methods.

At block 1402, the active receiver labels each node (i.e. user) into one of X communities, where X<N/2 and N is the number of nodes in the topic network.

At block 1403, the active receiver identifies the number of nodes within each community.

The active receiver then adds the community with the largest number of nodes to the filtered topic network, if that community has not already been added to the filtered topic network (block 1404). It can be appreciated that initially, the filtered topic network includes zero communities, and the first community added to the filtered topic network is the largest community. The same community from the unfiltered topic network cannot be added more than once to filtered topic network.

At block 1405, the active receiver determines if the number of nodes of the filtered topic network exceeds, or is greater than, Y % of the number of nodes of the original or unfiltered topic network. In an example embodiment, Y % is 80%. Other percentage values for Y are also applicable. If not, then the process loops back to block 1404. When the condition of block 1405 is true, the process proceeds to block 1406.

Generally, when the number of nodes in the filtered topic network reaches or exceeds a majority percentage of the total number of nodes in the unfiltered topic network, then the main cluster has been identified and the remaining nodes, which are the outlier nodes (e.g. U_{O}), are also identified.

At block 1406, the filtered topic network is outputted, which does not include the outlier user U_{O}.

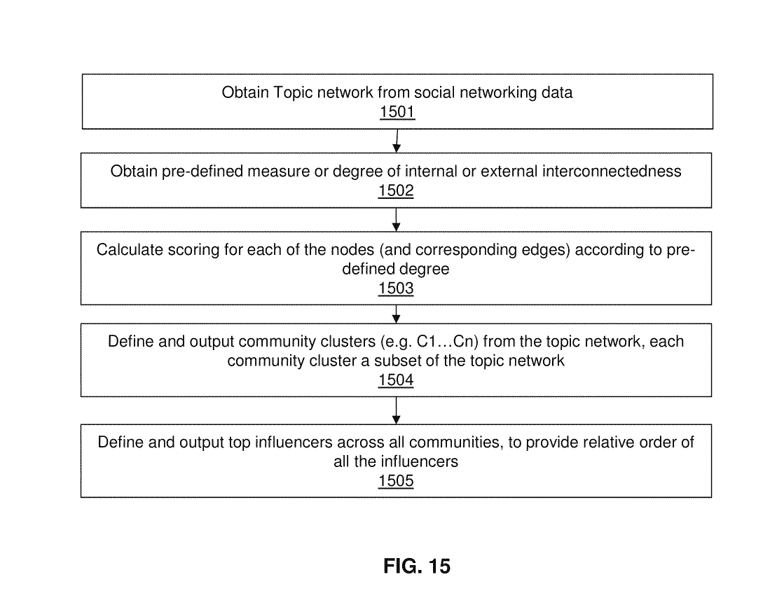

Turning to FIG. 15, an example embodiment of computer executable instructions are shown for identifying and outputting communities from social network data, which can be performed by the influencer module 706, or more generally the active receiver 103.

A feature of social network platforms is that users are following (or defining as a friend) another user. As described earlier, other types of relationships or interconnectedness can exist between users as illustrated by a plurality of nodes and edges within a topic network. Within the topic network, influencers can affect different clusters of users to varying degrees. That is, based on the process for identifying communities as described in relation to FIG. 15, the active receiver is configured to identify a plurality of clusters within a single topic network, referred to as communities. Since influence is not uniform across a social network platform, the community identification process defined in relation to FIG. 15 is advantageous as it identifies the degree or depth of influence of each influencer (e.g. by associating with one community over another) across the topic network.

As will be defined in FIG. 15, the active receiver is configured to provide a set of distinct communities (e.g. C1, . . . , Cn), and the top influencer(s) in each of the communities. In yet a preferred aspect, the active receiver is configured to provide an aggregated list of the top influencers across all communities to provide the relative order of all the influencers.

At block 1501, the active receiver is configured to obtain topic network graph information from social networking data as described earlier. The topic network visually illustrates relationships among the nodes a set of users (U_{T}) each represented as a node in the topic network graph and connected by edges to indicate a relationship (e.g. friend or follower-followee, or other social media interconnectivity) between two users within the topic network graph. At block 1502, the active receiver obtains a pre-defined degree or measure of internal and/or external interconnectedness (e.g. resolution) for use in defining the boundary between communities.

At block 1503, the active receiver is configured to calculate scoring for each of the nodes (e.g. influencers) and edges according to the pre-defined degree of interconnectedness (e.g. resolution). That is, in one example, each user handle is assigned a Modularity class identifier (Mod ID) and a PageRank score (defining a degree of influence). In one aspect, the resolution parameter is configured to control the density and the number of communities identified. In a preferred aspect, a default resolution value of 2 which provides 2 to 10 communities is utilized by the active receiver. In yet another aspect, the resolution value is user defined to generate higher or lower granularity of communities as desired for visualization of the community information.

At block 1504, the active receiver is configured to define and output distinct community clusters (e.g. C₁, C₂, . . . , Cₙ) thereby partitioning the users U_{T} into U_{C1} . . . U_{Cn} such that each user defined by a node in the network is mapped to a respective community. In one aspect, modularity analysis is used to define the communities such that each community has dense connections (high connectivity) between the cluster of nodes within the community but sparse connections with nodes in different communities (low connectivity). In one aspect, the community detection process steps 1503-1506 can be implemented utilizing a modularity algorithm and/or a density algorithm (which measures internal connectivity).

At block 1505, the active receiver is configured to define and output top influencer across all communities and/or top influencers within each community and provide relative ordering of all influencers. In yet a further aspect, at block 1505, the active receiver is configured to output an aggregated list of all the top influencers across all communities to provide the relative order of all the influencers.

In another aspect of the influencer module 706, an influencer and the influencer's community are determined using weighted edges or connections between users or followers in the social network. In context of a topic, an influencer is an individual or entity represented in the social data network that: is considered to be interested in the topic or generate content about the topic; has a large number of followers (e.g. or readers, friends or subscribers), a significant percent of which are interested in the topic; and has a significant percentage of the topic-interested followers that value the influencer's opinion about the topic. Non-limiting examples of a topic include a brand, a company, a product, a service, a sale, a promotion, an event, a location, and a person.

Continuing with the example of using weighted edges or connections, several types of edges or connections are considered between different user nodes (e.g. user accounts) in a social data network. These types of edges or connections include: (a) a follower relationship in which a user follows another user; (b) a re-post relationship in which a user re-sends or re-posts the same content from another user; (c) a reply relationship in which a user replies to content posted or sent by another user; and (d) a mention relationship in which a user mentions another user in a posting.

In the example of using weighted edges to identify top influencers and their communities, the network links are weighted to create a notion of link importance and further, external sources are identified and incorporated into the social data network. Examples of external sources include users and their activities of re-posting an old message or content posting, or users and their activities of referencing or mention an old message or content posting. Another example of an external source is a user and their activity of mentioning a topic in a social data network, but the topic originates from another or ancillary social data network.

Below are example computer executable or processor implemented instructions for generating a weighted influencer graph, which may be used in combination with the other operations of the influencer module 706.

1. Obtain a topic represented as T. For example, the topic is obtained from one of the other modules or from a process performed by the active receiver module.

2. The active receiver module uses the topic to identify all posts related to the topic. These set of posts are collectively denoted as P_{T}. In an example embodiment, one or more additional search criteria are used, such as a specified time period. In other words, the server may only be examining posts related to the topic within a given period of time.

3. The active receiver module obtains authors of the posts P_{T} and identifies the top N authors based on rank. The set of top ranked authors is represented by A_{T}. In an example embodiment, the top N authors are identified using the Authority Score. Other methods and processes may be used to rank the authors. For example, the server uses PageRank to measure importance of a user within the topic network and to rank the user based on the measure. Other non-limiting examples of ranking algorithms that can be used include: Eigenvector Centrality, Weighted Degree, Betweenness, Hub and Authority metrics. It is appreciated that the authors are uses in the social network that authored the posts. It is also appreciated that N is a counting number. Non-limiting example values of N include those values in the range of 3,000 to 5,000. Other values of N can be used.

4. The active receiver module characterizes each of the posts P_{T} as a ‘Reply’, a ‘Mention’, or a ‘Re-Post’, and respectively identifies the user being replied to, the user being mentioned, and the user who originated the content that was re-posted (e.g. grouped as replied to users U_{R}, mentioned users U_{M}, and re-posted content from users U_{RP}). The time stamp of each reply, mention, re-post, etc. may also be recorded in order to determine whether an interaction between users is recent, or to determine a ‘recent’ grading.

5. The active receiver module generates a list called ‘users of interest’ that combines the top N authors A_{T} and the users U_{R}, U_{M}, and U_{RP}. Non-limiting examples of the numbers of users in the ‘users of interest’ list or group include those numbers in range of 3,000 to 10,000. It will be appreciated that the number of users in the ‘users of interest’ group or list may be other values.

6. For each user in the ‘users of interest’ list, the active receiver module identifies or obtains the followers of each user.

7. The active receiver module removes the followers that are not listed in the ‘users of interest’ list, while still having identified the follower relationships between those users that are part of the ‘users of interest’. In a non-limiting example implementation of step 6, it was found that there were several million follower connections or edges when considering all the followers associated with the ‘users of interest’. Considering all of these follower edges may be computationally consuming and may not reveal influential interactions. To reduce the number of follower edges, those followers that are not part of the ‘users of interest’ are discarded as per step 7.

In an alternative embodiment of steps 6 and 7, the active receiver module identifies the follower relationships limited to only users listed in the ‘users of interest’ group.

8. The active receiver module creates a link between each user in the ‘users of interest’ list and its followers. This creates the follower-following network where all the links have the same weight (e.g., weight of 1.0).

9. Between each user pair (e.g. A, B) in the ‘users of interest’ list, the active receiver module identifies the number of instances A mentions B, the number of instances A replies to B, and the number of instances A re-posts content from B. It can be appreciated that a user pair does not have to have a follower-followee relationship. For example, a user A may not follow a user B, but a user A may mention user B, or may re-post content from user B, or may reply to a posting from user B. Thus, there may be an edge or link between a user pair (A,B), even if one is not a follower of the other.

10. Between each user pair (e.g. A, B), the active receiver module computes a weight associated with the link or edge between the pair A, B, where the weight is a function of at least the number of instances A mentions B, the number of instances A replies to B, and the number of instances A re-posts content from B. For example, the higher the number of instances, the higher the weighting.

In an example embodiment, the weighting of an edge is initialized at a first value (e.g. value of 1.0) when there is a follower-followee link and otherwise the edge is initialized at a second value (e.g. value of 0) where there is no follower-followee link, where the second value is less than the first value. Each additional activity (e.g. reply, repost, mention) between two users will increase the edge weight to a maximum weighting value of 4.0. Other numbers or ranges can be used to represent the weighting.

In an example embodiment, the relationship between the increasing number of activity or instances and the increasing weighting is characterized by an exponentially declining scale. For example, consider a user pair A,B, where A follows B. If there are 2 re-posts, the weighting is 2.0. If there are 20 re-posts, the weighting is 3.9. If there are 400 re-posts, the weighting is 4.0. It is appreciated that these numbers are just for example and that different numbers and ranges can be used.

In an example embodiment, the weighting is also based on how recent did the interaction (e.g. the re-post, the mention, the reply, etc.) take place. The ‘recent’ grading may be computed by determining the difference in time between the date the query is run and the date that an interaction occurred. If the interactions took place more recently, the weighting is higher, for example.

11. The active receiver module computes a network graph of nodes and edges corresponding respectively to the users of the ‘users of interest’ list and their relationships, where the relationships or edges are weighted (e.g. also called the topic network). It can be appreciated that the principles of graph theory are applied here. The relationships defined at step 11 may be outputted by the active receiver module, or further processing is performed to identify communities (e.g. steps 12-14), or both.

12. The active receiver module identifies communities (e.g. C₁, C₂, . . . , Cₙ) amongst the users in the topic network. The identification of the communities can depend on the degree of connectedness between nodes within one community as compared to nodes within another community. That is, a community is defined by entities or nodes having a higher degree of connectedness internally (e.g. with respect to other nodes in the same community) than with respect to entities external to the defined community. As will be defined, the value or threshold for the degree of connectedness used to separate one community from another can be pre-defined. The resolution thus defines the density of the interconnectedness of the nodes within a community. Each identified community graph is thus a subset of the network graph of nodes and edges (the topic network) for each community. In one aspect, the community graph further displays both a visual representation of the users in the community (e.g. as nodes) with the community graph and a textual listing of the users in the community. In yet a further aspect, the display of the listing of users in the community is ranked according to degree of influence within the community and/or within all communities for topic T. In accordance with step 12, users U_{T} are then split up into their community graph classifications such as U_{C1}, U_{C2}, . . . U_{Cn}.

13. For each given community (e.g. C₁), the active receiver module determines popular characteristic values for pre-defined characteristics (e.g. one or more of: common words and phrases, topics of conversations, common locations, common pictures, common meta data) associated with users (e.g. U_{C1}) within the given community based on their social network data. The selected characteristic (e.g. topic or location) can be user-defined and/or automatically generated (e.g. based on characteristics for other communities within the same topic network, or based on previously used characteristics for the same topic T).

14. The active receiver module server outputs the identified communities (e.g. C₁, C₂, . . . , Cₙ) and the popular characteristics associated with each given community. The identified communities may be output as a community graph in association with the characteristic values for a pre-defined characteristic for each community.

Using the weighted edges or connections, influencers may be more accurately identified as well as each influencer's score (e.g. weighted PageRank score). Accordingly, a relationship between an influencer and other users in their community, a relationship between an influencer and a topic, or a relationship between users in an influencer's community and a topic, may be identified and more accurately characterized by the active receiver module.

With respect to the behavioral segmentation module 707, the active receiver 103 is configured to track user segmentation and behaviours. As used herein, the term “user segmentation” can refer to for example dividing a target market data into subsets of consumers, called segments that have common attributes or needs. In general, behavioural segmentation as used herein refers to a computer-implemented method and system for dynamically tracking and grouping consumers and/or users based on specific behavioural patterns and activities they display when interacting with social networking platforms (e.g. via content of social media conversations, “tweets” and/or posts and/or comments and/or chat sessions) such as social networking websites.

The proposed systems and methods, as described herein, dynamically determine and calculate user behaviour segmentation patterns associated with user activity in relation to social networking platforms. This information can subsequently be useful for designing and implementing strategies to target specific needs of individual “segments”.

More generally, the proposed systems and methods provide a computer-implemented method and system to determine and analyze user behaviours (e.g. in relation to particular common topic of conversation or “tweet” associated with a social networking platform) for a number of users for the social networking platform. The system and method further includes determining other overlapping or commonality in the behaviour patterns of the users (e.g. for those users that shared a common topic or conversation). The result providing an analysis of user segmentation patterns relating to social networking activity (e.g. posts).

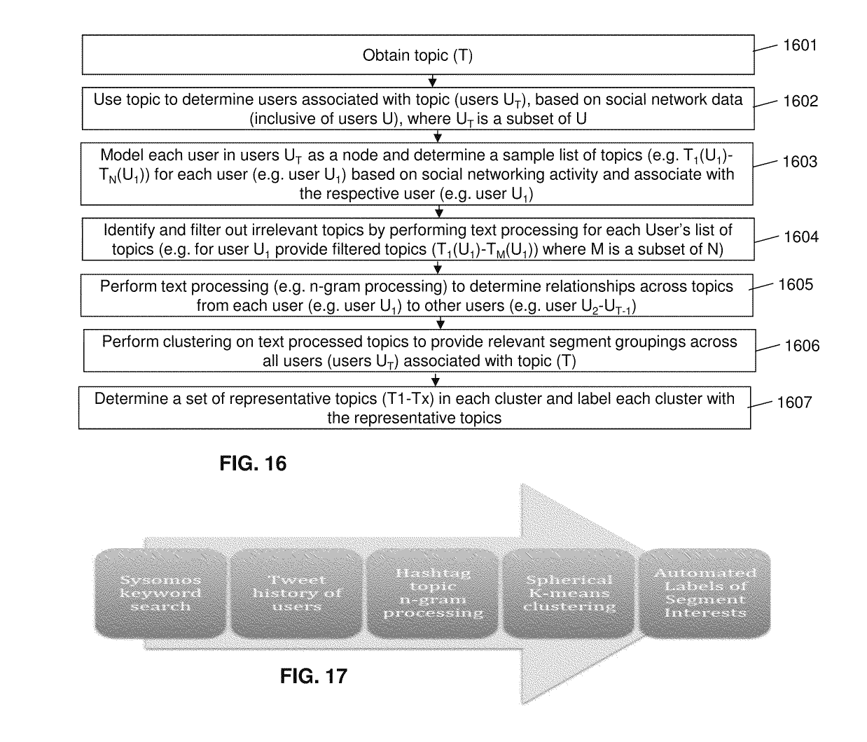

Turning to FIG. 16, an example embodiment of computer executable instructions are provided for determining one or more dynamical behavioural segments for a plurality of social networking users based on a particular topic of interest, topic T. The process shown in FIG. 16 may be implemented by the behavioral segmentation module 707, or more generally the active receiver 103. It will be understood that the social network data includes multiple users that are represented as a set U. At block 1601, the active receiver obtains a topic represented as T. At block 1602, the active receiver uses the topic to determine users from the social network data which are associated with the topic. This determination can be implemented in various ways and will be discussed in further detail below. The set of users associated with the topic is represented as U_{T}, where U_{T} is a subset of U.

Continuing with FIG. 16, at block 1603, the active receiver models each user in the set of users U_{T} as a node and determines a sample list of topics (e.g. T₁(U₁)-T_{N}(U₁)))) for each user (e.g. user U₁) based on social networking activity and associate with the respective user (e.g. user U₁). As will be described in relation to FIG. 17, in one example this involves collecting a sample of social networking posts (e.g. Tweets for Twitter users) having a pre-defined sample size (e.g. a pre-defined number of recent or randomly selected posts and/or posts during a specific time duration). At block 1604, the active receiver identifies and filters out irrelevant topics by performing text processing for each User's list of topics (e.g. for user U₁ provide filtered topics (T₁(U₁)-T_{M}(U₁)) where M is a subset of N). As discussed in relation to FIG. 17, in one example this step includes extracting text from posts (e.g. tweets, comments, chats and other social networking posts) to determine a listing of topics for all users U_{T} and normalizing the extracted text while filtering out topics that are pre-determined to be irrelevant. This step further comprises relationship mapping between each textual topics (e.g. hashtags) and the corresponding user that posted the topic.

Referring again to FIG. 16, at block 1605, the active receiver performs text processing (e.g. n-gram processing) to determine relationships across topics from each user (e.g. user U₁) to other users (e.g. user U₂-U_{T-1}). The relationships depict the statistical overlap amongst users for each topic (or stems of the topics as provided by breaking down the topic into n-grams) as shown in the exemplary chart below.

| | Tri-gram word stems from the list of topics for all users | | | | |
|---|---|---|---|---|---|
| | U_{T}: (T₁(U₁₋U_{T-1}) − T_{N}(U₁₋UT₋₁)) | | | | |
| Users | “iph” | “pho” | “hon” | “one” | “the” |
| A | 0.2 | 0.2 | 0.2 | 0.2 | |
| B | 0.3 | 0.3 | 0.3 | 0.3 | |

In the case of n-gram processing, the result is a chart where one dimension shows the users (e.g. U1, U2), another dimension shows each topic broken down into n-grams (e.g. “iph”, “pho”, “hon”, “one”, “the”) for each user and each cell value represents the TF-IDF statistic.

Generally speaking, the tf-idf statistical value is the term frequency inverse document frequency which is a numerical statistic and provides information on the importance of each broken down segment of the topic words (e.g. a topic broken down into its n-gram) for each topic amongst the various broken down segments of topics for a user. That is, the tf-idf for a segment of a topic word (e.g. “iph”) reflects the statistic value based on the number of times the segment (e.g. “iph”) appears in the listing of all topics for the user. That is, for user1, the segmented topic (e.g. “iph”) may have a statistical probability of X among all topics (e.g. topics T₁(U₁)-T_{M}(U₁) as shown in FIG. 16) for the particular user, user1. The n-grams TF-IDF provide a statistical likelihood of the occurrence of the n-gram for the particular user. Accordingly, for each user, a listing of TF-IDF is output associated with respective n-grams. The vector of n-gram tf-idf's are thus fed into the clustering module at block 1606.

At block 1606, the active receiver performs clustering on text processed topics (e.g. receiving a vector of TF-IDF values for each n-gram of a respective user) to provide relevant segment groupings across all users (users U_{T}) associated with a topic.

At block 1607, the active receiver determines a set of representative topics (T1-Tx) in each cluster and label each cluster with the representative topics.

In one embodiment, not illustrated in FIG. 16, subsequent to the step illustrated at block 1605, the active receiver identifies and filters out outlier nodes within the topic network. This can be done, for example, using n-gram processing. The outlier nodes are outlier users that are considered to be separate from a larger population or clusters of users in the topic network. That is, they can relate to users that have a topic without a sufficient measure of commonality with topics of other users (e.g. as determined by the n-gram processing, the subsets of a particular topic for a user does not statistically overlap over a pre-defined threshold with the subsets of each topic for other users. The set of outlier users or nodes within the topic network is represented by UO, where UO is a subset of UT. In one aspect, the users UT are outputted, with the users UO removed.

Referring to FIG. 17, an example implementation of the blocks 1601-1607 in FIG. 16 for performing dynamic segmentation of data relating specifically to Twitter users. The segmentation method, an example of which is depicted in FIG. 17, thus uses these exemplary steps:

1. Gather list of users for a particular query or topic. This list can be compiled, for example, by gathering all users who have tweeted about a given search term query (e.g. Tweets from users who have used “iPhone” in their tweets, in the past 6 months), or simply all followers of a specific brand handle.

2. For each user, gather a random sample listing of their tweet history (e.g. posts related to a specific social networking platform Twitter). In one aspect, the sample will be taken from their recent tweets to get an accurate picture of their current interests and preferences. In a preferred aspect, a sample size between 500 to 1000 tweets is preferred to extract enough hashtags to be useful.

3. Extract the hashtags from each of the user's historical tweets, and associate each one to the corresponding user. The result should be a map from user to a list of hashtags.

4. Perform text processing on each user's list of hashtags, normalizing the text to lowercase, and removing common hashtags that convey no meaning such as “#RT” (i.e. stopword removal).

5. From the full list of hashtags, use a character n-gram model to represent the hashtags using term-frequency inverse document frequency (TF-IDF). The result of this process is a document-term matrix where the columns represent the users, the row represents the n-grams, and each cell represents the TF-IDF statistic.

In a preferred aspect, a trigram (n=3) model for n-gram processing results in an optimal balance between processing speed and segmentation quality.

6. Using an unsupervised machine learning clustering method for a pre-defined number of clusters e.g. in one aspect k=[5, 9] gives highly relevant segments. In a preferred aspect, spherical k-means clustering algorithm is particularly effective in clustering high dimensional text data. The final result of this algorithm is a mapping from each user to one of the k clusters.

However, one of the aspects of a clustering analysis is the labeling of the clusters. To address this issue, an additional step is added to label the clusters: 1. For each cluster, collect all the hashtags associated with each user in that cluster. 2. For each hashtag, count the number of users who have used that hashtag in that cluster. 3. Label that cluster with the top hashtags for each cluster. In a preferred embodiment, the top ten or so hashtags provides a good labeling of the cluster.

Referring to FIG. 17, the end result provided by the steps according to the present example is a set of k segments, which are labeled with a set of hashtags denoting the interests of the users in the segment. In a preferred aspect, this type of behavioural segmentation is very powerful for marketers and CRM applications.

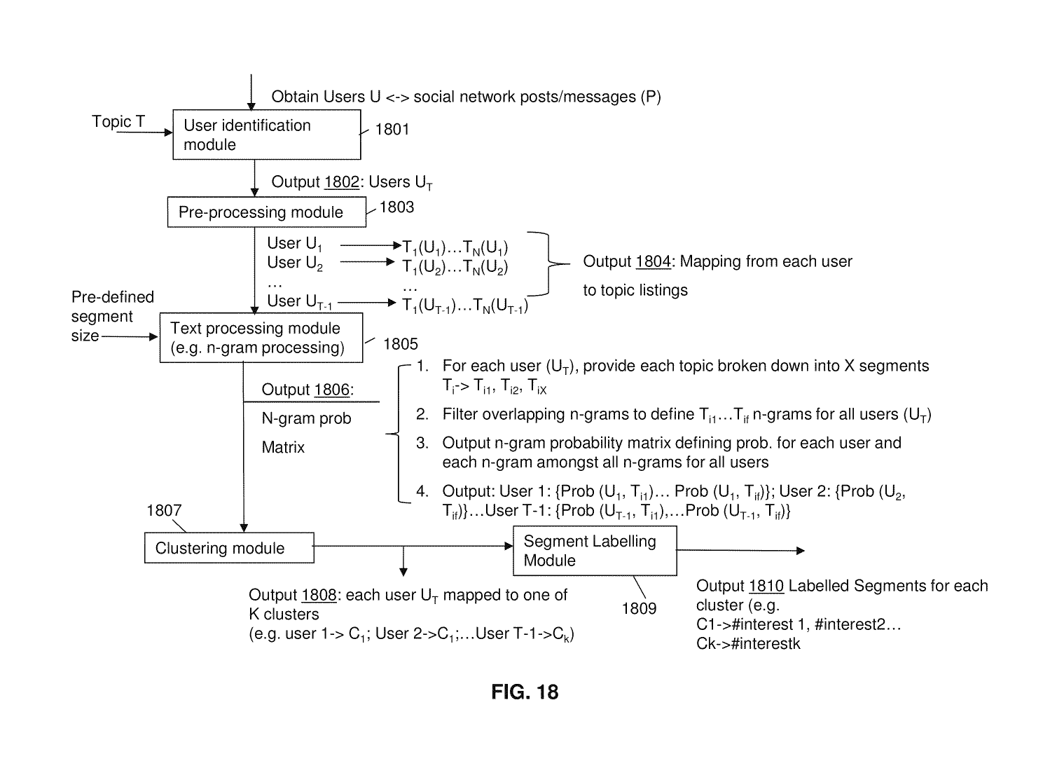

Turning to FIG. 18, shown is a flow diagram of an example embodiment of computer executable instructions associated with different modules including: a computer-implemented user identification module 1801, a pre-processing module 1803, a text processing module 1805, a clustering module 1807, and a segment labelling module 1809. These modules are part of the behavioural segmentation module 707. As illustrated, the user identification module 1801 obtains data relating to a plurality of users U and their associated social networking posts/messages (e.g. Tweets). The user identification module 1801 then extracts a listing of users U_{T} that have social networking posts/messages relating to a pre-defined topic T and provides the listing of users U_{T} as output 1802.

Subsequently, the pre-processing module 1803 is configured to provide a mapping from each user to a plurality of topic listings associated with the respective user at output 1804.

The text processing module 1805 is then configured to receive the listing of topics and associations with each user U_{T} such as to calculate an n-gram probability matrix based on a pre-defined segment size defined at the text processing module 1806. That is, in one aspect, the text processing module 1805 is configured to: for each user (U_{T}), provide each topic broken down into X segments Tᵢ->Tᵢ₁, Tᵢ₂, T_{iX} filter overlapping n-grams to define Tᵢ₁ . . . T_{if} n-grams for all users (U_{T}) and output n-gram probability matrix (output 1806) which defines probability for each user and each n-gram amongst all n-grams for all users. An exemplary output 1804 defined as: User 1: {Prob (U₁, Tᵢ₁) . . . Prob (U₁, T_{if})}; User 2: {Prob (U₂, T_{if})} . . . User T-1: {Prob (U_{T-1}, Tᵢ₁), . . . Prob (U_{T-1}, T_{if})}.

The clustering module 1807 thus receives a vector of n-gram TF-IDFs for each user U_{T}. The clustering module 1807 is then configured to map each user U_{T} into one of K clusters (e.g. user 1->C₁; User 2->C₁; . . . User T-1->Cₖ), as per output 1808.

The segment labelling module 1809 is then configured to provide at output 1810, the labelled segments for each cluster (e.g. C1->#interest 1, #interest2 . . . Ck->#interestk). These labels may also be called topics or keywords.

With respect to the directional receiver module 708, it is appreciated that the active receiver is configured to narrow the scope of data being obtained. It is herein recognized that obtaining large amounts of data and then parsing or filtering through the same can be computationally intensive. It can be desirable to only obtain specific data to avoid downloading and storing large amounts of unnecessary data. A method performed by the directional receiver module 708 is used to help target the obtaining operations of the active receiver.

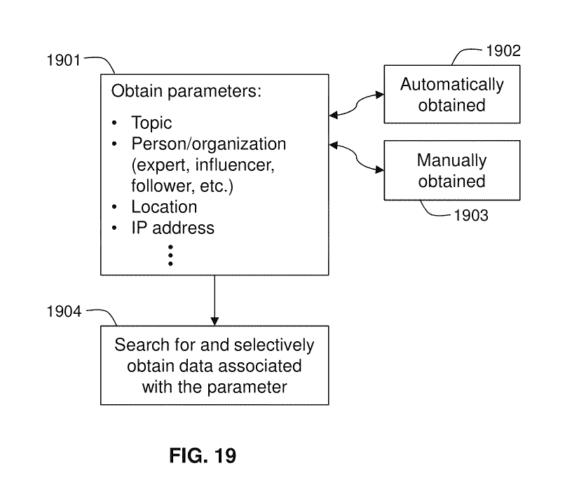

Turning to FIG. 19, the active receiver obtains parameters used to narrow down the search for data (block 1901). For example, the parameters include any one or more of a topic, a person or organization (e.g. expert, influencer, follower, a community, etc.), a location, a time range, a keyword or key phrase, and an IP address. Other parameters may be used as well. These parameters may be automatically obtained (block 1902). For example, the topics, the experts, the influencers, the followers, and the communities may be automatically obtained using any one or more of the operations performed associated with modules 704, 705, 706, and 707.

The parameters may also be manually obtained (block 1903), for example, using user input.

At block 1902, the active receiver uses the obtained parameters to search for and obtained data that is associated with the parameters.

For example, after establishing an influencer or an expert as a parameter, the active receiver actively obtains data related to the influencer or the expert. This related data, for example, includes: name, keywords used, common words used, followers, location, likes, dislikes, frequency of posts or messages, writing styles, language, etc. In an example embodiment, the active receiver does not obtain data from other users in the social network when obtaining data from the influencer or the expert, so as to narrow the scope of data being obtained.

In an example embodiment, when automatically obtaining the parameters, the parameters may be dynamically and automatically updated. For example, as the top influencers or the top experts for given topic change over time, so do the parameters associated with the top influencers or the top experts also change over time.

In another example, after establishing a location as a parameter, the active receiver only actively obtains data related to the given location. For example, message posts, article posts, tweet posts, etc. that originate from the given location are obtained, while other social data originating from other locations are not obtained.

In this way, social data associated with the parameter is selectively obtained and other data is ignored or intentionally not obtained. In other words, the operations to obtain the data are directed to specific targets.

With respect to the filter module 709, in an example aspect, the active receiver is configured to use the filter module to identify certain characteristics in the social data and amplify those characteristics. In another aspect, the active receiver uses the filter module to analyze the obtained social data and remove any anomalies.

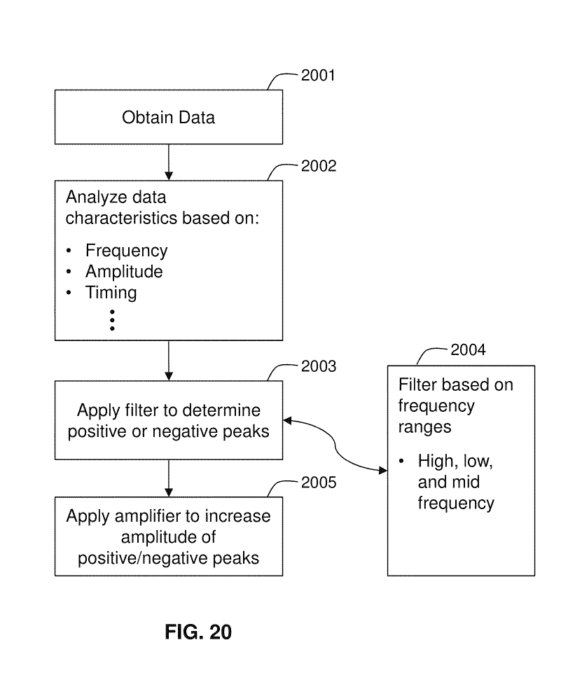

Turning to FIG. 20, example processor executable instructions are provided for filtering data to identify and amplify certain characteristics. This is beneficial to highlight certain meaning and content in the social data, which may be important or desirable, while ignoring the rest of the social data.

At block 2001 the social data is obtained. At block 2002, the active receiver analyzes the data based frequency, amplitude and timing. The frequency data or metaphor represents a certain social channel or plurality of social channels on the same social network or a plurality of several social channels spanning different social networks. The amplitude data or metaphor represents and characterizes the amount of activity (e.g. number of digital messages or number instances of a certain type of social data occurrence) on a certain social channel or a plurality of social channels on the same social network, or a plurality of social channels spanning different social networks. A social data occurrence may be characterized in different ways or based on different filters. For example, a social data occurrence may be a message from a certain type of user, or any message that uses a certain keyword, or a social data object originating from a certain location, or a social data object associated with a brand or a company. It can be appreciated other ways for characterizing a social data occurrence can be used. The timing data or metaphor represents different dimensions of the frequency activity and or the amplitude activity. For example, the frequency or timing, or both, of the social data occurrences is tracked. Specifically there is more or less activity on certain social channels or a plurality of social channel activity on the same network or a plurality of social channel activity on different network activity—all at similar or opposite or recognizable patterns throughout the time of day. At block 2003, a singular or plurality of filter(s) is applied to determine positive or negative peaks (frequency peaks/valleys, amplitude peaks/valleys and timing peaks/valleys) in the data. A different filter could automatically machine learn peaks or valleys and automatically remove this data. The filter may be based on different frequency ranges or amplitude ranges, or both (block 2004). At block 2005, an amplifier process is applied to the amplitude of the positive or the negative peaks. Alternatively the amplifier could amplify data that was previously overshadowed by the distractive peak or valley information to hear the real signal amongst the distracting peaks and valleys in the social data. This exaggeration or amplification of the data helps the system 102 to more readily identify the importance of the data.

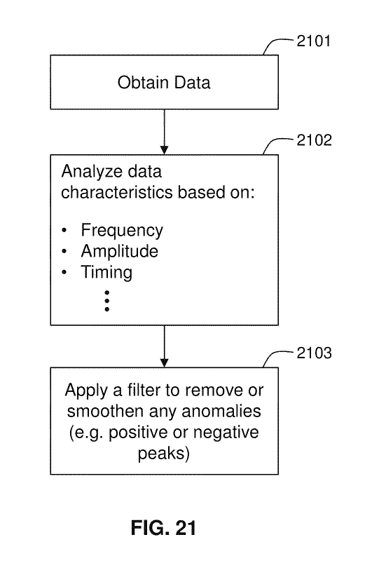

Turning to FIG. 21, example processor executable instructions are provided for filtering noise, including anomalies, in the social data. In this the way, the active receiver is able to output data and relationships that are more accurate. A non-limiting example of an anomaly in social data may include, for example, a topic that seem to be of interest to a certain group, but is not actually of interest to a group. Such an anomaly may be caused, for example, by many people using an ancillary topic keyword for a very short amount of time, while discussing a primary topic keyword over a longer or persistent period of time. The high number of instances of the use of the ancillary topic keyword is considered an anomaly, rather than a representation of a topic of interest. It is appreciated that other examples of anomalies are applicable and may be based on other characteristics, such as location, IP address, frequency, time range, users, communities, and relations between other users.

An example of noise in social data is when an expert or an influencer, or a group of users, regularly and frequently uses certain keywords and infrequently uses ancillary keywords. The infrequently used ancillary keywords may be considered as noise. It is appreciated that other examples of noise are applicable and may be based on other characteristics, such as location, IP address, frequency, time range, users, communities, and relations between other users.

At block 2101, the active receiver obtains the social data. It then analyzes the social data characteristics based on any one or more of frequency, amplitude, timing, etc (block 2102). At block 2103, the active receiver applies a filter to remove the noise or anomalies. For example, the active receiver removes any positive or negative peaks in the social data.

The process of FIG. 21 is a derivative of the content in FIG. 20, with an exception. The process of FIG. 21 is considered to be a “broadband receiver” constantly looking for patterns across frequency, amplitude, and time. By contrast, the process of FIG. 21 may be considered the inverse of the process of FIG. 20. In particular, in the process of FIG. 21, human or machine based key words, phrases, metadata etc. are inserted into the filter and applied to the social data to remove noise or anomalies.

With respect to the location and the topic correlator module 710, the active receiver is configured to use the module 710 identify and output relationships between different locations based on a similar topic or keyword.

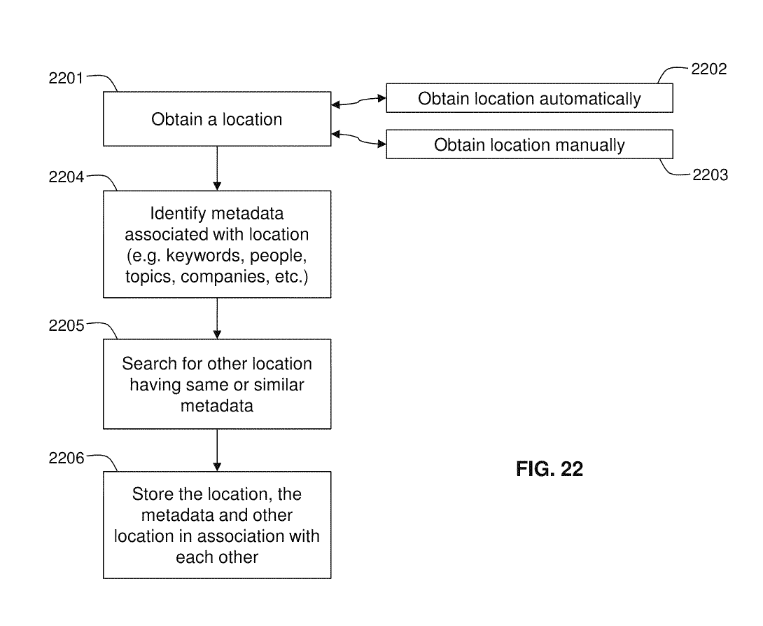

Turning to FIG. 22, example processor executable instructions are provided for performing operations according to the location and the topic module correlator 710, or more generally, via the active receiver. At block 2201, the active receiver obtains a location or multiple locations. The location or locations can have one or more forms, such as, for example, a country, a state or province, a region, a city, a village, an area, a demographic location, etc. The location may be obtained automatically (block 2202) or manually (block 2203). For example, when the location is obtained automatically, active receiver obtains the location based on metadata obtained in relation to an expert, an influencer, a community of influencers, or a segment of users. The location may also be automatically obtained based on pre-determined business intelligence of users or customers of the system 102 (e.g. location of users or customers, or location of their activity).

At block 2204, the active receiver identifies metadata associated with the location. Examples of such metadata include topics, keywords, key phrases, people, companies, etc. For example, if the obtained location (from block 2201) is the city of Toronto in Canada, a popular and commonly associated topic with Toronto is ‘mayor scandal’.

At block 2205, the active receiver searches for one or more other locations have the same or similar metadata. Continuing with the Toronto example, the active receiver searches for another location that is also commonly associated with the topic ‘mayor scandal’. The other location, in this example, is the city of San Diego in the United States.

At block 2206, the active receiver stores the location, the meta data and the other location in association with each other. Continuing with the Toronto example, the active receiver stores the relationship or associations between the location of Toronto, the location of San Diego and the common topic of ‘mayor scandal’.

It will be appreciated that such an association, for example, can be used to identify target audiences that are located in different locations, but have similar interests or a common topic (e.g. as per the module 104). In another example, the relationship can also be used to determine to which different locations should advertisement data be transmitted, based on common or shared meta data (e.g. as per the advertisement procurement module 105).

With respect to the data collaborator module 711, the active receiver is configured to use the module 711 to combine data from different data sources to form a more complete, or a complete data set. It is herein recognized that it is desirable to obtain many different types of data related to a specific topic, product, service, person, organization, location, user, or more generally, a specific subject. However, a single data source may not be able to provide all the different types of data, while other data sources may provide the missing types of data. The operations used according to the data collaborator module 711 can be used to address such problems.

In another aspect, the active receiver is configured to use the module 711 to obtain data from different sources to verify the data. In particular, it is herein recognized that data from a data source may not be reliable or correct. To verify that a data value for a certain data type is correct, the active receiver obtains the same data types from different data sources and compares the data values of the same data types.

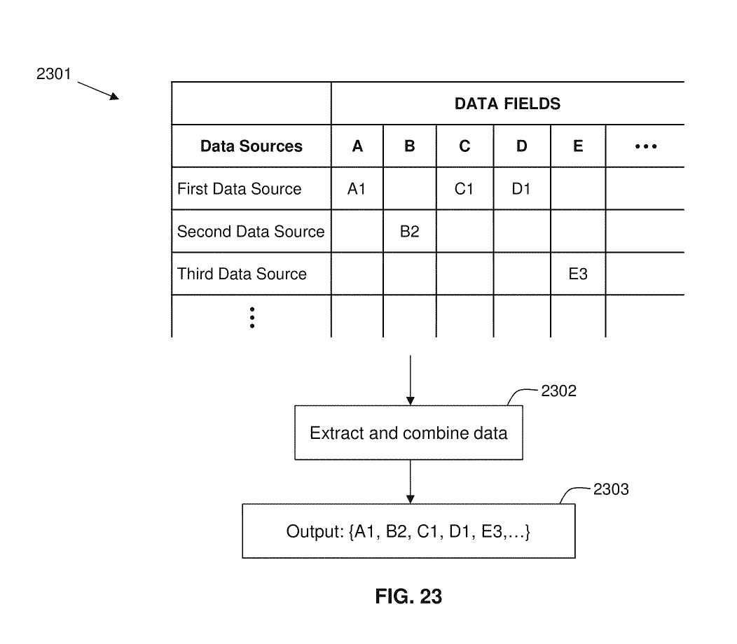

Turning to FIG. 23, an example is provided for combining data from different data sources to form a more complete, or a complete data set. In the graphical representation 2301, a set of data fields (e.g. A, B, C, D, E, etc.) are shown as being desired to be obtained by the active receiver. For example, the data fields may all relate to a certain subject, such as a person and non-limiting examples of the data fields for the person include name, age, location, email address, occupation, community or groups, and interests. As shown in the representation 2301, a first data source only can provide data values A1, C1 and D1 for the data fields A, C and D. In other words, the first data source is not able to provide data values for all the data fields, such as data fields B and E. A second data source only provides the data value B2 to populate the data field B and a third data source only provides the datable E3 to populate the data field E.

At block 2302, the active receiver extracts the data from these different data sources and combines the data. At block 2303, a more complete or a complete data set, in which the data fields are populated from the different data sources, is outputted. For example, the completed data set is {A1, B2, C1, D1, E3, . . . }.

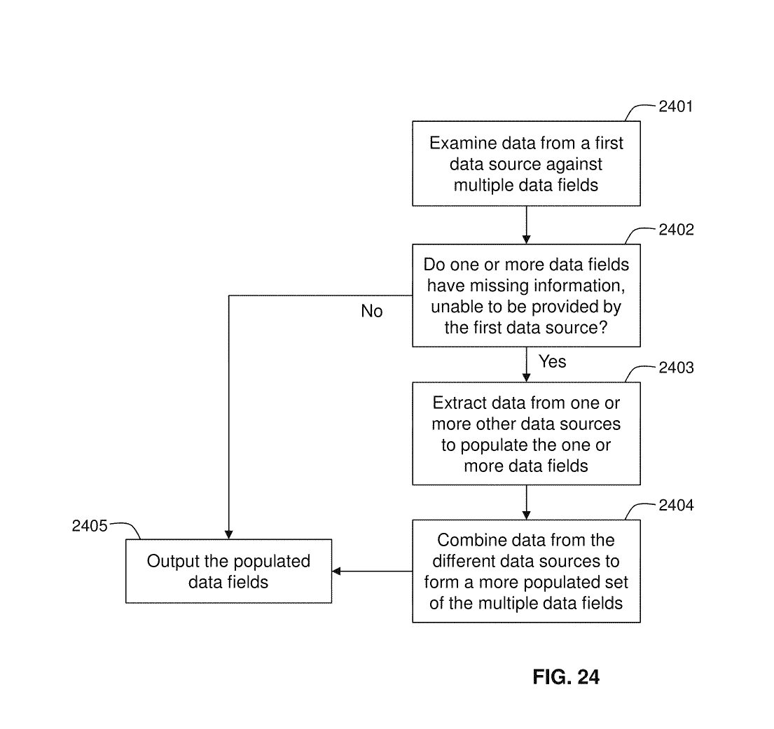

Turning to FIG. 24, example processor executable instructions are provide for combining data from different data sources to form a more complete, or a complete data set. These operations can be performed according to module 711, or more generally via the active receiver. At block 2401, the active receiver examines data from a first data source against multiple data fields. At block 2402, the active receiver determines if one or more data fields have missing information, which is unable to be provided by the first data source. If not, such as when the first data source provides data to populate all the data fields, then the process proceeds to block 2405 and the active receiver outputs the populated data fields.

However, if there is missing information in one or more data fields, then the active receiver extracts data from one or more other data sources to populate the one more data fields (block 2403). The active receiver then combines the data from the different data sources to form a more completely populated data set, or a completely populated data set, of the multiple data fields (block 2404).

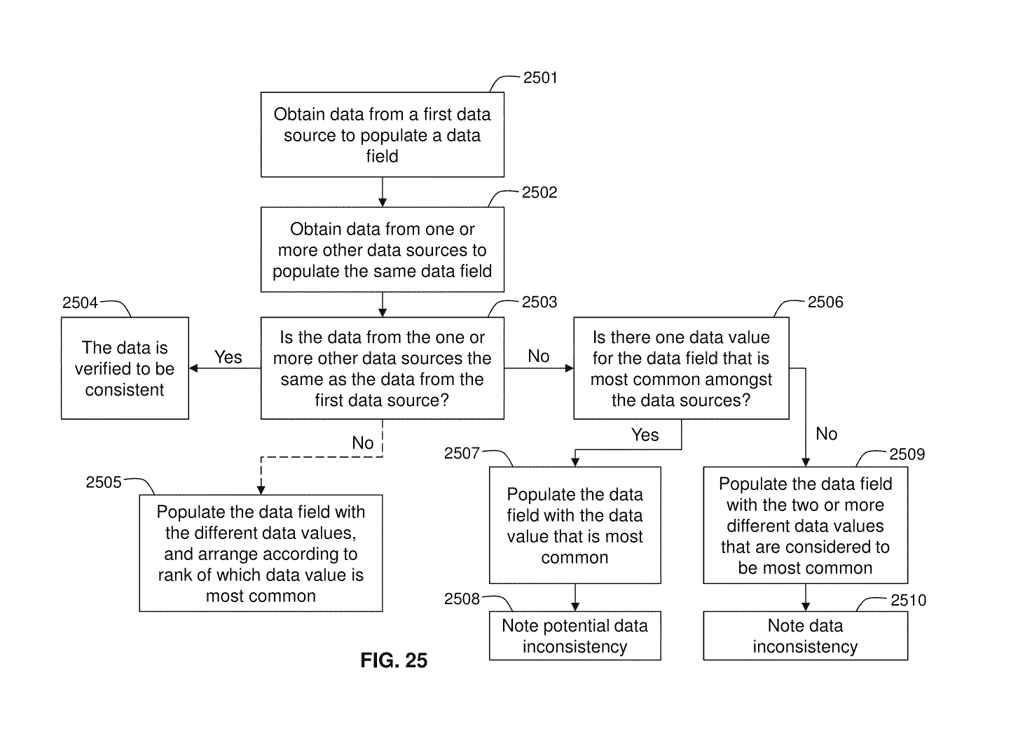

Turning to FIG. 25, example processor executable instructions are provided for filtering out noise, including anomalies, from social data. These instructions may be performed according to module 711, or more generally via the active receiver. At block 2501, the active receiver obtains data from a first data source to populate a data field. At block 2502, the active receiver obtains data from one or more other data sources to populate the same data field. At block 2503, the active receiver determines if the data from the one or more other data sources is the same as the data from the first data source. If so, at block 2504, the data is verified to be consistent.

If the data is not the same, then at block 2506, the active receiver determines if there is a data value for the date field that is most common amongst the data sources.

If there is a data value that is most common amongst the data sources, then the active receiver populates the data field with the data field that is most common (block 2507). A note about the potential data inconsistency is also made and associated with the data populated in the data field (block 2508). In this way, the system 102 or a user is aware that there is potential that the data is not correct.

In the alternative, continuing from block 2506, if there is no data value that is most common amongst the data sources, then there will be two or more different data values that are considered most common. These different data values are then used to populate the data field (block 2509). In other words, for the same data field, there are different data values. For example, a user's email address data field may be populated with different email addresses which are considered to be most common amongst the data sources. At block 2510, a note about the inconsistency in the data is made and associated with the data field and the data values. In this way, the system 102 or a user know that other data values for the same data field are possible.

In an alternative example embodiment, stemming from block 2503, if the data from the one or more other sources is not the same as the data from the first data source, then at block 2505, the active receiver populates the data field with the different data values. The different data values are ranked based on which data value is most common.

With respect to the prediction and the synthesizer module 712, the active receiver is configured to the module 712 to predict or synthesize, or both, one or more features related to an entity. A feature may be a characteristic related to an entity. A feature may also be an action that is predicted to be performed by an entity. A feature may also be an action that has been performed by an entity.

In particular, it is herein recognized that data about an entity may not be complete. However, using the prediction and synthesizer module 712, the active receiver is able to generate data about the entity, thereby making data about the entity more complete.

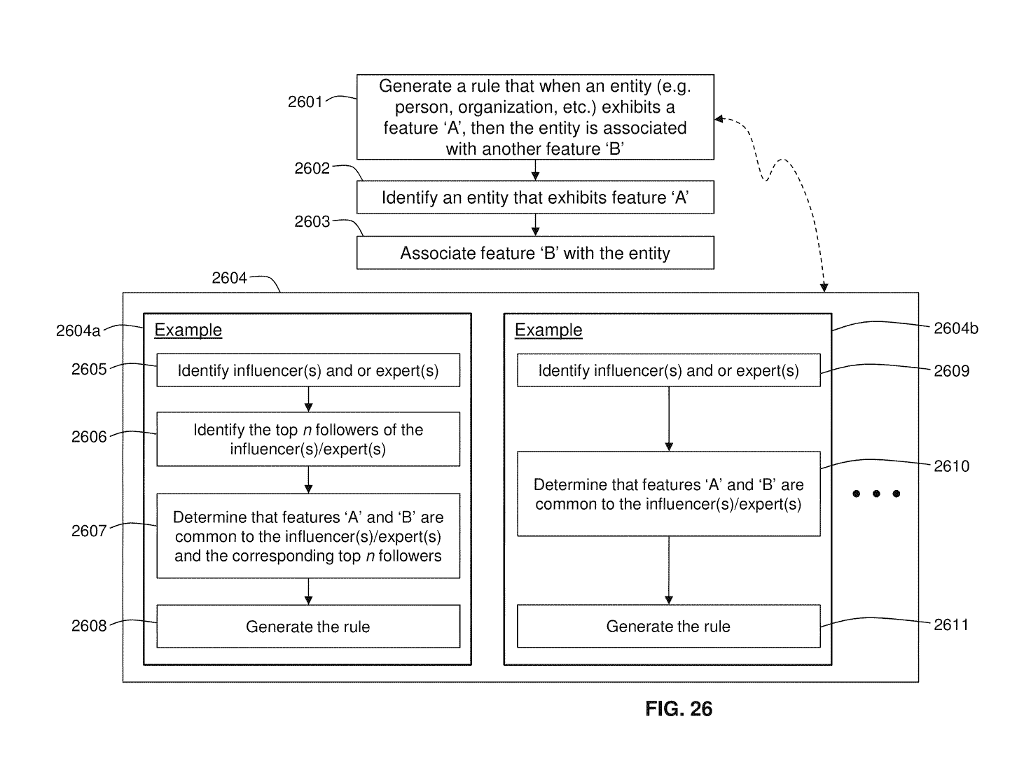

Turning to FIG. 26, example processor executable instructions are provided for predicting and synthesizing features. These instructions may be performed according to module 712, or more generally via the active receiver. At block 2601, the active receiver generates a rule that when an entity exhibits a feature ‘A’, then the entity is associated with another feature ‘B’. It will be appreciated that an entity may be a person, an organization, an account, a user, a group, a device, etc.

Non-limiting examples 2604 of generating such a rule are provided. An example 2604a includes identifying an influencer or an expert (block 2605), or multiples thereof. At block 2606, the active receiver identifies the top n followers of the influencer(s) or the expert(s). At block 2607, the active receiver determines that features ‘A’ and ‘B’ are common to the influencer(s) or the expert(s) and the common top n followers. At block 2608, the active receiver generates the rule that when an entity exhibits a feature ‘A’, the entity is associated with the other feature ‘B’.

Another example 2604b of generating the rule includes identifying an influencer or an expert (block 2609), or multiples thereof. At block 2610, the active receiver determines the features ‘A’ and ‘B’ are common to the influencer(s) or the expert(s). At block 2611, the active receiver generates the rule that when an entity exhibits a feature ‘A’, the entity is associated with the other feature ‘B’.

Continuing with FIG. 26, after generating the rule, at block 2602, the active receiver identifies an entity from the obtained data that exhibits feature ‘A’. At block 2603, the active receiver associates feature ‘B’ with the same entity.

In this way, although the entity has not exhibited feature ‘B’ and only feature ‘A’, the active receiver is configured to predict or synthesize that the entity is associated with feature ‘B’.

Other example aspects of the active receiver module are provided below.

The active receiver module 103 is configured to capture, in real time, one or more electronic data streams.

The active receiver module 103 is configured to analyse, in real time, the social data relevant to a business.

The active receiver module 103 is configured to translate text from one language to another language.

The active receiver module 103 is configured to interpret video, text, audio and pictures to create business information. A non-limiting example of business information is sentiment information. Sentiment information typically applies to whether a piece of social information is positive or negative. Consider the example social data: “I don't like Adidas shoes because my feet are wide and Adidas shoes are narrow”. In this example there is negative sentiment toward Adidas shoes.

Natural Language Processing (NLP) methods and algorithms are widely available both as open source (Ling Pipe) as well as commercially available (ClaraBridge). Social information can be entered into these NLP engines and output positive, neutral, or negative sentiment toward a social message.

The active receiver module 103 is configured to apply metadata to the received social data in order to provide further business enrichment. Non-limiting examples of metadata include geo data, temporal data, business driven characteristics, analytic driven characteristics, etc.

The active receiver module 103 is configured to interpret and predict potential outcomes and business scenarios using the received social data and the computed information. Determining and recommending potential event outcomes enables businesses to better forecast, reduce business risks, and make wiser decisions amongst a variety of possible outcomes. Using social information that has been collected, this data can be run through a Monte Carlo simulator. This computer intensive process can then output a variety of likely outcomes based on certain inputs. For example, if social networks are talking about the latest Adidas soccer shoe in Columbia, South America, Adidas could use Monte Carlo simulation to estimate the level of advertising money required to drive a certain purchase level.

The active receiver module 103 is configured to propose user segment or target groups based upon the social data and the metadata received. For example, the user and the segment groups are obtained by identifying experts and their followers. In another example, the users and the segments are obtained by identifying an influencer and their community or communities. In another example embodiment, the users and the segments are obtained by using any of the modules in the active receiver 103.

The active receiver module 103 is configured to propose or recommend social data channels that are positively or negatively correlated to a user segment or a target group.

The active receiver module 103 is configured to correlate and attribute groupings, such as users, user segments, and social data channels. In an example embodiment, the active receiver module uses patterns, metadata, characteristics and stereotypes to correlate users, user segments and social data channels.

The active receiver module 103 is configured to operate with little or no human intervention.

The active receiver module 103 is configured to assign affinity data and metadata to the received social data and to any associated computed data. In an example embodiment, affinity data is derived from affinity analysis, which is a data mining technique that discovers co-occurrence relationships among activities performed by (or recorded about) specific individuals, groups, companies, locations, concepts, brands, devices, events, and social networks.

### Example of a Target Audience Search Algorithm

As noted above with reference to FIGS. 5 and 6, different target audience search algorithms are stored in the target search audience analysis and library module 104. A non-limiting example of a target audience search algorithm or computing process is provided below.

Although the principles described herein may apply to different social networking platforms, many of the examples of the target audience searching are described with respect to Twitter to aid in the explanation of the principles.

It is recognized that known computing processes for identifying a group of people can be data intensive, and typically requires time to examine the interests. It also recognized that these computing processes are typically specific to a topic. For example, for each topic, a computer system will need to perform a new analysis of interests of the users in order to identify interests related to the topic. It is also recognized that the content of a user's messages changes over time, and thus, the analytics of interests may be outdated if the latest content of a user has not been analyzed. It is also recognized that these known computing processes are difficult to scale when there are millions of users continuously generating data content.

In an example aspect of the proposed computing systems and methods, an approach is provided to identifying a target audience, which is based on identifying friends (e.g. relationships between data accounts). Consider an old Mexican proverb that says, “Tell me who your friends are and I'll tell you who you are”. This is hugely fitting in today's online social data networks.

People active on social networks “friend” people/organizations they like, they re-tweets posts of people whose opinion matter's to them, and they click on links on topics they enjoy from trustworthy sources.

This new social way of thinking has significant implications in advertising. For example, brand building Twitter's “Tailored Audience” is designed to take advantage of this social reality, allowing brands to reach out to their target audience (see FIG. 27). FIG. 27 provides a simplified overview of the steps needed to reach the intended audience on Twitter. The goal is to get a lot of conversions and a high engagement rate. A conversion on Twitter is clicking on the link that's in the tweet. Engagement rate typically includes re-tweets, favorites, and replies. Other social data network platforms may have similar approaches to finding a target audience or a tailored audience.

The success of “Tailored Audience” hugely depends on finding the right targets.

It is herein recognized, however, that a computing system that leverages the social data network structure, including the friend and follower relationships, may be used to accurately identify relevant target audiences.

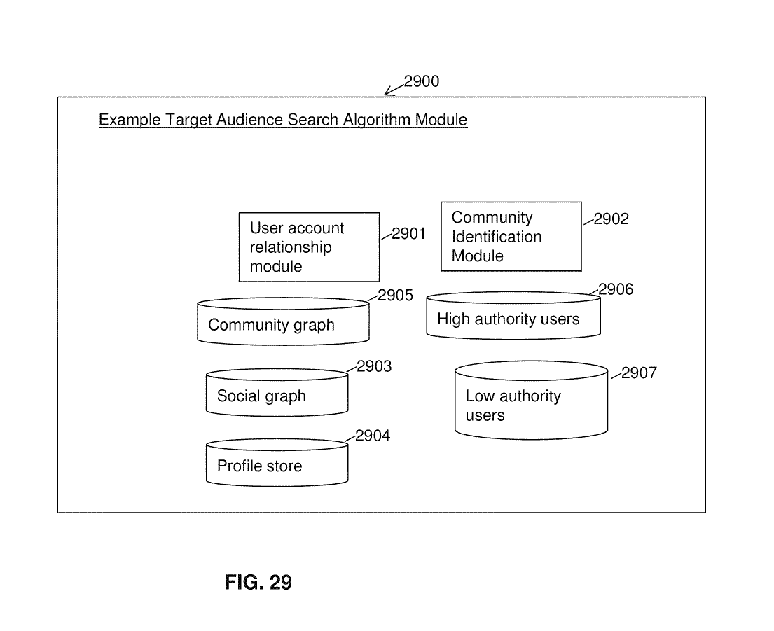

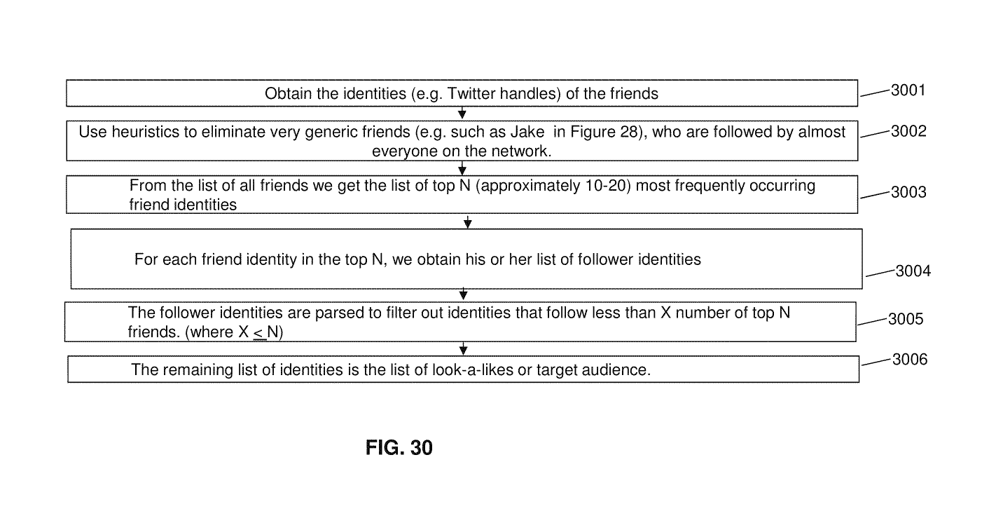

A non-limiting motivating example is shown in FIG. 28. The brand Dannon is a consumer goods company and they want to launch a campaign for their latest yogurt. There are other yogurt brands on the market such as brand logo and brand YoPlait. Celebrity Cho endorses many products of brand Dannon including this yogurt. We also know that Paul and Harry are all loyal customers of the brand. FIG. 28, shows their makeup on a social network. There is also Celebrity Jake who has the most number of followers on the network.

FIG. 28 shows an example social network. The target audiences for a brand Dannon are Harry, and Paul who follow Dannon, Kate who follows Cho (the brand ambassador of Danon) and another similar brand logo, and Brian who follows similar brands and brand Dannon's loyalists. However, other people such as Aym and Stef who follow a lot of the celebrities are likely not part of target audience.

From the graph, we get the sense that Kate and Brian are similar to Harry and Paul since they follow other yogurt brands such as logo, and Yoplait. Additionally, they both follow Dannon's brand ambassador Cho. Similarly, if logo, and Yoplait have other followers, they would also be target audience. However, Ayman and Stef and many others follow Jake and Cho but have no predisposition towards Dannon or Dannon like brands are likely not part of the target audience.

In many cases, the brand can identify a few Harrys, Pauls and Yoplaits. One of the challenges for a computing system lies in using this information and the social network structure to identify other people like Harry or Paul who like Dannon or people like Brian who are followers of similar brands like Yoplait.

It is herein recognized that, given a small list of users that have some significance for the brand, the followers of high authority handles (e.g., Yoplait or logo) are part of the target audience. For the low authority handles, the followers of their friends are part of the target audience (e.g., given Paul, logo is Paul's friend, and Kate is logo's follower; Kate is part of target audience).

The proposed computing systems and methods provided herein may be used to exploit the social network structure to provide the power to expand lists of, for example, 1,000 users to millions of users in one or more target audiences.

More generally, social networks allow users to easily pass on information to all their followers (e.g., re-tweet or @reply using Twitter) or friends (e.g., share using Facebook).

The terms “friend” and “follower” are defined below.

The term “follower”, as used herein, refers to a first user account (e.g. the first user account associated with one or more social networking platforms accessed via a computing device) that follows a second user account (e.g. the second user account associated with at least one of the social networking platforms of the first user account and accessed via a computing device), such that content posted by the second user account is published for the first user account to read, consume, etc. For example, when a first user follows a second user, the first user (i.e. the follower) will receive content posted by the second user. In some cases, a follower engages with the content posted by the other user (e.g. by sharing or reposting the content). The second user account is the “followee” and the follower follows the followee.

A “friend”, as used herein, is used interchangeably with a “followee”. In other words, a friend refers to a user account, for which another user account can follow. Put another way, a follower follows a friend.

For example, regarding friends, in FIG. 28 Harry, Paul, and Yoplait are friends of Brian. Brian can get updates and direct messages (e.g. posts) from any one of them. Regarding followers, in FIG. 28, Harry and Paul are Dannon's followers. Dannon can choose to send direct messages or posts to Harry and Paul; however, the reverse (solely based on FIG. 2) may not be true.

The term “post” or “posting” refers to content that is shared with others via social data networking. A post or posting may be transmitted by submitting content on to a server or website or network for other to access. A post or posting may also be transmitted as a message between two computing devices. A post or posting includes sending a message, an email, placing a comment on a website, placing content on a blog, posting content on a video sharing network, and placing content on a networking application. Forms of posts include text, images, video, audio and combinations thereof. Twitter refers to posts as “tweets”.

The term “authority” refers to a metric computed using an algebraic formula incorporating the number of followers and the number of mentions (e.g. Tweets, posts). This metric, sometimes called the “authority metric” or “authority score”, provides a rough estimate to distinguish between the more influential users, such as popular users and brand or company accounts, (e.g. Yoplait) and other users (e.g. Harry). The users with higher authority scores (e.g., Yoplait, logo, and Cho) will likely be other similar brands or brand influencers and hence their followers are the target audience. The users with low authority (e.g., Harry, Paul, and Brian) are themselves the target audience. The input users will be segregated based on authority and treated differently in the methodology.

In an example embodiment, the Authority score, for example, is computed using a linear combination of several parameters, including the number of posts from a user and the number followers that follow the same user. In an example embodiment, the linear combination may also be based on the number of ancillary users that the same user follows.

The Authority score has a high follower count bias. If there is a well-defined specialist in a certain field with a limited number of followers, but all of them are also experts, they will never show up in the top 20 to 100 results due to their low follower count. Effectively, all the followers are treated as having equal weight.

Other methods and processes may be used to rank the users. For example, the server may use PageRank to measure importance of a user within the topic network and to rank the user based on the measure. Other non-limiting examples of ranking algorithms that can be used include: Eigenvector Centrality, Weighted Degree, Betweenness, Hub and Authority metrics.

Turning to FIG. 29, an example of a target audience search algorithm module 2900 is shown, including its components. The example search algorithm module 2900 preferably resides in the target audience analysis and library module 104, but in another example embodiment, resides in the advertisement procurement module 105. This example search algorithm module 2900 obtains social network data about users (e.g. their user accounts).

It can be appreciated that social network data includes data about the users of a social data network platform, as well as the content generated or organized, or both, by the users. Non-limiting examples of social network data includes the user account ID or user name, a description of the user or user account, the messages or other data posted by the user, connections between the user and other users, location information, etc. An example of connections is a “user list”, also herein called “list”, which includes a name of the list, a description of the list, and one or more other users which the given user follows. The user list is, for example, created by the given user.

The module 2900 includes a user account relationship module 2901 and a community identification module 2902. The community identification module 2902 is configured to obtain the communities of users or cluster of data based on a network graph. The communities of users and the clusters of data are computed by the active receiver module 103, and then transmitted or made accessible to the module 2900

The module 2900 also includes a number of databases, including a database for a social graph 2903, a profile store 2904, a database for storing community graph information 2905, a database for storing high-authority users 2906, and a database for storing low-authority users 2907.

A social graph may be computed by the active receiver module 103 and transmitted to the module 2900 for storage in the social graph database 2903. Alternatively, a social graph is obtained from the social networking platform server, not shown, and is stored in the social graph database 2903. The social graph, when given a user as an input to a query, can be used to return all users following the queried user.

The profile store 2904 stores meta data related to user profiles. Examples of profile related meta data include the aggregate number of followers of a given user, self-disclosed personal information of the given user, location information of the given user, etc. The data in the profile store 2904 can be queried.

In an example embodiment, the user account relationship module 2901 can use the social graph 2903 and the profile store 2904 to determine which users are following a particular user. In other words, a user can be identified as “friend” or “follower”, or both, with respect to one or more other users. The module 2901 may also configured to determine relationships between user accounts, including reply relationships, mention relationships, and re-post relationships.

The target audience search module 2900 performs executable instructions for identifying a target audience.

Turning to FIG. 30, an example embodiment of computer executable instructions are shown for determining a target audience. The instructions include obtaining an initial group of users in a social data network. This initial group may be called the sample target users. The server then obtains the identities of friends of the users (3001). In the example of Twitter, the identities are called “handles”. Heuristics may then be used to eliminate very generic friends, who are followed by almost everyone on the network (3002). An example of a generic friend is Jake in the example graph of FIG. 28. From the list of all friends, the server obtains the list of top N most frequently occurring friend user accounts (e.g. the top N friend Twitter handles in the example of Twitter) (3003). In a non-limiting example, N is in the range of approximately 10 to 20.

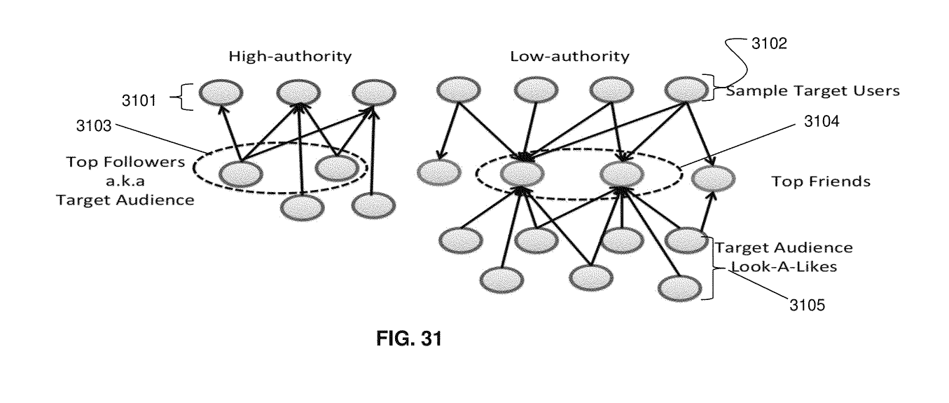

For each friend account identified in the top N, the server obtains his or her list of follower handles (see FIG. 31) (3004).

The follower identities (e.g. or handles) are parsed to filter out identities that follow less than X number of top N friends (3005).

The remaining list of identities (e.g. or handles) is the list of look-a-likes, also called users in the target audience (3006).

Turning to FIG. 31, a set of graphs are shown for high-authority users and low-authority users. In another example, an initial group of users, or sample target users is characterized as high-authority users 3101 and low-authority users 3102 based on the Authority score. A threshold authority score or metric is used to separate the high-authority users from the low-authority users.

The high-authority users' relationships are analyzed to determine the top followers 3103 of the high-authority users. Those top followers form part of the target audience. In an example embodiment, the top followers are those followers that are common to at least C of the high-authority users, where C is an integer ≧2. The high-authority users may also be part of the target audience.

For the low-authority users, the top friends 3104 of the users are determined, and the followers 3105 of those top friends are used to form part of the target audience. The top friends and the low-authority users may also be part of the target audience. It will be appreciated that the friends provide the context to identify the look-a-likes or a target-audience. In an example embodiment, the top friends are those friends that are common to at least T of the low-authority users, where T is an integer ≧2.

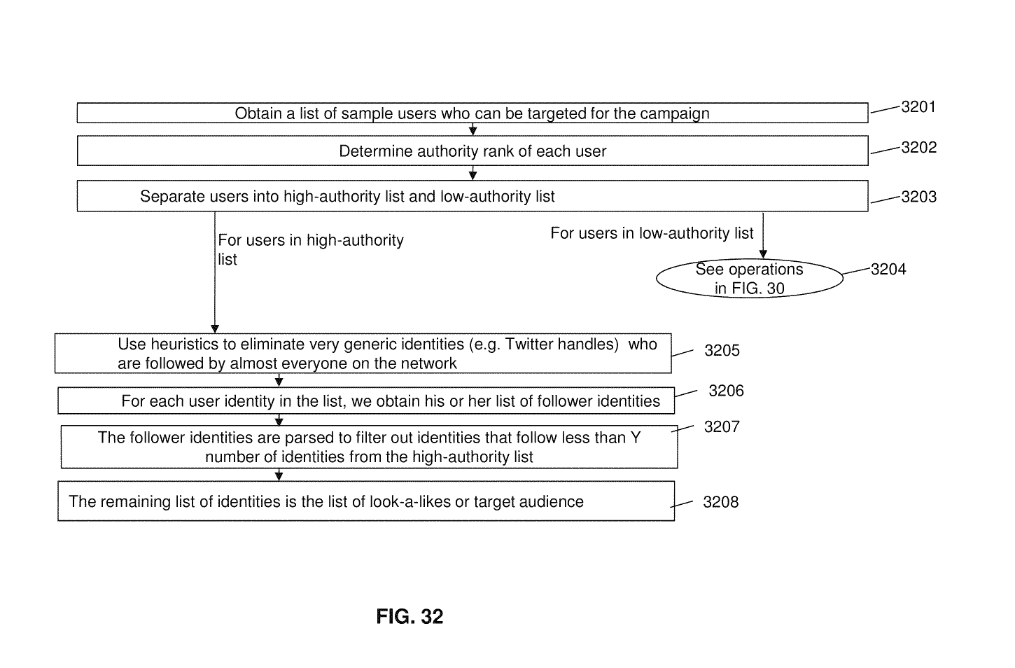

Turning to FIG. 32, example processor executable instructions are shown for identifying a target audience amongst both high-authority users and low-authority users.

Finding a target audience for a campaign (e.g. an advertising campaign) involves expanding the input list of users with large number of additional users who are similar to the input. The operations involved in generating the target audience are stated below.

The server obtains a list of sample users who can be targeted for the campaign (3201). These users may be obtained from identifying influencers and their communities. The initial list of users may be obtained based on communities or groups that are related or relevant to a topic, a key word or phrase, or a brand. These users may be provided from a third-party. It is appreciated that the initial list of sample users may be obtained in various ways.

In an example embodiment, the initial community of users or set of users is determined based on the computations of the active receiver module 103 and in particular, its influencer module 706. In one particular example, a community of users may be used as the initial list of sample users. In another particular example, the influencers are used as the initial list of sample users. In yet another example, both the communities and the influencers are used as the initial list of sample users.

Continuing with FIG. 32, the authority score of each user is determined (3202). The users are separated into a high-authority list and a low-authority list based on their authority score (3203).

For the low-authority users, the operations described in FIG. 30 are executed (3204).

For the high-authority users, the server uses heuristics to eliminate very generic handles (e.g. Jake shown in FIG. 28), who are followed by almost everyone on the network (3205).

For each user account identity (e.g. Twitter handle) in the list, the server obtains his or her list of follower handles (3206).

The follower identities (e.g. or handles) are parsed to filter out identities that follow less than Y number of identities from the high-authority list (3207), where Y is an integer.

The remaining list of identities is used to form at least part of the list of look-a-likes or the users in the target audience (3208).

It is appreciated that the target audience includes the users derived from both the low-authority and the high-authority users.

After obtaining the users in the target audience, this target audience is used in other computations as described above, for example, with respect to FIG. 5.

Example Case Studies

The underlying Twitter data is used to highlight the salient points in each of the example case studies to demonstrate the value of the proposed system and method. This section is divided into three subsections: the first section talks about the correlation between inputs and outputs (e.g. called “Interests and Demographics”); the second section talks about the usability of the lists generated (called “Match Rates”); and the third section talks about the outcomes obtained when using the expanded lists (called “Conversion Metrics”).

Interests and Demographics

When given an input list of users and asked to find look-a-likes, the first objective of course is to make sure that the input and output lists are similar in certain aspects, such as gender, geography, and in example case of Twitter, the bios that people include in their profile. This comparison provides a rough but good understanding how the inputs and outputs correlate.

The server obtains two input lists from a certain brand. In both cases the input list had 1K users. The list had a mix of influencers and other users interested in the topic. In both cases the list was expanded to 100K users. The correlation between the input and output lists is shown across 3 different dimensions.

Beauty & Grooming Example

The input and output lists had similarity in the profiles of the users. Some of the most prominent words were beauty, blogger, makeup, hair, nail, skin, skin-care, etc. As expected, the gender was biased towards females in both lists (˜60% in input list and ˜66% in output list). The brand had provided as input mainly its UK based users and so it was not surprising that the input consisted of 98% users from UK. However, the unexpected result was that in the output list ˜55% users were from UK and it was the largest contributor to the output list.

Gaming Example

This saw similar results to grooming. The input and output profiles had similar words such as xbox, videos, psi, ps4, playstation, geek etc., (2) the gender was biased towards males in both lists (˜98% in input and ˜95% in output and (3) UK formed the largest geographic contributor to both lists (˜98% in input list and ˜59% in output list).

Although two representative examples in this section are discussed, similar or comparable trends were observed when processing other keywords related to music, “green environment,” ice-cream, social media and so on.

Match Rates

Twitter's “Tailored Audience” allows a user to upload a list of users to be targeted in a campaign. However, not all the entered users are targeted, Twitter's computing system performs some pre-processing on the list (to take into account people's privacy settings, to avoid spamming, and so on) before allowing the user to set up the campaign. After the processing, Twitter's computing system provides a number called match rate that is the percent of the input that can be targeted in the current campaign. From published match rates, the current range is anywhere from 25%-40%.

TABLE 2
Example match rates for different input list sizes

| | | | | Match |
|---|---|---|---|---|
| Upload size | Status | Size | Last updated | rate |
| 10,000 | READY | 4,640 | Jul. 30, 2014 | 45% |
| 2,000 | READY | 1,040 | Jul. 30, 2014 | 52% |
| 10,000 | READY | 5,420 | Jul. 4, 2014 | 54% |
| 10,000 | READY | 5,800 | Jul. 4, 2014 | 58% |
| 50,000 | READY | 32,585 | Jul. 31, 2014 | 65% |
| 50,000 | READY | 34,347 | Jul. 31, 2014 | 69% |
| 100,000 | READY | 66,679 | Jul. 31, 2014 | 67% |

Table 2, shows the different lists sizes generated for keywords such as “social media” and “television executives.” In most cases the Twitter match rate obtained is significantly higher than the published results. The proposed computing systems and methods described herein are able to tap into the “passive users” space. Passive users do not actively post (e.g. tweet), but they heavily use a social network (e.g. such as Twitter) as an information source of all their favorite celebrities and brands. Such users will not pop up in methods that rely on tweeting activity to identify target audience.

Conversion Metrics

In the section, two campaigns are discussed that were run using the lists generated by the proposed systems and methods described herein. In both cases the starting point was a query on a social network analytics engine, such as a Sysomos engine, to identify a few individuals related to the topic/brand. The list was then expanded using out methodology and a campaign was run using Twitter's Tailored Audience.

“Social Media” Campaign Example

An initial sample of 324 users was identified by determining a community of users (e.g. module 706) who had tweeted about social media. This list was expanded to a size of 10K using the methodology. Some key points about the campaign (after 1 week of the campaign) are stated below:

The match-rate for the input list was approximately 60%.

The Engagement Rate was 3.4% in comparison to the 0.81% generated by previous campaigns using keyword searches.

Although Twitter was estimating a match rate of 6K, the campaign actually reached 14K impressions.

“Ice-Cream” Brand Campaign Example

The communities approach (e.g. module 706) was used to identify two communities relating to “ice cream” lovers consisting of 196 users and 249 users. Each community was expanded to about 50K users using the methodology. Some key points about the campaign are stated below.

The match-rate for the input list was over 50%.

The Engagement rate was 9% and 10% for the two lists which was higher than the ˜4% generated by previous campaign runs for the same keywords.

The two campaigns reached 21K and 27K impressions.

Note that, at this time, the brand is continuing to run the campaign owing to the strong first round results.

Based on the above, computing systems and methods are provided that identify the target audience for any campaign utilizing some sample set of users (for example, approximately 1000 users) with the required attributes and may be used to expand the set to over 100 or 1000 times its size with relevant look-a-like users. The methods use the friend relationship to understand preference and likes and exploits the network structure to identify the target audience.

These insights may be used to improve the quality and effectiveness of advertisement campaigns and may be used to narrow the gap between the intended targets and the actual targets. Furthermore, this kind of control may be used to help drive smarter and more cost-effective business decisions and improve the ROI of online campaigns.

It will be appreciated that the above systems and methods may use the graph theory to identify relationships, including the friend and follower relationships. This approach allows the relationships to be immediately, or near immediately, updated and obtained by the server. The proposed systems and methods facilitate scalability amongst more user accounts and larger social data networks. The proposed systems and methods are also less data intensive compared to continuously monitoring the data content continuously outputted by millions of users. The proposed systems and methods are also independent of a topic, because the relationships between friends are followers are not directly dependent on performing computer analysis of the content of the data posts.

Below are general example embodiments and example aspects for searching for a target audience, which may be used in the system for continuous advertising.

In a general example embodiment, a method performed by a server system is provided for determining a target group of users in a social data network. The method includes: the server system obtaining identities of friends from a first group of users, where a user in the first group follows one or more of the friends, and the friends and the first group of users are associated with user accounts in the social data network; the server system determining N number friends that are most frequently occurring amongst the identities of friends from the first group of users; for each of the N number friends, the server system obtaining identities of followers following a given one of the N friends; the server system filtering out one or more followers from the identities of the followers that follow less than X number of the N number of friends, where X≦N; and the server system storing remaining ones of the identities of the followers as part of the target group of users in memory of the server system.

In an aspect, the method further includes, prior to the obtaining the identities of the friends from the first group of users, the server system computing an authority ranking score of each of the users in an initial group of users; the server system identifying a high-authority portion of users and a low-authority portion of users based on the authority ranks; and the server system using the low-authority portion of users as the first group of users.

In another aspect, the method further includes the server system using the high-authority portion of users as a second group of users; the server system obtaining identities of friends from the second group of users; the server system parsing out those identities of the friends from the second group of users that follow less than Y number of users from the second group of users; and the server system storing remaining ones of the identities of the friends from the second group of users as part of the target group of users in the memory.

In another aspect, the method further includes, prior to obtaining the identities of the friends from the second group of users, the server system parsing out generic users from the second group of users.

In another aspect, wherein a threshold authority ranking score separates the high-authority portion of users from the low-authority portion of users in the initial group of users.

In another aspect, the method further includes the server system identifying top followers of the high-authority portion of users; and the server system storing these top followers as part of the target group of users in the memory.

In another aspect, the top followers are those followers that are common to at least C of the high-authority portion of users, where C is an integer >2.

In another aspect, the method further includes, after identifying the target group of users, transmitting digital content to the target group of users.

In another general example embodiment, a method performed by a server system is provided for determining a target group of users in a social data network. The method includes: the server system computing an authority ranking score of each of the users in an initial group of users; the server system identifying a high-authority portion of users and a low-authority portion of users based on the authority ranking scores; the server system using the high-authority portion of users as a first group of users; the server system obtaining identities of friends from the first group of users; the server system parsing out those identities of the friends from the first group of users that follow less than Y number of users from the first group of users; and the server system storing remaining ones of the identities of the friends from the first group of users as part of the target group of users in memory of the server system.

In an aspect, the method further includes: the server system using the low-authority portion of users as a second group of users; the server system obtaining identities of friends from the second group of users, where a user in the second group follows one or more of the friends, and the friends and the first group of users are associated with user accounts in the social data network; the server system determining N number friends that are most frequently occurring amongst the identities of friends from the second group of users; for each of the N number friends, the server system obtaining identities of followers following a given one of the N friends; the server system filtering out one or more followers from the identities of the followers that follow less than X number of the N number of friends, where XN; and the server system storing remaining ones of the identities of the followers as part of the target group of users in memory of the server system.

In another general example embodiment, a server system is provided, which is configured to determine a target group of users in a social data network. The server system includes: one or more processors that obtain identities of friends from a first group of users, where a user in the first group follows one or more of the friends, and the friends and the first group of users are associated with user accounts in the social data network; the one or more processors determine N number friends that are most frequently occurring amongst the identities of friends from the first group of users; for each of the N number friends, the one or more processors obtain identities of followers following a given one of the N friends; the one or more processors filter out one or more followers from the identities of the followers that follow less than X number of the N number of friends, where X≦N; and a memory that stories remaining ones of the identities of the followers as part of the target group of users.

In an aspect of the server system, prior to the obtaining the identities of the friends from the first group of users, the one or more processors are configured to at least: compute an authority ranking score of each of the users in an initial group of users; the identify a high-authority portion of users and a low-authority portion of users based on the authority ranks; and use the low-authority portion of users as the first group of users.

In another aspect of the server system, the one or more processors are configured to at least: use the high-authority portion of users as a second group of users; obtain identities of friends from the second group of users; parse out those identities of the friends from the second group of users that follow less than Y number of users from the second group of users; and the server system storing remaining ones of the identities of the friends from the second group of users as part of the target group of users in the memory.

In another aspect of the server system, prior to obtaining the identities of the friends from the second group of users, the one or more processors are configured to at least parse out generic users from the second group of users.

In another aspect of the server system, a threshold authority ranking score separates the high-authority portion of users from the low-authority portion of users in the initial group of users.

In another aspect of the server system, the one or more processors are further configured to at least identify top followers of the high-authority portion of users, and store these top followers as part of the target group of users in the memory.

In another aspect of the server system, the top followers are those followers that are common to at least C of the high-authority portion of users, where C is an integer >2.

In another aspect, the server system further includes a communication device to configured to transmit digital content to the target group of users.

In another aspect, the server system further includes a communication device, wherein the one or more processors and the communication device are used to obtain the identities of the friends from the first group of users, and are used to obtain the identities of the followers following a given one of the N friends.

In another general example embodiment, a server system is provided, which is configured to determine a target group of users in a social data network. The server system includes one or more processors that are configured to at least: compute an authority ranking score of each of the users in an initial group of users; identify a high-authority portion of users and a low-authority portion of users based on the authority ranking scores; use the high-authority portion of users as a first group of users; and obtain identities of friends from the first group of users; parse out those identities of the friends from the first group of users that follow less than Y number of users from the first group of users. The server system also includes a memory configured to store remaining ones of the identities of the friends from the first group of users as part of the target group of users.

### Examples of Composing Advertisement Content

Below are examples of computer executable instructions for composing advertisement content, which can be executed by the advertisement procurement module 105.

Turning to FIG. 33A, example computer or processor implemented instructions are provided for composing a digital advertisement according to the module 105. The module 105 obtains social data or advertisement data, or both, as well as corresponding data relationships from the active receiver module 103 or the target audience analysis and library module 104, or both (block 3300).

At block 3301, in an example embodiment, the module 105 automatically transmits a request for permission to the authors of the social data or the advertisement data for such data to be used in a digital advertisement. It is appreciated that the user accounts of the authors is known by the system 102, including the contact information associated with the user accounts, and that the module 105 sends a digital message that includes the request for permission. The module 105 receives response messages from the authors of the data content indicating that permission is granted or is denied. For response messages granting permission, the module 105 appends a permission tag to the corresponding data content to indicate that the data may be incorporated into a digital advertisement. The response messages from the authors are saved in a database for future reference. Using the above executable instructions, the module 105 is able to automatically manage a large number of permissions to use or not use social data or advertisement data in digital advertisements.

The module then composes a new digital advertisement file (e.g. text, video, graphics, audio) derived from the obtained social data or the obtained advertisement data (block 3302).

Various approaches can be used to compose the new digital advertisement file(s). For example, social data or advertisement data, or both, can be combined to create the new digital advertisement file (block 3305); social data or advertisement data, or both, can be extracted to create the new digital advertisement file (block 3306); and new social data or new advertisement data, or both, can be created to form the new digital advertisement file (block 3307). In another example approach, the module 105 recognizes external video, audio, and picture content and is able to incorporate this content into the digital advertisement (block 3325). The operations from one or more of blocks 3305, 3306, 3307 and 3325 can be applied to block 3302. Further details in this regard are described in FIGS. 33B, 33C and 33D.

Continuing with FIG. 33A, at block 3303, the module 105 outputs the composed digital advertisement file. The module 105 may also add identifiers or trackers to the composed advertisement file, which are used to identify the sources of the combined social data and the relationship between the combined social data (block 3304).

Turning to FIG. 33B, example computer or processor implemented instructions are provided for combining social data or advertisement data according to block 3305. The module 105 obtains relationships and correlations between the social data (block 3308). The relationships and correlations, for example, are obtained from the active receiver module 104. The module 105 also obtains the social data corresponding to the relationships (block 3309). The social data obtained in block 3309 may be a subset of the social data obtained by the active receiver module, or may be obtained by third party sources, or both. At block 3310, the module 105 composes new social data (e.g. a new social data object) by combining social data that is related to each other.

It can be appreciated that various composition processes can be used when implementing block 3310. For example, a text summarizing algorithm can be used (block 3311). In another example, templates for combining text, video, graphics, etc. can be used (block 3312). In an example embodiment, the templates may use natural language processing to generate text.

Natural language processing catered to different languages can also be used. Natural language generation can also be used. It can be appreciated that currently known and future known composition algorithms that are applicable to the principles described herein can be used.

Natural language generation includes content determination, document structuring, aggregation, lexical choice, referring expression generation, and realisation. Content determination includes deciding what information to mention in the text. In this case the information is extracted from the social data associated with an identified relationship. Document structuring is the overall organisation of the information to convey. Aggregation is the merging of similar sentences to improve readability and naturalness. Lexical choice is putting words to the concepts. Referring expression generation includes creating referring expressions that identify objects and regions. This task also includes making decisions about pronouns and other types of anaphora. Realisation includes creating the actual text, which should be correct according to the rules of syntax, morphology, and orthography. For example, using “will be” for the future tense of “to be”.

Continuing with FIG. 33B, metadata obtained from the active receiver module, or obtained from third party sources, or metadata that has been generated by the system 102, may also be applied when composing the new digital advertisement (block 3313). Furthermore, a thesaurus database, containing words and phrases that are synonymous or analogous to keywords and key phrases, can also be used to compose the new social data object (block 3314). The thesaurus database may include slang and jargon. In an example embodiment, entries in the thesaurus database, such as instances of a word or phrase including slang and jargon, are each associated with one or more locations, or one or more demographic characteristics, or both. The associated locations, for example, indicate where each particular entry is commonly used. The associated demographic characteristics (e.g. age, language, ethnicity, gender, education, interests, social groups, etc.) indicate the characteristics of people that commonly use each particular entry. In this way, based on the location of the targeted audience, or the demographic characteristics of the targeted audience, or both, the advertisement procurement module 105 is able to select words and phrases from the thesaurus that are appropriate and commonly used according to the targeted audience.

It will be appreciated that thesaurus database has terms that are tagged with certain demographic characteristics. Examples of data tags include “young”; “middle aged”; “senior”; “parents”; “male”; “female”; “urban”; “suburban”; “Caucasian”; “Hispanic”; “African American”; Asian”; “American”; “Canadian”; “European”; etc. In this way, the module 105 is able to identify synonyms of words using the tags, which are more commonly used amongst certain demographics of people.

For example, a composed text may describe a new product as being “exciting”. Knowing that the text is geared towards students or younger people, which is a demographic characteristic, the module 105 uses the thesaurus database to identify words or phrases to replace the word “exciting”. The module 105 identifies that the terms “groovy”, “rocking”, and “hype” are appropriate words for the student demographic and, thus, replaces the word “exciting” with one of the identified terms (e.g. “rocking”).

In another example, a composed text uses the word “toque” to describe a certain type of hat, which is commonly called by name in Canada. However, as the module 105 has obtained data that the composed text is targeted for readers located in the United States, the module 105 searches for words or phrases in the thesaurus database that are better suited for the United States. As an example, the synonym “beanie” is found in the thesaurus database and is associated with the location “United States”. Therefore, “beanie” is used to replace the word “toque”.

Turning to FIG. 33C, example computer or processor implemented instructions are provided for extracting social data according to block 3306. At block 3315, the module 105 identifies characteristics related to the social data. These characteristics can be identified using metadata, tags, keywords, the source of the social data, etc. At block 3316, the module 105 searches for and extracts social data that is related to the identified characteristics.

For example, one of the identified characteristics is a social network account name of a person, an organization, or a place. The module 105 will then access the social network account to extract data from the social network account. For example, extracted data includes associated users, interests, favourite places, favourite foods, dislikes, attitudes, cultural preferences, etc. In an example embodiment, the social network account is a LinkedIn account or a Facebook account. This operation (block 3318) is an example embodiment of implementing block 3316.

Another example embodiment of implementing block 3316 is to obtain relationships and use the relationships to extract social data (block 3319). Relationships can be obtained in a number of ways, including but not limited to the methods described herein. Another example method to obtain a relationship is using Pearson's correlation. Pearson's correlation is a measure of the linear correlation (dependence) between two variables X and Y, giving a value between +1 and −1 inclusive, where 1 is total positive correlation, 0 is no correlation, and −1 is negative correlation. For example, if given data X, and it is determined X and data Y are positively correlated, then data Y is extracted.

The relationships between different types of data (e.g. user accounts, influencers, experts, followers, topics, content, locations, etc.) may also be those obtained by the active receiver module 103.

Another example embodiment of implementing block 3316 is to use weighting to extract social data or advertisement data, or both (block 3320). For example, certain keywords can be statically or dynamically weighted based on statistical analysis, voting, or other criteria. Characteristics that are more heavily weighted can be used to extract social data. In an example embodiment, the more heavily weighted a characteristic is, the wider and the deeper the search will be to extract social data related to the characteristic.

Other approaches for searching for and extracting social data or advertisement data, or both, can be used.

At block 3317, the extracted social data is used to form a new digital advertisement file.

Turning to FIG. 33D, example computer or processor implemented instructions are provided for creating a digital advertisement file according to block 3307. At block 3321, the module 105 identifies stereotypes related to the social data. Stereotypes can be derived from the social data. For example, using clustering and decision tree classifiers, stereotypes can be computed.

In an example stereotype computation, a model is created. The model represents a person, a place, an object, a company, an organization, or, more generally, a concept. As the system 102, including the advertisement procurement module 105, performs more and more processing iterations to obtaining data and feedback regarding the advertisements being transmitted, the module 105 is able to modify the model. Features or stereotypes are assigned to the model based on clustering. In particular, clusters representing various features related to the model are processed using iterations of agglomerative clustering. If certain of the clusters meet a predetermined distance threshold, where the distance represents similarity, then the clusters are merged. For example, the Jaccard distance (based on the Jaccard index), a measure used for determining the similarity of sets, is used to determine the distance between two clusters. The cluster centroids that remain are considered as the stereotypes associated with the model. For example, the model may be a clothing brand that has the following stereotypes: athletic, running, sports, swoosh, and ‘just do it’.

In another example stereotype computation, affinity propagation is used to identify common features, thereby identifying a stereotype. Affinity propagation is a clustering algorithm that, given a set of similarities between pairs of data points, exchanges messages between data points so as to find a subset of exemplar points that best describe the data. Affinity propagation associates each data point with one exemplar, resulting in a partitioning of the whole data set into clusters. The goal of affinity propagation is to minimize the overall sum of similarities between data points and their exemplars. Variations of the affinity propagation computation can also be used. For example, a binary variable model of affinity propagation computation can be used. A non-limiting example of a binary variable model of affinity propagation is described in the document by Inmar E. Givoni and Brendan J. Frey, titled “A Binary Variable Model of Affinity Propagation”, Neural Computation 21, 1589-1600 (2009), the entire contents of which are hereby incorporated by reference.

Another example stereotype computation is Market Basket Analysis (Association Analysis), which is an example of affinity analysis. Market Basket Analysis is a mathematical modeling technique based upon the theory that if you buy a certain group of products, you are likely to buy another group of products. It is typically used to analyze customer purchasing behavior and helps in increasing the sales and maintain inventory by focusing on the point of sale transaction data. Given a dataset, an apriori algorithm trains and identifies product baskets and product association rules. However, the same approach is used herein to identify characteristics of a person (e.g. stereotypes) instead of products. Furthermore, in this case, users' consumption of social data and advertisements (e.g. what they read, watch, listen to, comment on, etc.) is analyzed. The apriori algorithm trains and identifies characteristic (e.g. stereotype) baskets and characteristic association rules.

Other methods for determining stereotypes can be used.

Continuing with FIG. 33D, the stereotypes are used as metadata (block 3322). In an example embodiment, the metadata is used to derive or compose a new digital advertisement file (block 3324).

It can be appreciated that the methods described with respect to blocks 3305, 3306 and 3307 to compose a new social data object can be combined in various way, though not specifically described herein. Other ways of composing a new digital advertisement file can also be applied.

In an example embodiment of composing a digital advertisement file, the advertisement relates to the comedian named “Chris Farley”. To compose a new digital advertisement file, it is created using stereotypes. For example, the stereotypes ‘comedian’, ‘fat’, ‘ninja’, and ‘blonde’ are created and associated with Chris Farley. The stereotypes are then used to automatically create a caricature (e.g. a cartoon-like image of Chris Farley). The image of the person is automatically modified to include a funny smile and raised eye brows to correspond with the ‘comedian’ stereotype. The image of the person is automatically modified to have a wide waist to correspond with the ‘fat’ stereotype. The image of the person is automatically modified to include ninja clothing and weaponry (e.g. a sword, a staff, etc.) to correspond with the ‘ninja’ stereotype. The image of the person is automatically modified to include blonde hair to correspond with the ‘blonde’ stereotype. In this way, a new digital advertisement file that includes the caricature image of Chris Farley is automatically created. Various graphic generation methods, derived from text, can be used. For example, a mapping database contains words that are mapped to graphical attributes, and those graphical attributes in turn can be applied to a template image. Such a mapping database could be used to generate the caricature image.

In another example embodiment, the stereotypes are used to create a text description of Chris Farley, and to identify in the text description other people that match the same stereotypes. The text description is the composed social data object. For example, the stereotypes of Chris Farley could also be used to identify the actor “John Belushi” who also fits the stereotypes of ‘comedian’ and ‘ninja’. Although the above examples pertain to a person, the same principles of using stereotypes to compose social data also apply to places, cultures, fashion trends, brands, companies, objects, etc.

In an example embodiment, templates are provided for composing text, image, and video social data objects, and can apply the above operations and principles. For example, the determination of which content is used to populate a template is based on the obtained social data or obtained advertisement data, or both, and the relationships.

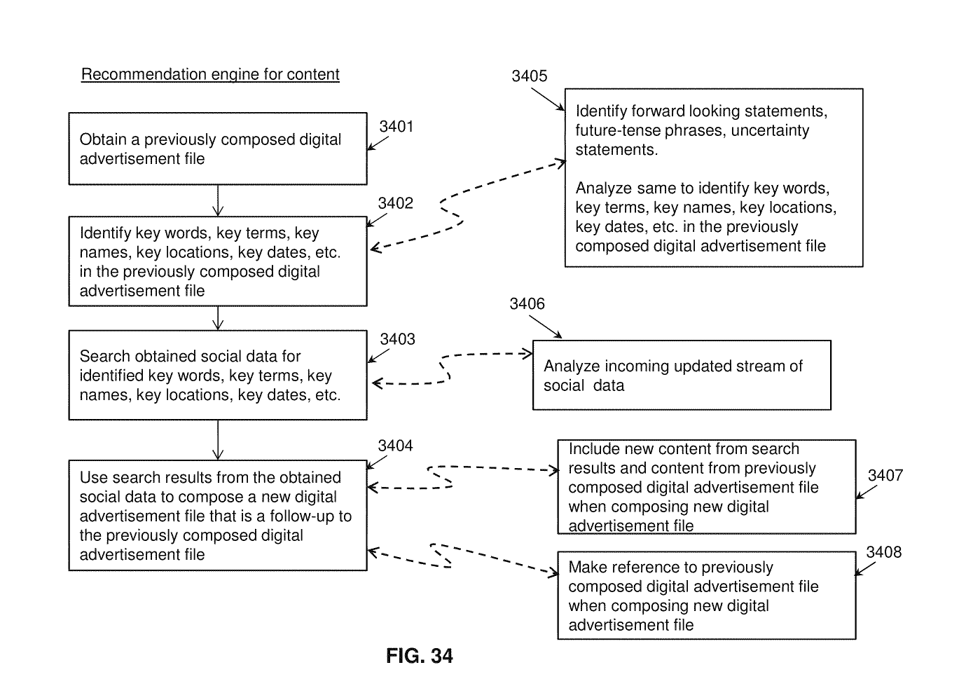

Turning to FIG. 34, example computer or processor implemented instructions are provided for composing a new digital advertisement file based on a previously composed digital advertisement file. At block 3401, the module 105 obtains a previously composed digital advertisement file (e.g., a posting, a message, an audio file, a video, a picture, etc.).

At block 3402, the module 105 identifies key words, key terms, key names, key locations, key dates, etc. in the previously composed digital advertisement file. For pictures and videos, the module 105 may identify key objects, faces, locations, and other metadata associated with the advertisement.

In an example embodiment of implementing block 3402, the module 105 identifies forward looking statements, future-tense phrases, and uncertainty statements (block 1905). These identified statements and phrases are analyzed to identify key words, key terms, key names, key locations, key dates, etc. in the previously composed social data object. Other ways of implementing block 3402 may be used.

Continuing with FIG. 34, at block 3403, the module 105 searches social data for the identified key words, key terms, key names, key locations, key dates, etc. In an example embodiment of implementing block 3403, the incoming and continuously updated stream of social data obtained by the active receiver module is searched and analyzed. Other ways of implementing block 3403 may be used.

At block 3404, the search results from block 3403 are used to compose a new digital advertisement file that is a follow-up to the previously composed digital advertisement file.

In an example embodiment of implementing block 3404, the new digital advertisement file includes new content from the search results and includes content from the previously composed digital advertisement file (block 3407). In another example embodiment, the module 105 makes reference to the previously composed digital advertisement file when composing the new digital advertisement file (block 3408). Blocks 3407 and 3408 may occur together, or just block 3407 is used, or just block 3408 is used. Other ways of implementing block 3404 may be used.

For example, as per block 3408, the new digital advertisement file makes reference by including the title of the previously composed digital advertisement file or title of the promotion, the date of publication, the date of a previously advertised sale or promotion, the publication source, a data link to the previously composed digital advertisement file, or any combination thereof.

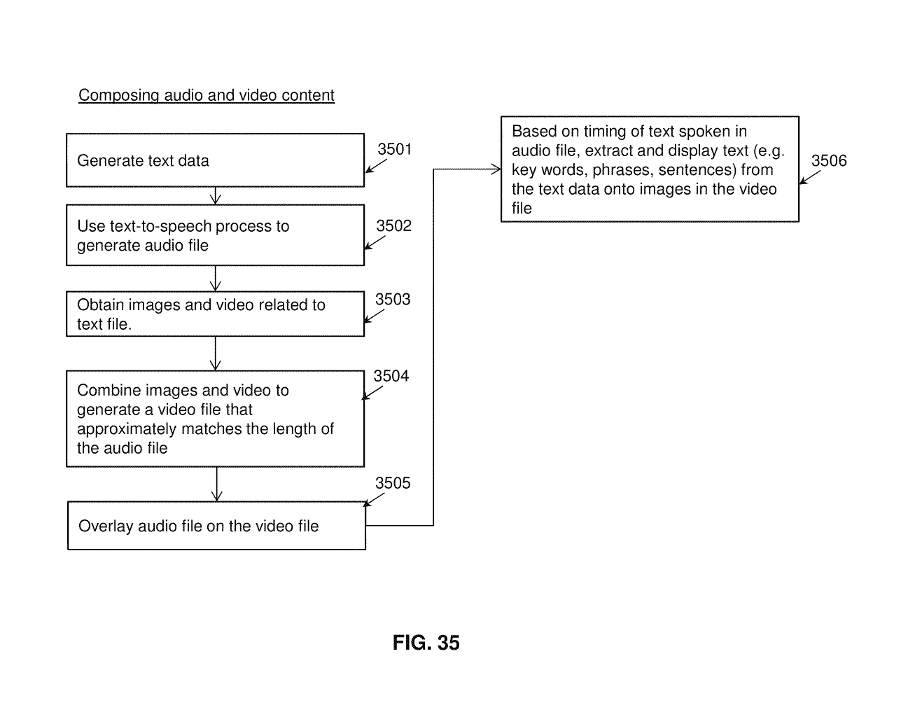

Turning to FIG. 35, example computer or processor executable instructions are provided for composing a digital advertisement file comprising audio content, and for composing a digital advertisement file comprising video content. The process starts with generating text data (block 3501). The text can be obtained or composed in many ways, including the methods described above.

At block 3502, the module 105 uses a text-to-speech process to generate an audio file from the text. In this way the audio content is created.

To create video content, continuing with FIG. 35, at block 3503, the module 105 obtains images and video related to the text data. For example, the images and video were originally published in articles or messages or posts having certain key words or phrases, and those key words and phrases are in the composed text data of block 3501. In another example, the images and video have metadata which matches content or metadata of the text data. Other ways of identifying relationships between images and video with the text data can be used.

At block 3504, the module 105 combines images and video to generate a video file that approximately matches the length of the audio file. For example, the images and video may be concatenated together to form a series of images to form a video. Or images may be inlaid video. Other ways of combining images, or combining video, or combining images and video may be used. As a non-limiting particular example, if the audio file is t seconds long, the generated video file is also approximately t seconds long.

At block 3505, the audio file is overlaid the video file. In this way, the video file has an audio component accompanying the video images.

At block 3506, optionally, based on the timing of the text spoken in the audio file, text from the generated text data is extracted and displayed onto the images in the video file. For example, key words, phrases or sentences ca be extracted from the generated text data and displayed in the video file. The text may be displayed as streaming text or static text, overlaid a video image or inlaid, or displayed in another fashion.

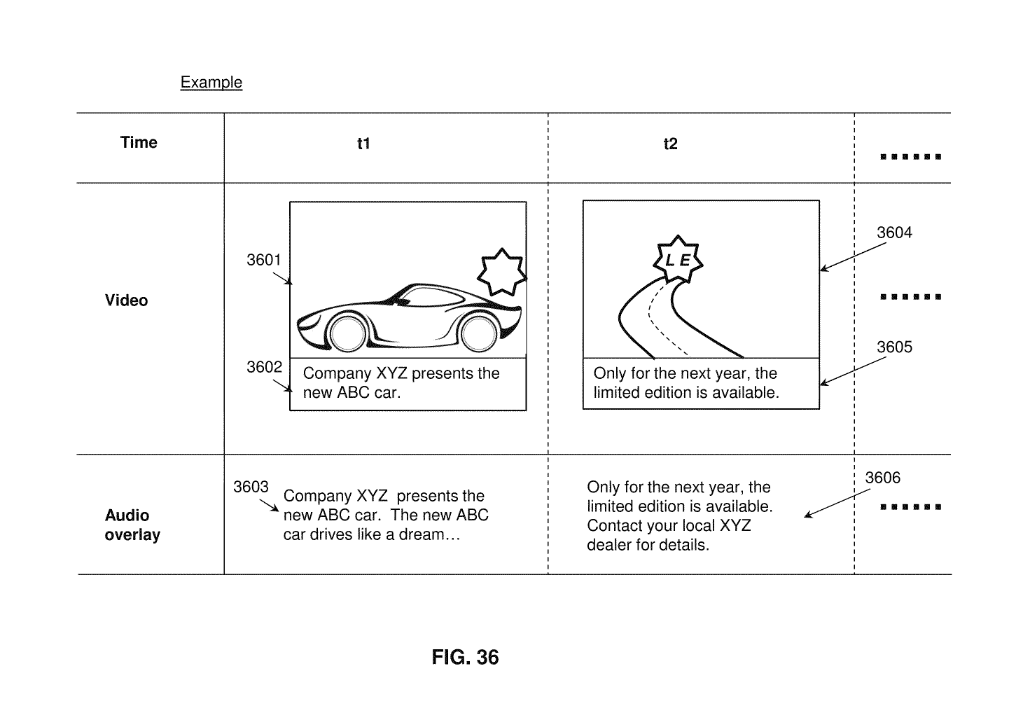

Turning to FIG. 36, an example schematic diagram is provided to illustrate the combined video and audio data, which forms a video file. The text data may be obtained from a text advertisement, such as a company releasing a new car for sale. Different instances of time are shown as t1 and t2. At the time t1, a video image 3601 is shown. Also at the same time the video image 3601 is displayed, the audio component 3603 is played and recites “Company XYZ presents the new ABC car. The new ABC car drives like a dream . . . ”. Based on the audio content being played at t1, the corresponding text (or a portion thereof) 3602 is displayed in the image. The displayed text 3602 at t1 reads: “Company XYZ presents the new ABC car.”

At time t2, a different image 3604 is shown in the video file. The audio component 3606 being played at time t2 recites: “Only for the next year, the limited edition is available. Contact your local XYZ dealer for details.” Thus, the text being extracted and displayed 3605 in the video at time t2 reads: “Only for the next year, the limited edition is available”

Other display configurations of text and images in the video file can be used. In another example embodiment, there is no audio overlay, and the video file includes only the video and image data combined with the display of text data overlaid the video and image data.

General example embodiments and related aspects for automatically procuring a digital advertisement are provided below.

In a general example embodiment, a method performed by a computing system is provided for automatically generating and sending a digital advertisement. In particular, the computing system performs at least the following: obtaining social data and using the social data to identify one or more data relationships amongst the social data; determining a target set based on the one or more data relationships and storing the target set in a library database, the target set comprising a combination of inputs and a target audience, wherein the inputs comprise a search algorithm for identifying the target audience, and the target audience comprises user accounts in one or more social data networks; responsive to detecting a proposed advertising campaign, retrieve the target set from the library database; generating a digital advertising campaign by at least generating a digital advertisement, identifying a target audience, and identifying a data communication channel over which to transmit the digital advertisement to the target audience; initiating transmission of the digital advertisement to the target audience over the data communication channel; obtaining feedback about the digital advertisement; and modifying the digital advertising campaign by at least one of modifying the digital advertisement, modifying the target audience and selecting a different data communication channel based on the feedback.

In an example aspect, the method further includes, after the computing system modifies the digital advertising campaign, initiating a second transmission of the modified digital advertisement.

In another example aspect, the method further includes, after determining the target set, machine testing the target set to determine if the target set has passed one or more thresholds and, after determining the target set has passed one or more thresholds, storing the target set in the library database for future access.

In another example aspect, the inputs of the target set comprises any one or more of: an algorithm that identifies a social pattern, and a social pattern related to at least one of an event, people, a brand, a product, a service, a company, a place, a behavior, and a social communication channel.

In another example aspect, the target set is retrieved from the library database when the proposed digital advertising campaign is detected to comprise information that matches at least one or more of the inputs of the target set.

In another example aspect, initiating the transmission of the digital advertisement comprises at least one of: purchasing advertising from at least one of an advertisement data network and a social data network; loading the digital advertisement onto at least one of the digital advertisement network and the social data network; and sending transmission parameters associated with the digital advertisement to at least one of the digital advertisement network and the social data network.

In another example aspect, the method further includes, prior to initiating the transmission of the digital advertisement, the computing system simulating the digital advertising campaign to predict a number of users that will view the digital advertisement.

In another example aspect, identifying the target audience comprises: the computing system obtaining identities of friends from a first group of users, where a user in the first group follows one or more of the friends, and the friends and the first group of users are associated with a first group of user accounts in the social data network; the computing system determining N number friends that are most frequently occurring amongst the identities of friends from the first group of users; for each of the N number friends, the computing system obtaining identities of followers following a given one of the N friends; the computing system filtering out one or more followers from the identities of the followers that follow less than X number of the N number of friends, where X≦N; and the computing system storing remaining ones of the identities of the followers as part of the target audience in memory of the computing system.

In another example aspect, identifying the target audience comprises: the computing system computing an authority ranking score of each of the users in an initial group of users; the computing system identifying a high-authority portion of users and a low-authority portion of users based on the authority ranking scores; the computing system using the high-authority portion of users as a first group of users; the computing system obtaining identities of friends from the first group of users; the computing system parsing out those identities of the friends from the first group of users that follow less than Y number of users from the first group of users; and the computing system storing remaining ones of the identities of the friends from the first group of users as part of the target audience in memory of the computing system.

In another example aspect, the target set further comprises a digital advertising template, and generating the digital advertisement comprises populating the digital advertisement template with text or a digital image, or both.

It will be appreciated that different features of the example embodiments of the system and methods, as described herein, may be combined with each other in different ways. In other words, different modules, operations and components may be used together according to other example embodiments, although not specifically stated.

The steps or operations in the flow diagrams described herein are just for example. There may be many variations to these steps or operations without departing from the spirit of the invention or inventions. For instance, the steps may be performed in a differing order, or steps may be added, deleted, or modified.

Although the above has been described with reference to certain specific embodiments, various modifications thereof will be apparent to those skilled in the art without departing from the scope of the claims appended hereto.

1. A method performed by a computing system for automatically generating and sending a digital advertisement, the method comprising:
obtaining social data and using the social data to identify one or more data relationships amongst the social data;
determining a target set based on the one or more data relationships and storing the target set in a library database, the target set comprising a combination of inputs and a target audience, wherein the inputs comprise a search algorithm for identifying the target audience, and the target audience comprises user accounts in one or more social data networks;
responsive to detecting a proposed advertising campaign, retrieving the target set from the library database;
generating a digital advertising campaign by at least generating a digital advertisement, identifying a target audience, and identifying a data communication channel over which to transmit the digital advertisement to the target audience;
initiating transmission of the digital advertisement to the target audience over the data communication channel;
obtaining feedback about the digital advertisement; and
modifying the digital advertising campaign by at least one of modifying the digital advertisement, modifying the target audience and selecting a different data communication channel based on the feedback.

2. The method of claim 1 further comprising, after the computing system modifies the digital advertising campaign, initiating a second transmission of the modified digital advertisement.

3. The method of claim 1 further comprising, after determining the target set, machine testing the target set to determine if the target set has passed one or more thresholds and, after determining the target set has passed one or more thresholds, storing the target set in the library database for future access.

4. The method of claim 1 wherein the inputs of the target set comprises any one or more of: an algorithm that identifies a social pattern, and a social pattern related to at least one of an event, people, a brand, a product, a service, a company, a place, a behavior, and a social communication channel.

5. The method of claim 4 wherein the target set is retrieved from the library database when the proposed digital advertising campaign is detected to comprise information that matches at least one or more of the inputs of the target set.

6. The method of claim 1 wherein initiating the transmission of the digital advertisement comprises at least one of: purchasing advertising from at least one of an advertisement data network and a social data network; loading the digital advertisement onto at least one of the digital advertisement network and the social data network; and sending transmission parameters associated with the digital advertisement to at least one of the digital advertisement network and the social data network.

7. The method of claim 1 further comprising, prior to initiating the transmission of the digital advertisement, the computing system simulating the digital advertising campaign to predict a number of users that will view the digital advertisement.

8. The method of claim 1 wherein identifying the target audience comprises:
the computing system obtaining identities of friends from a first group of users, where a user in the first group follows one or more of the friends, and the friends and the first group of users are associated with a first group of user accounts in the social data network;
the computing system determining N number friends that are most frequently occurring amongst the identities of friends from the first group of users;
for each of the N number friends, the computing system obtaining identities of followers following a given one of the N friends;
the computing system filtering out one or more followers from the identities of the followers that follow less than X number of the N number of friends, where X≦N; and
the computing system storing remaining ones of the identities of the followers as part of the target audience in memory of the computing system.

9. The method of claim 1 wherein identifying the target audience comprises:
the computing system computing an authority ranking score of each of the users in an initial group of users;
the computing system identifying a high-authority portion of users and a low-authority portion of users based on the authority ranking scores;
the computing system using the high-authority portion of users as a first group of users;
the computing system obtaining identities of friends from the first group of users;
the computing system parsing out those identities of the friends from the first group of users that follow less than Y number of users from the first group of users; and
the computing system storing remaining ones of the identities of the friends from the first group of users as part of the target audience in memory of the computing system.

10. The method of claim 1 wherein the target set further comprises a digital advertising template, and generating the digital advertisement comprises populating the digital advertisement template with text or a digital image, or both.

11. A computing system for automatically generating and sending a digital advertisement, comprising:
a communication device configured to obtain social data;
memory for storing databases; and
a processor configured to at least:
use the social data to identify one or more data relationships amongst the social data;
determine a target set based on the one or more data relationships and storing the target set in a library database in the memory, the target set comprising a combination of inputs and a target audience, wherein the inputs comprise a search algorithm for identifying the target audience, and the target audience comprises user accounts in one or more social data networks;
responsive to detecting a proposed advertising campaign, retrieve the target set from the library database;
generate a digital advertising campaign by at least generating a digital advertisement, identifying a target audience, and identifying a data communication channel over which to transmit the digital advertisement to the target audience;
initiate transmission of the digital advertisement to the target audience over the data communication channel;
obtain feedback about the digital advertisement; and
modify the digital advertising campaign by at least one of modifying the digital advertisement, modifying the target audience and selecting a different data communication channel based on the feedback.

12. The computing system of claim 11 wherein the processor is further configured to initiate a second transmission of the modified digital advertisement after modifying the digital advertising campaign.

13. The computing system of claim 11 wherein, after determining the target set, the processor is further configured to machine test the target set to determine if the target set has passed one or more thresholds and, after determining the target set has passed one or more thresholds, the processor stores the target set in the library database for future access.

14. The computing system of claim 11 wherein the inputs of the target set comprise any one or more of: an algorithm that identifies a social pattern, and a social pattern related to at least one of an event, people, a brand, a product, a service, a company, a place, a behavior, and a social communication channel.

15. The computing system of claim 14 wherein the target set is retrieved from the library database when the proposed digital advertising campaign is detected to comprise information that matches at least one or more of the inputs of the target set.

16. The computing system of claim 1 wherein initiating the transmission of the digital advertisement comprises at least one of: the computing system purchasing advertising from at least one of an advertisement data network and a social data network; the computing system loading the digital advertisement onto at least one of the digital advertisement network and the social data network; and the computing system sending transmission parameters associated with the digital advertisement to at least one of the digital advertisement network and the social data network.

17. The computing system of claim 1 wherein, prior to initiating the transmission of the digital advertisement, the processor is configured to simulate the digital advertising campaign to predict a number of users that will view the digital advertisement.

18. The computing system of claim 11 wherein identifying the target audience comprises:
the computing system obtaining identities of friends from a first group of users, where a user in the first group follows one or more of the friends, and the friends and the first group of users are associated with a first group of user accounts in the social data network;
the computing system determining N number friends that are most frequently occurring amongst the identities of friends from the first group of users;
for each of the N number friends, the computing system obtaining identities of followers following a given one of the N friends;
the computing system filtering out one or more followers from the identities of the followers that follow less than X number of the N number of friends, where X≦N; and
the computing system storing remaining ones of the identities of the followers as part of the target audience in memory of the computing system.

19. The computing system of claim 11 wherein identifying the target audience comprises:
the computing system computing an authority ranking score of each of the users in an initial group of users;
the computing system identifying a high-authority portion of users and a low-authority portion of users based on the authority ranking scores;
the computing system using the high-authority portion of users as a first group of users;
the computing system obtaining identities of friends from the first group of users;
the computing system parsing out those identities of the friends from the first group of users that follow less than Y number of users from the first group of users; and
the computing system storing remaining ones of the identities of the friends from the first group of users as part of the target audience in memory of the computing system.

20. The computing system of claim 11 wherein the target set further comprises a digital advertising template, and generating the digital advertisement comprises populating the digital advertisement template with text or a digital image, or both.

21. A non-transitory computer readable medium comprising computer executable instructions for automatically generating and transmitting a digital advertisement, the instructions comprising:
obtaining social data and using the social data to identify one or more data relationships amongst the social data;
determining a target set based on the one or more data relationships and storing the target set in a library database, the target set comprising a combination of inputs and a target audience, wherein the inputs comprise a search algorithm for identifying the target audience, and the target audience comprises user accounts in one or more social data networks;
responsive to detecting a proposed advertising campaign, retrieving the target set from the library database;
generating a digital advertising campaign by at least generating a digital advertisement, identifying a target audience, and identifying a data communication channel over which to transmit the digital advertisement to the target audience;
initiating transmission of the digital advertisement to the target audience over the data communication channel;
obtaining feedback about the digital advertisement; and
modifying the digital advertising campaign by at least one of modifying the digital advertisement, modifying the target audience and selecting a different data communication channel based on the feedback.
